(19) United States
(12) Patent Application Publication
(10) Pub. No.: US 2004/0133716 A1
(43) Pub. Date: Jul. 8, 2004

(54) Power supply apparatus for power load appliances having rechargeable battery

(76) Inventor: Sang- Yeol Lee, Seoul (KR)

Correspondence Address: Mark Friedman, Bill Polkinghorn, Discovery Dispatch, 9003 Florin Way, Upper Marlboro, MD, 20772, US

(21) Appl. No.: 10/472,179

(22) PCT Filed: Mar. 19, 2002
(86) PCT No.: PCT/KR02/00459

(30) Foreign Application Priority Data
Mar. 19, 2001 (KR) 2001/0014088
Apr. 12, 2001 (KR) 2001/0019643
Jul. 27, 2001 (KR) 2001/0045576

(51) Int. Cl. G06F 13/12

(52) U.S. Cl. 710/72

(57) ABSTRACT

The present invention provides a power supply and data repeater device, and in particular to a power supply and data repeater device for a portable communication terminal using a peripheral device connection port of the computer system to the portable communication terminal and/or other portable devices as operation and/or charging power, and which repeats data among the computer system, portable communication terminal and/or computer peripheral device. In addition, the present invention is directed to a keyboard device having a portable communication terminal connection structure, and more particularly, a keyboard device having a portable communication terminal connection structure which accesses a portable communication terminal (CDMA and GSM cellular phones, PCS terminal and PDA terminal) to input and transmit short messages, and which supplies operation power and charging power to the portable communication terminal. Moreover, the present invention provides to a keyboard device having a portable communication terminal communication terminal control function, and more particularly, a keyboard device having a portable communication terminal control function which charges a battery of a portable communication terminal with key scan power, manages mode setup of the portable communication terminal in a portable communication terminal control mode, and displays caller information and short message transmitted to the portable communication terminal on a display device through a computer system.

### FIELD OF THE INVENTION

The present invention relates to a power supply and data repeater device, and in particular to a power supply and data repeater device for a portable communication terminal using a peripheral device connection port of a computer system which supplies power of the peripheral device connection port of the computer system to the portable communication terminal and/or other portable devices as operation and/or charging power, and which repeats data among the computer system, portable communication terminal and/or computer peripheral device.

In addition, the present invention is directed to a keyboard device having a portable communication terminal connection structure, and more particularly, a keyboard device having a portable communication terminal connection structure which accesses a portable communication terminal (CDMA and GSM cellular phones, PCS terminal and PDA terminal) to input and transmit short messages, and which supplies operation power and charging power to the portable communication terminal.

Moreover, the present invention relates to a keyboard device having a portable communication terminal control function, and more particularly, a keyboard device having a portable communication terminal control function which charges a battery of a portable communication terminal with key scan power, manages mode setup of the portable communication terminal in a portable communication terminal control mode, and displays caller information and short message transmitted to the portable communication terminal on a display device through a computer system.

### BACKGROUND OF THE INVENTION

As publicly known, a computer system for executing a data communication function of mediating a data communication network has been widely distributed to input, edit, store and output a large quantity of information.

The computer system is roughly divided into a desktop computer and a notebook computer. Peripheral devices, for example, a scanner for scan input of images, a monitor for visually displaying an operation state of the computer system, a printer for outputting data and a speaker for outputting voice/sound are connected to the computer system.

Especially, a data input port to which a keyboard which is a data input device for setting up an operation state (and function) of the computer system or inputting data and a mouse which is a data input device for converting a specific function and commanding execution/selection of the function are connected is individually designed in a main body of the desktop computer system. The data input port receives key scan power of a predetermined DC voltage level from a power device of the main body.

Accordingly, a central processing unit (CPU) of the main body of the computer system scans a key operation state signal of the keyboard and/or mouse on the basis of the key scan power, and executes an operation corresponding to the key operation.

The notebook computer and the keyboard are generally incorporated. However, the notebook computer includes a data input port (i.e., keyboard/mouse connection port) to which a data input device having at least one keyboard or mouse is directly connected. The data input port receives key scan power of a predetermined level.

Therefore, in a state where the keyboard or mouse is selectively connected to the keyboard/mouse connection port, the notebook computer recognizes a key operation state of the keyboard or mouse by the key scan power, and performs a corresponding operation.

Recently, a portable communication terminal for executing voice communication and/or data communication regardless of time and places has been widely distributed, such as CDMA/GSM cellular phones, PCS phone and PDA. The cellular phone and the PDA include a recharging battery for performing voice communication and/or data communication anywhere.

In addition, MP3 players, portable cassette tape players and portable compact disk players which are portable audio reproducing devices for reproducing music have the recharging battery for reproducing music anywhere.

However, the recharging battery of a power load terminal including the portable communication terminal or portable audio reproducing device generally requires an exclusive use battery charger (i.e., power adapter). Here, the power load terminals (cellular phone, PDA, MP3 player, cassette tape player and CD player) use different battery chargers, and thus fail to obtain compatibility.

Moreover, since the cellular phone or PDA is provided with one battery charger, when the battery is discharged in a place where the battery charger is not installed (for example, offices), voice or data communication cannot be performed.

In order to solve the foregoing problem, a method using universal serial bus (USB) port power of the computer system as charging power of the cellular phone battery has been suggested. However, while the cellular phone is being charged with power transmitted to the USB port, the USB port cannot be allocated to other external connection devices (for example, scanner, web camera, etc.).

Such a disadvantage may also be generated in the portable audio reproducing device such as the MP3 player. There are thus increased demands for various charging methods for the rechargeable battery of the power load terminal including the portable communication terminal and the portable audio reproducing device.

A keyboard device for the computer system includes: a plurality of character keys for inputting characters, a plurality of number keys for inputting numbers, a plurality of function keys for setting up an input mode of the character keys and the number keys, and a control circuit for processing key scan data in response to the operation of the character keys, number keys and function keys.

The keyboard device is connected generally to a keyboard connection port of the main body of the personal computer. When the keyboard device receives key scan power (i.e., operation power) from the main body, the control circuit recognizes the operation of the character keys, number keys or function keys by the key scan power, and transmits key scan data to the computer main body. In order to transmit a short message, the portable communication terminal can input characters by switching the keys to which numbers 0 to 9 are allocated into a Korean or English input mode. Accordingly, the key operation for inputting the short message is complicated and an extended period of time is consumed.

It is also possible to transmit a short message to another portable communication terminal (i.e., cellular phone) by accessing a web site providing a short message service through a communication network (i.e., internet) or executing a messenger program for transmitting the short message, by using the personal computer or notebook computer. However, the aforementioned short message service method has a disadvantage in that the computer system and the monitor must be turned on to transmit the short message. Moreover, it is inconvenient to access a special web site or execute a special messenger program.

### SUMMARY OF THE INVENTION

Accordingly, it is a primary object of the present invention to provide a power supply device which uses key scan power transmitted to a keyboard/mouse connection port (data input port) of a main body of a desktop or notebook computer as operation power or battery charging power of a power load terminal including a portable communication terminal and MP3 player.

Another object of the present invention is to provide a power supply and data repeater device which supplies power of an input device connection port of a computer system as operation power or battery charging power of a power load terminal including a portable communication terminal, and which has a data repeating function by using an additional data input port to which an input device is connectable.

Yet another object of the present invention is to provide a power supply and data repeater device which supplies power of an input device connection port of a computer system as operation power or battery charging power of a power load terminal including a portable communication terminal, and which controls the portable communication terminal through the computer system.

Yet another object of the present invention is to provide a keyboard device for a computer system which has a power load terminal connection structure, and supplies operation power and charging power of the power load terminal by using key scan power.

Yet another object of the present invention is to provide a keyboard device for a computer system having a portable communication terminal connection structure which inputs a short message to be transmitted through the portable communication terminal by using key scan power, and which supplies operation power and charging power to the portable communication terminal.

Yet another object of the present invention is to provide a keyboard device for a computer system having a portable communication terminal connection structure which charges a battery with key scan power, supplies operation power and charging power to the portable communication terminal, and supplies power and inputs a short message to the portable communication terminal in an off state of a computer by using power charged in the battery.

Yet another object of the present invention is to provide a keyboard device for a computer system having a portable communication terminal connection structure which inputs a short message and supplies power to the portable communication terminal by using key scan power, and confirms input of the short message by displaying a short message input window on a display device (i.e., monitor), when the computer system and the display device are turned on and a short message mode is set up.

Yet another object of the present invention is to provide a keyboard device for a computer having a portable communication terminal control function which charges a portable communication terminal, and executes a short message service function for transmitting characters inputted by the keyboard through the portable communication terminal.

Yet another object of the present invention is to provide a keyboard device for a computer having a portable communication terminal control function which displays caller information transmitted to a portable communication terminal connected to the keyboard device of the computer on a monitor device of the computer, searches detailed information (i.e., business card information) of a caller from a phone number database of the portable communication terminal, a phone number database registered on the keyboard device, or a phone number database registered on a memory device of a main body of the computer on the basis of a call number of the caller information, and displays the searched information.

Yet another object of the present invention is to provide a keyboard device having a portable communication terminal control function which registers, corrects or deletes information items (for example, phone number database) of a portable communication terminal connected.

In order to achieve the primary object of the invention, in the first aspect of the invention, a power supply device for a power load terminal using a computer input port includes: a first connector means connected to a keyboard connection port and a mouse connection port of a computer system, for receiving key scan power; and at least one second connector means for supplying power from the first connector means to the power load terminal.

Here, the power supply device for the power load terminal further includes a power stabilizing means for stabilizing the key scan power as supply power of the power load terminal between the first and second connector means.

In addition, preferably, the power supply device for the power load terminal further includes: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

Preferably, the second connector means includes: a power cable device having a first power connection plug, a power cable and a second power connection plug connected to a power supply jack of the power load terminal; and a power jack for supplying the power from the power stabilizing means to the power load terminal through the medium of the power cable, the first power connection plug being connected to the power jack.

In order to achieve another object of the invention, in the second aspect of the invention, a power supply and data repeater device for a power load terminal using a peripheral device connection port of a computer includes: a first connector means connected to the peripheral device connection port of the computer system; at least one second connector means for receiving operation power of a peripheral device from the computer system through the first connector means, and supplying the power to the power load terminal; and a data repeater means for repeating data between the computer system and the peripheral device through the first connector means.

Here, preferably, the data repeater means includes: a wiring connected to pins of the peripheral device connection port of the computer system through the first connector means; and a peripheral device connection port being identical to the peripheral device connection port of the computer system connected to the wiring.

Preferably, the data repeater means includes: a wiring connected to pins of the peripheral device connection port of the computer system through the first connector means; and a wireless communication means connected to the wiring, for performing wireless communication with a wireless communication type computer peripheral device.

In addition, preferably, the power load terminal is selected from a portable communication terminal, portable audio reproducing device and speaker, the portable communication terminal is selected from CDMA and GSM cellular phones, PCS phone and PDA, and the portable audio reproducing device is selected from an MP3 player, portable cassette tape player and portable compact disk player.

Preferably, the peripheral device connection port is selected from a keyboard connection port, mouse connection port and USB port.

Preferably, the power supply and data repeater device for the power load terminal further includes a power stabilizing means for stabilizing the key scan power as supply power of the power load terminal between the first and second connector means.

Moreover, preferably, the power supply and data repeater device for the power load terminal further includes: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

Preferably, the second connector means includes: a power cable device having a first power connection plug, a power cable and a second power connection plug connected to a power supply jack of the power load terminal; and a power jack connected to the first connector means, for supplying the power to the power load terminal through the medium of the power cable, the first power connection plug being connected to the power jack.

In addition, preferably, the second connector means includes: a power cable device having a first power connection plug, a power cable and a second power connection plug connected to a power supply jack of the power load terminal; and a power jack for supplying the power from the power stabilizing means to the power load terminal through the medium of the power cable, the first power connection plug being connected to the power jack.

In order to achieve yet another object of the invention, in the third aspect of the invention, preferably, a power supply and data repeater device for a portable communication terminal using a computer input port includes: a first connector means connected to a peripheral device connection port of a computer system; and a power supply/data repeater means for stabilizing power transmitted from the peripheral device connection port of the computer system through the first connector means, supplying the power to the portable communication terminal, and repeating data communication between the computer system and the portable communication terminal through the first connector means.

Here, preferably, the power supply and data repeater means includes: a power stabilizing means for stabilizing the key scan power as supply power of the portable communication terminal; a charging state detecting means for detecting a charging state of a battery of the portable communication terminal; a charging state display means for displaying the state according to a detection result of the charging state detecting means; a power supply control means for controlling supply of the power stabilized by the power stabilizing means to the power load terminal according to the detection result of the charging state detecting means; a data communication means for performing data communication between the computer system and the portable communication terminal; and a second connector means for transmitting the power from the power supply control means and the data from the data communication means to the portable communication terminal.

Preferably, the power supply/data repeater means includes a data communication setup means for setting up data communication between the computer system and the portable communication terminal.

In addition, preferably, an exclusive use communication drive program for communicating with the portable communication terminal through the peripheral device connection port is installed in the computer system. When the data communication setup means sets up a communication mode, the communication drive program is driven upon the request of the data communication means, for displaying a portable communication terminal control window on a display device of the computer system.

Preferably, the power supply/data repeater means further includes a memory means for storing detailed phone number information corresponding to phone numbers, which is inputted, corrected or deleted through the portable communication terminal control window by the communication drive program installed in the computer system.

Preferably, when the portable communication terminal receives caller phone number information and transmits the information to the power supply/data repeater means, the data communication means searches detailed information corresponding to the caller phone number information from the memory means, and transmits the caller phone number information and the searched detailed information to the computer system, and the computer system displays the caller phone number information and the detailed information on the portable communication terminal control window by the communication drive program.

Preferably, in the case that the portable communication terminal receives a short message and transmits it to the power supply/data repeater means, the data communication means transmits the short message to the computer system, and the computer system displays the short message on the portable communication terminal control window by the communication drive program.

In addition, preferably, the computer system inputs a receiver phone number and a short message through the portable communication terminal control window, and transmits short message information including the receiver phone number and the short message to the portable communication terminal through the medium of the power supply/data repeater means by the communication drive program, and the portable communication terminal separates the phone number and the short message from the short message information, and transmits the short message to the phone number.

Preferably, the computer system demands setup information of the portable communication terminal to the portable communication terminal through the power supply/data repeater means by the communication drive program. The portable communication terminal transmits the predetermined setup information to the computer system through the power supply/data repeater means upon the setup information request. The computer system receiving the setup information displays the setup information on the portable communication terminal control window by the communication drive program. When the computer system receives a renewal request for correcting the setup information through the portable communication terminal control window, the computer system transmits the corrected setup information to the portable communication terminal through the power supply/data repeater means by the communication drive program, and the portable communication terminal sets up the corrected setup information as new setup information.

Preferably, the data repeater means includes: a wiring connected to pins of the peripheral device connection port of the computer system through the first connector means; and a peripheral device connection port being identical to the peripheral device connection port of the computer system connected to the wiring.

Preferably, the data repeater means includes: a wiring connected to pins of the peripheral device connection port of the computer system through the first connector means; and a wireless communication means connected to the wiring, for performing wireless communication with a wireless communication type computer peripheral device.

In addition, preferably, the power supply and data repeater device for the portable communication terminal further includes a power supply means for stabilizing the power transmitted from the peripheral device connection port of the computer system through the first connector means, and supplying the power as operation power of the power load terminal. Preferably, the power supply means includes: a charging state detecting means for detecting a charging state of a battery of the power load terminal; a charging state display means for displaying the state of the battery according to a detection result of the charging state detecting means; a power supply control means for controlling supply of the stabilized power to the power load terminal according to the detection result of the charging state detecting means; and a power cable connection jack for supplying the power from the power supply control means to the power load terminal through a power cable.

Preferably, the second connector means includes: a power cable device having a first power connection plug, a power cable and a second power connection plug connected to the power supply jack of the power load terminal; and a power jack connected to the first connector means, for supplying the power to the power load terminal through the medium of the power cable, the first power connection plug being connected to the power jack.

In order to achieve yet another object of the invention, in the fourth aspect of the invention, a keyboard device includes at least one connector means for supplying key scan power transmitted from a keyboard connection port of a computer system to a power load terminal.

Here, preferably, the power load terminal is selected from a portable communication terminal, portable audio reproducing device and speaker.

Preferably, the portable communication terminal is selected from CDMA and GSM cellular phones, PCS phone and PDA, and the portable audio reproducing device is selected from an MP3 player, portable cassette tape player and portable compact disk player.

Preferably, the keyboard device further includes a power stabilizing means for stabilizing the key scan power as supply power of the power load terminal.

Preferably, the keyboard device further includes: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

The connector means supplies the power from the power stabilizing means to the power load terminal through the medium of a power cable device including a first power connection plug, a power cable and a second power connection plug connected to a power supply jack of the power load terminal, and includes a power jack to which the first power connection plug is connected.

The keyboard device includes: a charging means for charging power by using the key scan power; and a charging power supply means for supplying the charging power from the charging means to the connector means when the key scan power is not supplied from the computer system.

The keyboard device further includes a photoelectric transducer; and a photoelectric transducing means for stabilizing the power of the photoelectric transducer, and supplying the power to the charging means.

In addition, the keyboard device further includes: a power jack for receiving DC power from a power adapter means for converting the AC power to DC power; and a power supply means for supplying the DC power from the power jack to the connector means when the key scan power is not supplied from the computer system.

In order to achieve yet another object of the invention, in the fifth aspect of the invention, a keyboard device includes: a power stabilizing means for stabilizing key scan power transmitted from a keyboard connection port of a computer system; a data communication means for processing data communication with a portable communication terminal; and a connector means for transmitting the power from the power stabilizing means and the data from the data communication means to the portable communication terminal.

Here, preferably, the connector means supplies the power and data to the portable communication terminal through the medium of a cable device including a first connection plug, a cable and a second connection plug connected to a power/data I/O jack of the portable communication terminal, and includes a power/data connection jack to which the first connection plug is connected.

Preferably, the power stabilizing means includes: a charging state detecting means for detecting a charging state of a battery of the portable communication terminal; a charging state display means for displaying the state according to a detection result of the charging state detecting means; and a power supply means for supplying the power stabilized by the power stabilizing means to the connector means according to the detection result of the charging state detecting means.

In addition, preferably, the keyboard device further includes: a short message mode setup means for setting up a short message mode for inputting a short message to the portable communication terminal; a memory means for storing short message data inputted through an operation panel in the short message mode; and a short message transmitting means for transmitting the short message data stored in the memory means to the portable communication terminal through the data communication means. Otherwise, the keyboard device further includes a short message mode setup means for transmitting short message data inputted through an operation panel to the portable communication terminal through the data communication means.

Preferably, an exclusive use keyboard drive program for displaying the short message inputted to the portable communication terminal on a monitor device is installed in the computer system. The short message mode setup means transmits a control signal for displaying a short message window on the monitor device of the computer system by the keyboard drive program in the short message mode to the computer system.

In order to achieve yet another object of the invention, in the sixth aspect of the invention, a keyboard device includes: a power stabilizing means for stabilizing key scan power transmitted from a keyboard connection port of a computer system; a data communication means for processing data communication with a portable communication terminal; and a connector means for transmitting the power from the power stabilizing means to the portable communication terminal, and exchanging data between the data communication means and the portable communication terminal. The connector means connects the power stabilizing means and the data communication means to the portable communication terminal through the medium of a cable device including a first connection plug, a data converting means for converting the data between the data communication means and the portable communication terminal, and a second connection plug connected to a power/data I/O jack of the portable communication terminal, and includes a power/data connection jack to which the first connection plug is connected.

In order to achieve yet another object of the invention, in the seventh aspect of the invention, a keyboard device includes: a power stabilizing means for stabilizing key scan power transmitted from a keyboard connection port of a computer system; a data communication means for processing data communication with a portable communication terminal; a data converting means for converting data between the data communication means and the portable communication terminal; a connector means for supplying the power from the power stabilizing means to the portable communication terminal, and exchanging the data between the data communication means and the portable communication terminal; and a portable communication terminal control mode setup means for setting up a portable communication terminal control mode. An exclusive use portable communication terminal control drive program for displaying a short message inputted to the portable communication terminal on a monitor device is installed in the computer system. The portable communication terminal control mode setup means transmits a control signal for displaying a portable communication terminal control window on the monitor device of the computer system by the portable communication terminal control drive program in the portable communication terminal control mode to the computer system.

Here, preferably, the power stabilizing means includes: a charging state detecting means for detecting a charging state of a battery of the portable communication terminal; a charging state display means for displaying the state according to a detection result of the charging state detecting means; and a power supply means for transmitting the power stabilized by the power stabilizing means to the connector means according to the detection result of the charging state detecting means.

The keyboard device further includes a memory means for storing detailed information corresponding to phone numbers. The detailed phone number information is inputted, corrected or deleted through the portable communication terminal control window by the communication drive program installed in the computer system.

In the keyboard device of the invention, when the portable communication terminal receives caller phone number information and transmits the information to the data communication means through the medium of the connector means, the data communication means searches detailed information corresponding to the caller phone number information from the memory means, and transmits the caller phone number information and the searched detailed information to the computer system, and the computer system displays the caller phone number information and the detailed information on the portable communication terminal control window by the portable communication terminal control drive program.

In the keyboard device of the invention, in the case that the portable communication terminal receives a short message and transmits it to the data communication means through the medium of the connector means, the data communication means transmits the short message to the computer system, and the computer system displays the short message on the portable communication terminal control window by the portable communication terminal control drive program.

In addition, the keyboard device of the invention inputs a receiver phone number and a short message through the portable communication terminal control window, and transmits short message information including the receiver phone number and the short message to the portable communication terminal through the medium of the data communication means and the connector means by the portable communication terminal control drive program, and the portable communication terminal separates the phone number and the short message from the short message information, and transmits the short message to the phone number.

The keyboard device of the invention demands setup information of the portable communication terminal to the portable communication terminal through the medium of the data communication means and the connector means by the portable communication terminal control drive program. The portable communication terminal transmits the predetermined setup information to the computer system through the connector means and the data communication means upon the setup information request. The computer system receiving the setup information displays the setup information on the portable communication terminal control window by the communication drive program. When the computer system receives a renewal request for correcting the setup information through the portable communication terminal control window, the computer system transmits the corrected setup information to the portable communication terminal through the data communication means and the connector means by the communication drive program, and the portable communication terminal sets up the corrected setup information as new setup information.

### BRIEF DESCRIPTION OF THE DRAWINGS

The present invention will become better understood with reference to the accompanying drawings which are given only by way of illustration and thus are not limitative of the present invention, wherein:

FIG. 1 is a view illustrating a power supply device for a portable communication terminal using a peripheral device connection port of a computer system in accordance with the first embodiment of the present invention;

FIG. 2 is a view illustrating the circuit construction of the power supply device of FIG. 1;

FIG. 3 is a view illustrating a power supply device for a portable communication terminal using a peripheral device connection port of a computer system in accordance with the second embodiment of the present invention;

FIG. 4 is a view illustrating one example of the circuit construction of the power supply device of FIG. 2;

FIG. 5 is a view illustrating another example of the circuit construction of the power supply device of FIG. 2;

FIG. 6 is a view illustrating a power supply device for a portable communication terminal using a peripheral device connection port of a computer system in accordance with the third embodiment of the present invention;

FIG. 7 is a view illustrating the circuit construction of the power supply device of FIG. 6;

FIG. 8 is a view illustrating a power supply device for a portable communication terminal using a peripheral device connection port of a computer system in accordance with the fourth embodiment of the present invention;

FIG. 9 is a view illustrating a power supply device for a portable communication terminal using a peripheral device connection port of a computer system in accordance with the fifth embodiment of the present invention;

FIG. 10 is a view illustrating a power supply device for a portable communication terminal using a peripheral device connection port of a computer system in accordance with the sixth embodiment of the present invention;

FIG. 11 is a view illustrating the circuit construction of the power supply device of FIG. 10;

FIG. 12 is a view illustrating a power supply device for a portable communication terminal using a peripheral device connection port of a computer system in accordance with the seventh embodiment of the present invention;

FIG. 13 is a view illustrating the circuit construction of the power supply device of FIG. 12;

FIG. 14 is a view illustrating a power supply device for a portable communication terminal using a peripheral device connection port of a computer system in accordance with the eighth embodiment of the present invention;

FIG. 15 is a view illustrating the circuit construction of the power supply device of FIG. 14;

FIGS. 16 to 21 are views illustrating a power supply device for a portable communication terminal using a peripheral device connection port of a computer system in accordance with the ninth to fourteenth embodiments of the present invention;

FIG. 22 is a view illustrating a power supply and data repeater device for a portable communication terminal using a peripheral device connection port of a computer system in accordance with the fifteenth embodiment of the present invention;

FIG. 23 is a view illustrating one example of the circuit construction of the power supply and data repeater device of FIG. 22;

FIG. 24 is a view illustrating a power supply and data repeater device for a portable communication terminal using a peripheral device connection port of a computer system in accordance with the sixteenth embodiment of the present invention;

FIG. 25 is a circuit view illustrating the power supply and data repeater device of FIG. 24;

FIG. 26 is a view illustrating a power supply and data repeater device for a portable communication terminal using a peripheral device connection port of a computer system in accordance with the seventeenth embodiment of the present invention;

FIG. 27 is a view illustrating one example of the circuit construction of the power supply and data repeater device of FIG. 26;

FIGS. 28 to 35 are views illustrating a power supply and data repeater device for a portable communication terminal using a peripheral device connection port of a computer system in accordance with the eighteenth to twenty-fifth embodiments of the present invention;

FIG. 36 is a view illustrating a power supply and data repeater device for a portable communication terminal using a peripheral device connection port of a computer system in accordance with the twenty-sixth embodiment of the present invention;

FIG. 37 is a view illustrating one example of the circuit construction of the power supply and data repeater device of FIG. 36;

FIG. 38 is a view illustrating a power supply and data repeater device for a portable communication terminal using a peripheral device connection port of a computer system in accordance with the twenty-seventh embodiment of the present invention;

FIG. 39 is a view illustrating a power supply and data repeater device for a portable communication terminal using a peripheral device connection port of a computer system in accordance with the twenty-eighth embodiment of the present invention;

FIG. 40 is a view illustrating one example of the circuit construction of the power supply and data repeater device of FIG. 39;

FIG. 41 is a view illustrating a power supply and data repeater device for a portable communication terminal using a peripheral device connection port of a computer system in accordance with the twenty-ninth embodiment of the present invention;

FIG. 42 is a circuit view illustrating the power supply and data repeater device of FIG. 41;

FIG. 43 is a view illustrating a power supply and data repeater device for a portable communication terminal using a peripheral device connection port of a computer system in accordance with the thirtieth embodiment of the present invention;

FIG. 44 is a view illustrating one example of the circuit construction of the power supply and data repeater device of FIG. 43;

FIGS. 45 to 47 are views illustrating an operation relation in a state where the power supply and data repeater device of the fifteenth (FIG. 22) to thirtieth (FIG. 43) embodiments is connected to the portable communication terminal and the computer system;

FIG. 48 is a flowchart showing a process of installing a portable communication terminal control driving drive program for embodying the power supply and data repeater device in the computer system in accordance with the present invention;

FIGS. 49(a) to 49(c) are exemplary views for showing the flow of FIG. 48;

FIG. 50 is a flowchart for showing an operation when the portable communication terminal receives caller information and a short message, in a state where the power supply and data repeater device of the fifteenth (FIG. 22) to thirtieth (FIG. 43) embodiments is connected to the portable communication terminal and the computer system;

FIG. 51 is a flowchart showing an operation for transmitting a short message to the portable communication terminal by using a short message input device of the computer system, in a state where the power supply and data repeater device of the fifteenth (FIG. 22) to thirtieth (FIG. 43) embodiments is connected to the portable communication terminal and the computer system;

FIGS. 52(a) and 52(b) are exemplary views for showing the flow of FIG. 51;

FIG. 53 is a flowchart showing an operation for renewing phone number information of the power supply and data repeater device, in a state where the power supply and data repeater device of the fifteenth (FIG. 22) to thirtieth (FIG. 43) embodiments is connected to the portable communication terminal and the computer system;

FIG. 54 is an exemplary view for showing the flow of FIG. 53;

FIG. 55 is a flowchart showing an operation relation for renewing setup information of the portable communication terminal by using an input device of the computer system, in a state where the power supply and data repeater device of the fifteenth (FIG. 22) to thirtieth (FIG. 43) embodiments is connected to the portable communication terminal and the computer system;

FIGS. 56(a) and 56(b) are exemplary views of FIG. 55;

FIG. 57 is an outline external view illustrating a keyboard device having a portable communication terminal connection structure in accordance with the thirty-first embodiment of the present invention;

FIG. 58 is a block diagram illustrating an internal circuit of the keyboard device having the portable communication terminal connection structure of FIG. 57 in accordance with the thirty-first embodiment of the present invention;

FIG. 59 is a block diagram illustrating another internal circuit of the keyboard device having the portable communication terminal connection structure of FIG. 57 in accordance with the thirty-first embodiment of the present invention;

FIG. 60 is a schematic external view illustrating a keyboard device having a portable communication terminal connection structure in accordance with the thirty-second embodiment of the present invention;

FIG. 61 is a block diagram illustrating an internal circuit of the keyboard device having the portable communication terminal connection structure of FIG. 60 in accordance with the thirty-second embodiment of the present invention;

FIG. 62 is an outline external view illustrating a keyboard device having a portable communication terminal connection structure in accordance with the thirty-third embodiment of the present invention;

FIG. 63 is a block diagram illustrating an internal circuit of the keyboard device having the portable communication terminal connection structure of FIG. 62 in accordance with the thirty-third embodiment of the present invention;

FIG. 64 is a flowchart showing one example of a short message service method of a keyboard device having a portable communication terminal connection structure in accordance with the present invention;

FIG. 65 is a view illustrating an operation relation in a state where a keyboard device having a portable communication terminal connection structure is connected to a portable communication terminal and a computer system in accordance with the present invention;

FIG. 66 is a flowchart showing a process of installing a keyboard drive program for embodying compatibility of a keyboard device having a portable communication terminal connection structure and a computer system in the computer system in accordance with the present invention;

FIG. 67 is a flowchart showing an operation when a keyboard device is linked to a computer, in a state where the keyboard device having a portable communication terminal connection structure is connected to a portable communication terminal and a computer system in accordance with the present invention;

FIG. 68 is an external view illustrating a keyboard device having a portable communication terminal control function in accordance with the thirty-fourth embodiment of the present invention;

FIG. 69 is a block diagram illustrating an internal circuit of the keyboard device having the portable communication terminal control function of FIG. 68 in accordance with the present invention;

FIG. 70 is an external view illustrating a keyboard device having a portable communication terminal control function in accordance with the thirty-fifth embodiment of the present invention;

FIG. 71 is a block diagram illustrating an internal circuit of the keyboard device having the portable communication terminal control function of FIG. 70 in accordance with the present invention;

FIG. 72 is a view illustrating an operation relation in a state where a keyboard device having a portable communication terminal control function is connected to a portable communication terminal and a computer system in accordance with the present invention;

FIG. 73 is a flowchart showing a process of installing a keyboard drive program for embodying compatibility of a keyboard device having a portable communication terminal control function and a computer system in the computer system in accordance with the present invention;

FIG. 74 is a flowchart showing an operation when a portable communication terminal receives caller information and a short message, in a state where a keyboard device having a portable communication terminal control function is connected to a portable communication terminal and a computer system in accordance with the present invention;

FIG. 75 is a flowchart showing an operation of transmitting a short message to a portable communication terminal by using a short message input device of a computer system, in a state where a keyboard device having a portable communication terminal control function is connected to the portable communication terminal and the computer system in accordance with the present invention;

FIG. 76 is a flowchart showing an operation of renewing phone number information of a keyboard device, in a state where the keyboard device having a portable communication terminal control function is connected to a portable communication terminal and a computer system in accordance with the present invention; and

FIG. 77 is a flowchart showing an operation of renewing setup information of a portable communication terminal by using an input device of a computer system, in a state where the keyboard device having a portable communication terminal control function is connected to the portable communication terminal and the computer system in accordance with the present invention.

### DETAILED DESCRIPTION OF THE PREFERRED EMBODIMENTS

A power supply and data repeater device for a portable communication terminal using a peripheral device connection port of a computer system, and a keyboard device having a portable communication terminal connection structure and control function in accordance with preferred embodiments of the present invention will now be described in detail with reference to the accompanying drawings.

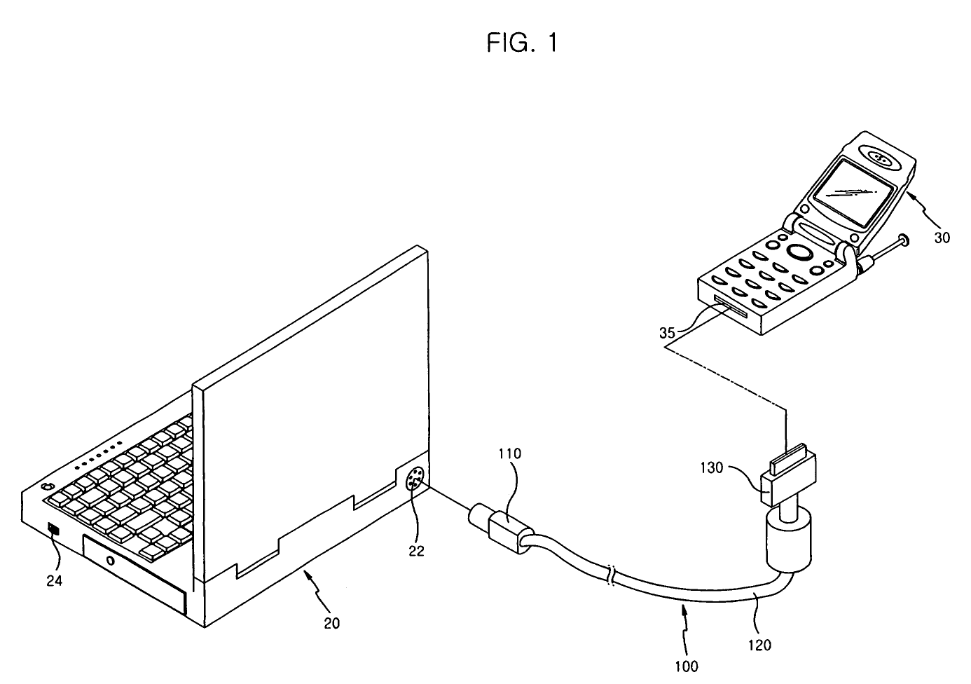

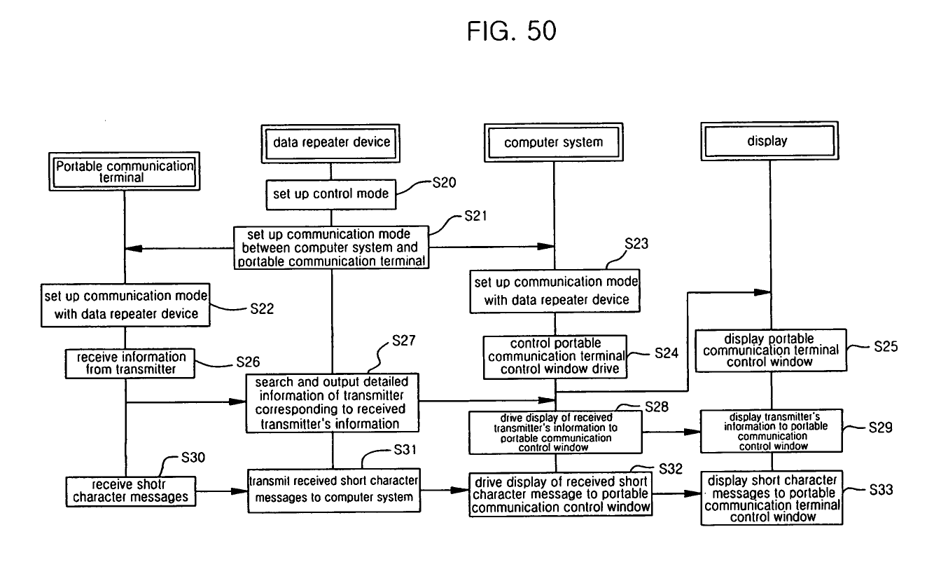

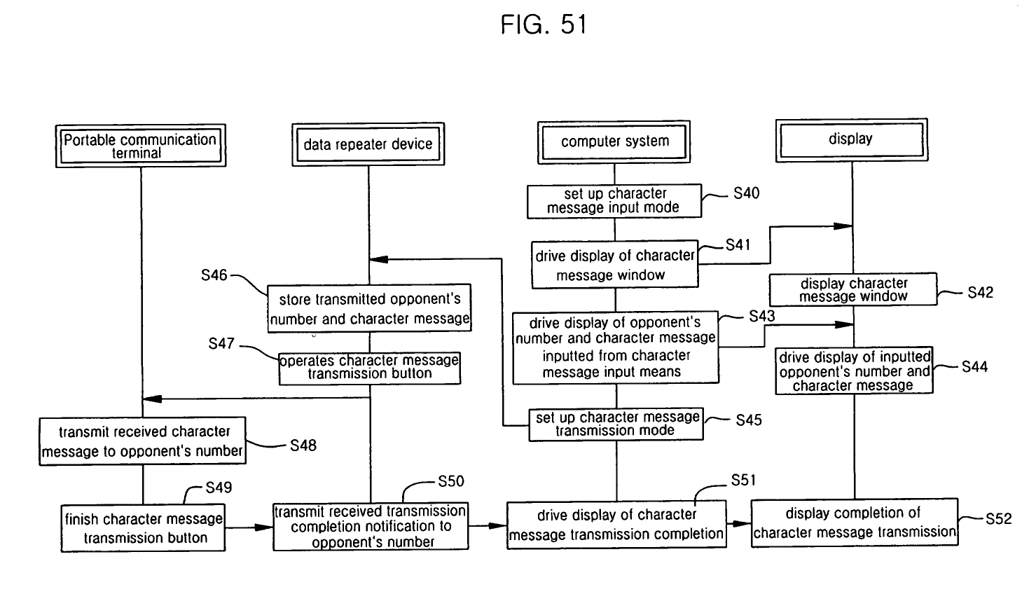

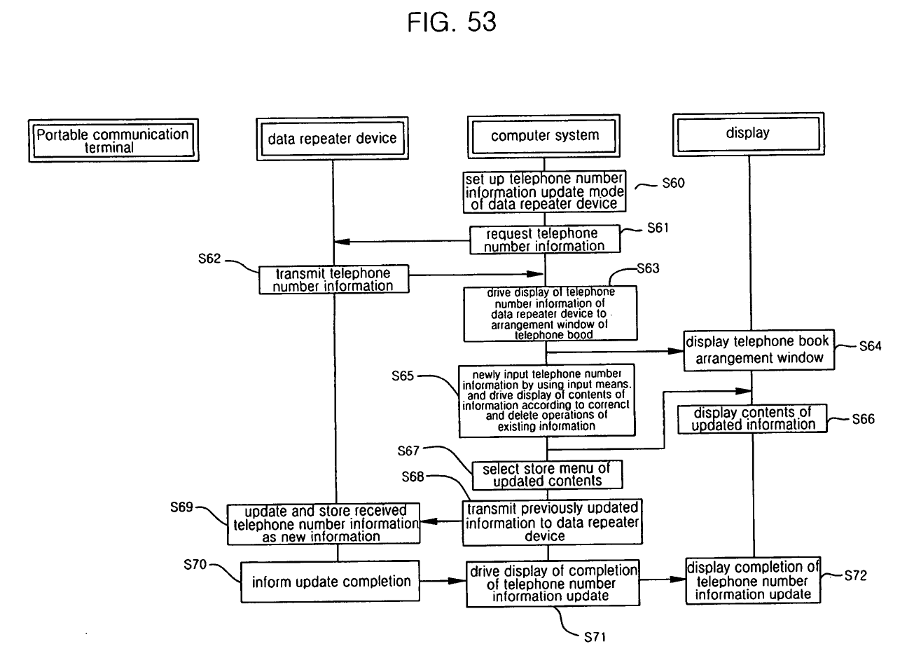

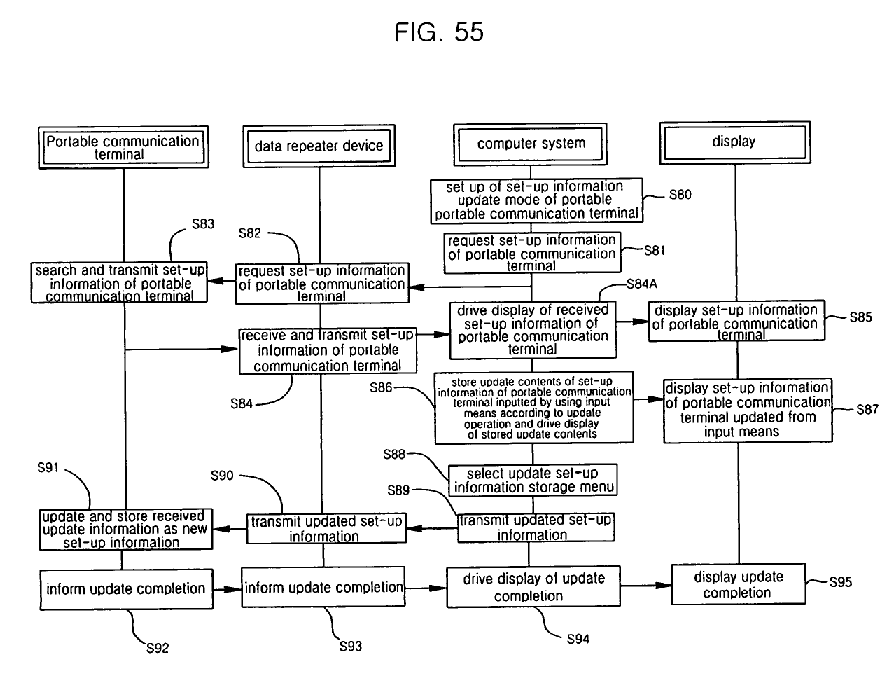

A power supply and data repeater device for a portable communication terminal using a peripheral device connection port of a computer system in accordance with the first to thirtieth embodiments of the present invention will now be explained in detail with reference to FIGS. 1 to 56.

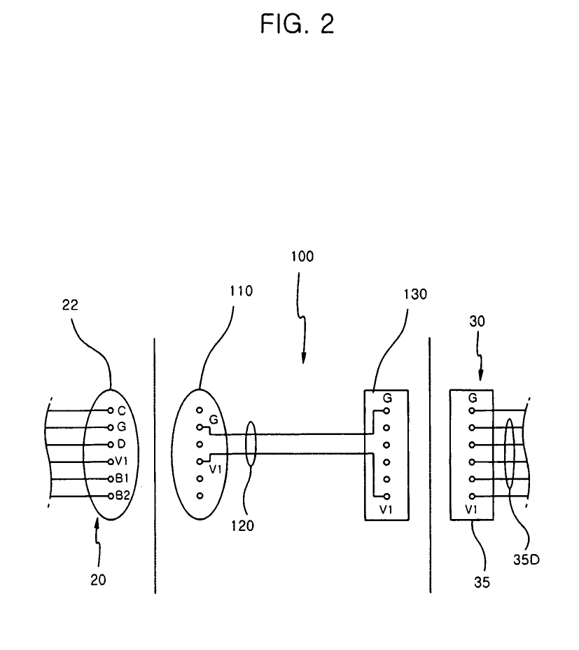

Firstly, the power supply device for the portable communication terminal using the peripheral device connection port of the computer system in accordance with the first embodiment of the present invention will now be explained with reference to FIGS. 1 and 2.

Referring to FIG. 1, in a power supply device 100 according to the first embodiment of the present invention, a keyboard/mouse connection plug 110 connected to a keyboard/mouse connection jack (port) 22 for connecting a keyboard or mouse in a notebook computer system (or desktop computer system main body) 20 is formed at one end of the power supply device 100, and a power plug 130 connected to a power jack (power/data I/O jack 35) of a charging load terminal (for example, portable communication terminal 30) for transmitting operation power or battery charging power of the charging load terminal (portable communication terminal 30) is formed at the other end of the power supply device 100 through the medium of a cable 120.

Generally, key scan power (about 5V) is transmitted to the data input port 22 to which the keyboard or mouse of the notebook computer system and the desktop computer system is connected, for detecting a key operation state of the externally-connected keyboard or mouse.

Therefore, in the power supply device 100 of the first embodiment, when the keyboard/mouse connection plug 110 is connected to the keyboard/mouse connection jack 22 of the computer system 20, the key scan power transmitted to the keyboard/mouse connection jack 22 can be used as power for operating the charging load terminal (for example, portable communication terminal 30) connected to the power plug 130 or charging a battery.

The charging load terminal connected to the power plug 130 is not restricted to a portable communication terminal (cellular phone, PDA and PCS), MP3 player, CD player and cassette tape player, but includes a speaker or internet phone which uses the key scan power as the operation power or battery charging power.

As shown in FIG. 2, the keyboard/mouse connection jack 22 for the computer system 20 has a clock pin C, ground pin G, data pin D, power pin V1 and one or two non-used pins B1 and B2, and the power/data I/O jack 35 of the portable communication terminal 30 has a ground pin G, a power pin V1 and a plurality of data pins 35D.

The plug 110 inserted and connected to the keyboard/mouse connection jack 22 of the computer system 20 has pins connected to the pins C, G, D, V1, B1 and B2 of the keyboard/mouse connection jack 22. Here, the ground pin G and the power pin V2 connected to the ground pin and the power pin are electrically connected to the cable 120, but the other pins are electrically insulated therefrom.

In addition, the power plug 130 inserted and connected to the power jack of the charging load terminal (for example, power/data I/O jack 35 of the portable communication terminal 30) has a ground pin G and a power pin V1 electrically connected to the ground pin and the power pin of the keyboard/mouse connection plug 110, and a plurality of electrically-insulated pins corresponding to the data pins of the power/data I/O jack 35 of the portable communication terminal 30.

When the power supply device 110 is connected to the keyboard/mouse connection jack 22 of the computer system 20 and the power jack of the charging load terminal (for example, power/data I/O jack 35 of the portable communication terminal 30), the ground pin G and the power pin V1 of the keyboard/mouse connection jack 22 are electrically connected to the ground pin and the power pin of the power jack of the charging load terminal (for example, power/data I/O jack 35 of the portable communication terminal 30) to have the identical potential, but the other pins are not electrically connected.

Accordingly, the key scan power from the keyboard/mouse connection jack 22 of the computer system 20 is supplied as operation power or battery charging power of the charging load terminal (for example, portable communication terminal 30) through the power jack of the charging load terminal (for example, power/data I/O jack 35 of the portable communication terminal 30).

In the embodiment shown in FIG. 2, the keyboard/mouse connection jack 22 have six pins but may have a different pin structure, for example, five pins (i.e., clock pin, ground pin, data pin, power pin and non-used pin). The power/data I/O jack 35 of the portable communication terminal 30 have the ground pin G, the power pin V1 and the plurality of data pins 35D, but may also have a different pin structure.

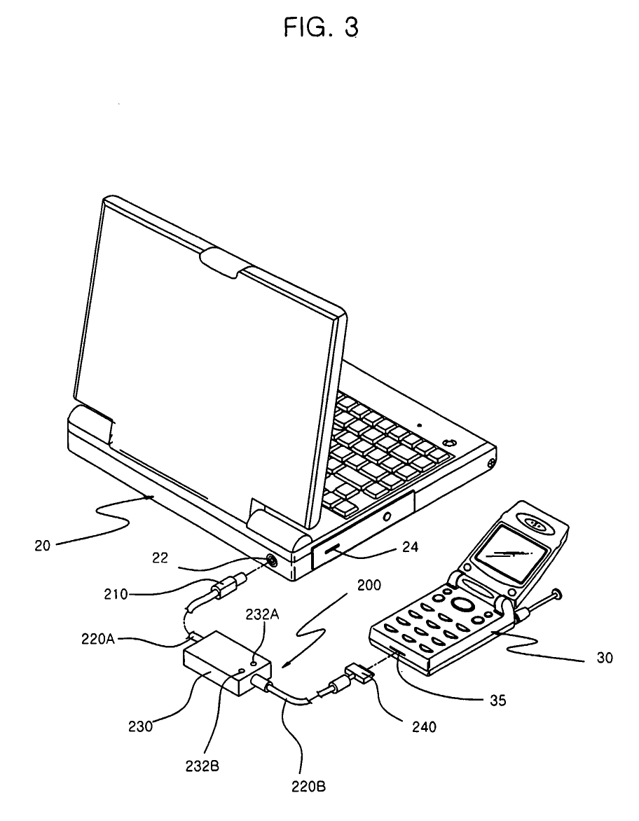

The power supply device for the portable communication terminal using the peripheral device connection port of the computer system in accordance with the 2nd embodiment of the present invention will now be explained with reference to FIGS. 3 to 5.

As compared with the power supply device 100 of the first embodiment, the power supply device 200 further includes a power control block 230 in the middle of the cable. That is, a power control printed circuit board is built in the power control block 230, and charging display devices 232A and 232B are protruded from the power control block 230. The power control block 230 has its one end connected to a plug 210 inserted and connected to the keyboard/mouse connection jack 22 of the computer system 20 through the medium of a first cable 220A, and its other end connected to a power plug 240 inserted and connected to the power/data I/O jack 35 of the charging load terminal, for example the portable communication terminal 30 through the medium of a second cable 220B.

Here, the charging display devices 232A and 232B are for example, two light emitting diode (LED) devices including a red LED device displaying a charging operation and a green LED device displaying completion of the charging operation.

The portable communication terminal is exemplified as the charging load terminal, but the power supply device 200 can be applied to the PDA, a portable audio device (MP3 player, cassette tape player, CD player, etc.) and a speaker as well as the cellular phone.

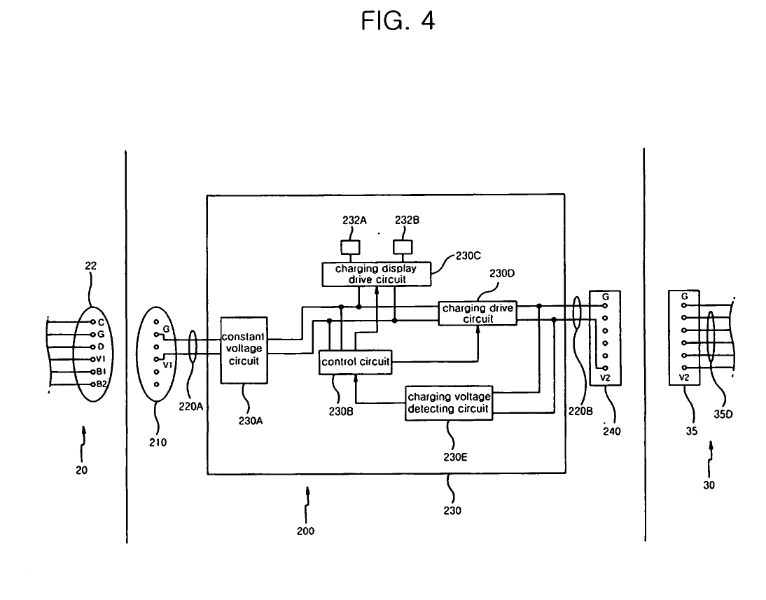

The circuit construction of the power control block 230 of FIG. 3 will now be explained with reference to FIG. 4.

As illustrated in FIG. 4, the power control block 230 includes a constant voltage circuit 230A, a charging drive circuit 230D, a charging voltage detecting circuit 230E, a charging display drive circuit 230C, charging display devices 232A and 232B and a control circuit 230B.

The constant voltage circuit 230A rectifies and stabilizes the key scan power inputted from the ground pin G and the power pin V1 of the keyboard/mouse connection jack 22 of the computer system 20 through the plug 210 and the first cable 220A, and outputs power of a required level.

The charging drive circuit 230D provides operation power to the portable communication terminal 30 and charges a battery (not shown), by transmitting the power of the constant voltage circuit 230A to the ground pin G and the power pin V2 of the power/data I/O jack 35 of the portable communication terminal 30 through the medium of the second cable 220B and the power plug 240.

The charging display drive circuit 230C drives the first charging display device 232A displaying the charging operation and the second charging display device 232B displaying completion of the charging operation under the control of the control circuit 230B, and the charging voltage detecting circuit 230E detects a charging voltage of the battery of the portable communication terminal 30.

The control circuit 230B confirms a charging state (overcharging state) and a connection state of the charging load terminal, for example the portable communication terminal 30 on the basis of the voltage detected by the charging voltage detecting circuit 230E. When the power load terminal (for example, portable communication terminal 30) is not overcharged, the control circuit 230B controls the charging drive circuit 230D to constantly output the power to the power/data I/O jack 35 of the charging load terminal, namely the portable communication terminal 30 through the medium of the second cable 220B and the power plug 240, and simultaneously controls the charging display drive circuit 230C to enable the first charging display device 232A to display the charging operation. In the case that the power load terminal (for example, portable communication terminal 30) is overcharged, the control circuit 230B controls the charging drive circuit 230D not to output the power to the power/data I/O jack 35 of the charging load terminal, namely the portable communication terminal 30 through the medium of the second cable 220B and the power plug 240, and simultaneously controls the charging display drive circuit 230C to enable the second charging display device 232B to display completion of the charging operation. When the charging load terminal, namely the portable communication terminal 30 is not connected, the control circuit 230B controls the charging display drive circuit 230C to stop the display operation of the first and second charging display devices 232A and 232B.

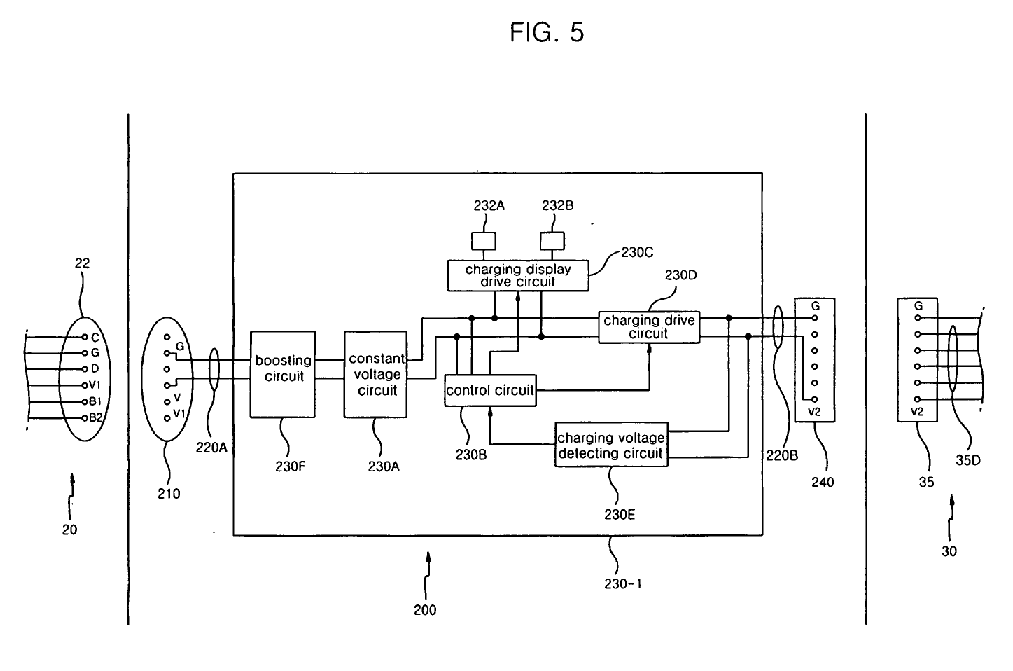

Another example of the circuit structure of the power control block of FIG. 3 will now be explained with reference to FIG. 5.

As depicted in FIG. 5, the power control block 230-1 further includes a boosting circuit 230F in the preceding terminal of the constant voltage circuit 230A, as compared with the power control block 230 of FIG. 4.

The boosting circuit 230F is used when the key scan power from the keyboard/mouse connection jack 22 of the computer system 20 is lower or may be lower than the charging power or operation power for the charging load terminal (for example, portable communication terminal 30). Here, the boosting circuit 230F boosts the key scan power of the computer system 20 to a higher level than the charging or operation power level, and the constant voltage circuit 230A rectifies and stabilizes the power, thereby outputting the power with the charging voltage level.

About 5V and 550 mA key scan power is outputted from the pins G and V1 of the keyboard/mouse connection jack 22. For example, when the charging power of the charging load terminal, namely the portable communication terminal 30 is about 4.2V (460 mA), since a voltage lower than 4.2V may be outputted from the keyboard/mouse connection jack 22 of the computer system 20, the boosting circuit 230F boosts the power to a level of about 7V, and the constant voltage circuit 230A makes the power have a voltage level required by the charging load terminal.

As described above, the power supply device in accordance with the embodiment of FIGS. 3 to 5 can charge the battery of the portable communication terminal 30 which is the charging load terminal.

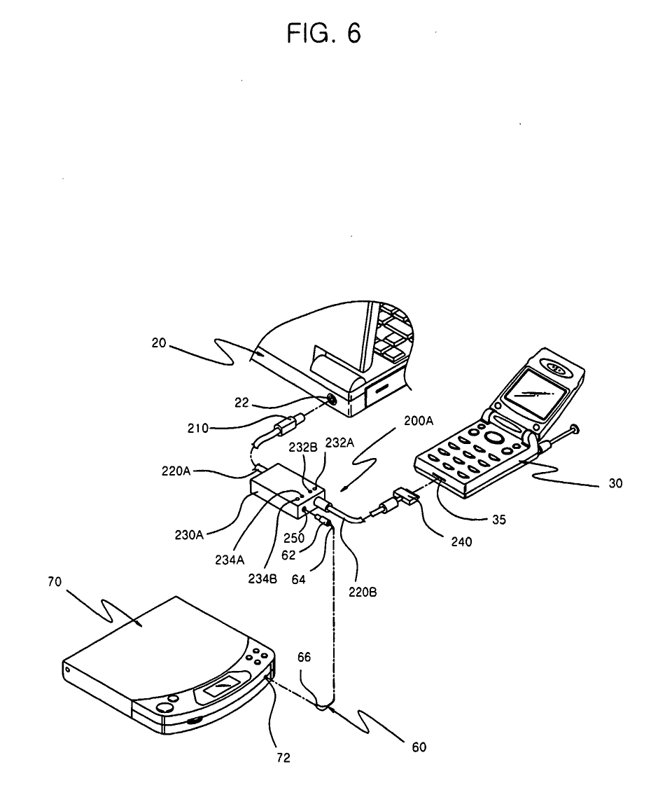

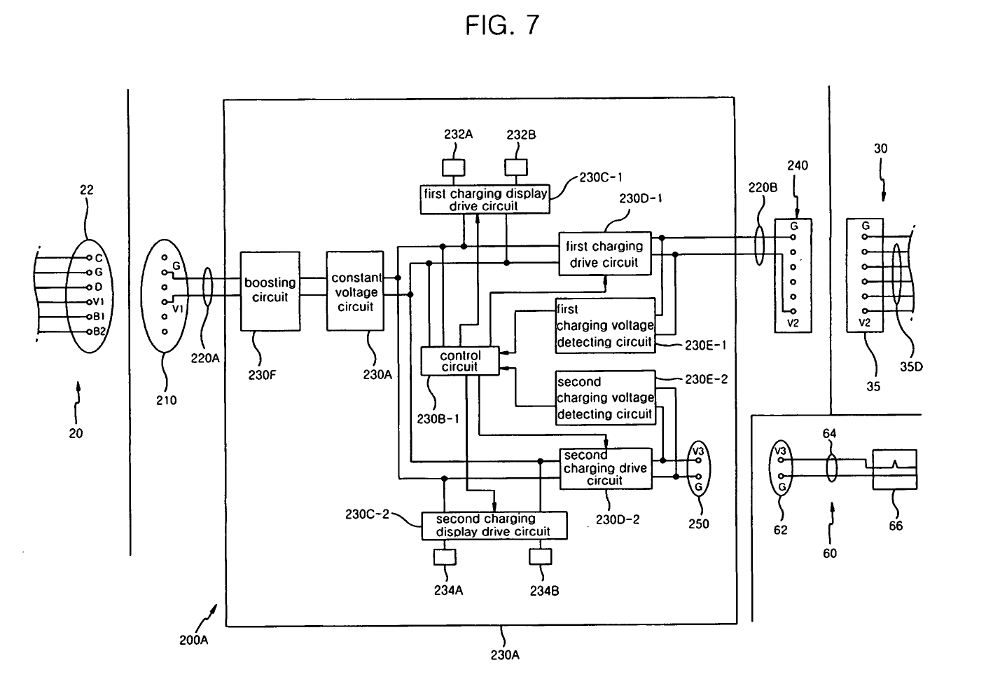

The power supply device for the portable communication terminal using the peripheral device connection port of the computer system in accordance with the third embodiment of the present invention will now be explained with reference to FIGS. 6 and 7.

As compared with the power supply device 200 of the second embodiment, the power supply device 200A further includes a structure for charging a portable audio device 70 (MP3 player, cassette tape player, CD player, etc.), in addition to the structure for charging the portable communication terminal 30.

In addition to the charging display devices 232A and 232B for the portable communication terminal 30, charging display devices 234A and 234B for the portable audio device 70 are further protruded from the power control block 230A, and a power jack 250 for supplying the charging power to the portable audio device 70 is further installed in the power control block 230A.

Here, the charging display devices 234A and 234B are two LED devices having, for example a red LED device displaying the charging operation and a green LED device displaying completion of the charging operation.

A power supply cable 60 of the portable audio device 70 is inserted and connected to the power jack 250.

The power supply cable 60 of the portable audio device 70 includes: a plug 62 inserted and connected to the power jack 250 of the power supply device 200A; a plug 66 inserted and connected to the power jack 72 of the portable audio device 70; and a cable 64 for connecting the plugs 62 and 66, which are incorporated.

The circuit construction of the power control block 230A of FIG. 6 will now be described with reference to FIG. 7. As shown therein, as compared with the power control block of FIG. 5, the power control block 230A further includes a second charging drive circuit 230D-2, a second charging voltage detecting circuit 230E-2, a power jack 250, a second charging display drive circuit 230C-2 and charging display devices 234A and 234B. A first charging drive circuit 230D-1, a first charging voltage detecting circuit 230E-1 and a first charging display drive circuit 230C-1 have the same function as the charging drive circuit 230D, the charging voltage detecting circuit 230-E and the charging display drive circuit 230C of FIG. 5.

For brief explanations, the differences between the power control blocks of FIGS. 5 and 6 will now be explained.

The second charging drive circuit 230D-2 transmits the power of the constant voltage circuit 230A to a ground pin G and a power pin V3 of the power plug 62 of the power supply cable 60 through the medium of the power jack 250, to provide the operation power to the portable audio device 70 and charge a battery (not shown) of the portable audio device 70.

Here, the second charging drive circuit 230D-2 may reduce or boost the output power of the constant voltage circuit 230A to supply the sufficient power to the charging load terminal.

The second charging display drive circuit 230C-2 drives the first charging display device 234A displaying the charging operation of the portable audio device 70 and the second charging device 234B displaying completion of the charging operation under the control of the control circuit 230B-1, and the second charging voltage detecting circuit 230E-2 detects the charging voltage of the battery of the portable audio device 70.

The control circuit 230B-2 performs the function explained referring to FIGS. 4 and 5, and confirms a charging state (overcharging state) of the battery of the portable audio device 70 and a connection state of the power load terminal on the basis of the voltage detected by the second charging voltage detecting circuit 230E-2. When the battery of the portable audio device 70 is not overcharged, the control circuit 230B-2 controls the second charging drive circuit 230D-2 to constantly output the power to the power jack 72 of the portable audio device 70 through the medium of the power jack 250 and the power supply cable 60, and simultaneously controls the second charging display drive circuit 230C-2 to enable the first charging display device 234A to display the charging operation. In the case that the battery of the portable audio device 70 is overcharged, the control circuit 230B-2 controls the second charging drive circuit 230D-2 not to output the power to the power jack 72 of the portable audio device 70 through the medium of the power jack 250 and the power supply cable 60, and simultaneously controls the second charging display drive circuit 230C-2 to enable the second charging display device 234B to display completion of the charging operation. When the portable audio device 70 is not connected, the control circuit 230B-2 controls the second charging display drive circuit 230C-2 to stop the display operation of the first and second charging display devices 234A and 234B.

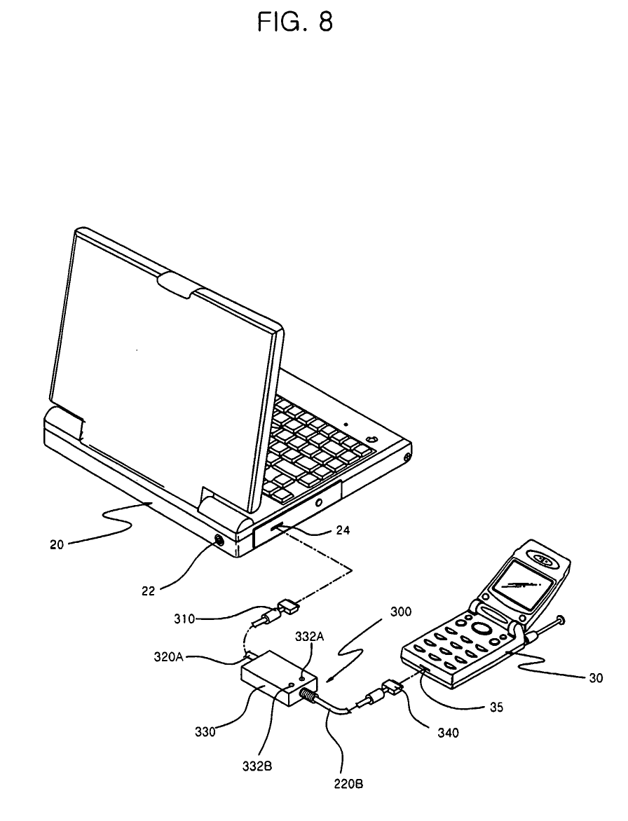

The power supply device for the portable communication terminal using the peripheral device connection port of the computer system in accordance with the fourth embodiment of the present invention will now be explained with reference to FIG. 8.

As compared with the power supply device of the second embodiment in FIG. 3, the power supply device 300 is not connected to the keyboard/mouse connection jack 22 of the computer system 20 but to a USB jack 24.

That is, the power supply device 300 includes: a USB plug 310 connected to the USB jack 24 of the computer system 20; a power control block 330 in which a power control printed circuit board is installed, and from which charging display devices 332A and 332B are protruded; a power plug 340 connected to a power jack of a charging load terminal (for example, power/data I/O jack 35 of the portable communication terminal 30); a first cable 320A for connecting the USB plug 310 to the power control block 330; and a second cable 320B for connecting the power control block 330 to the power plug 340, which are incorporated.

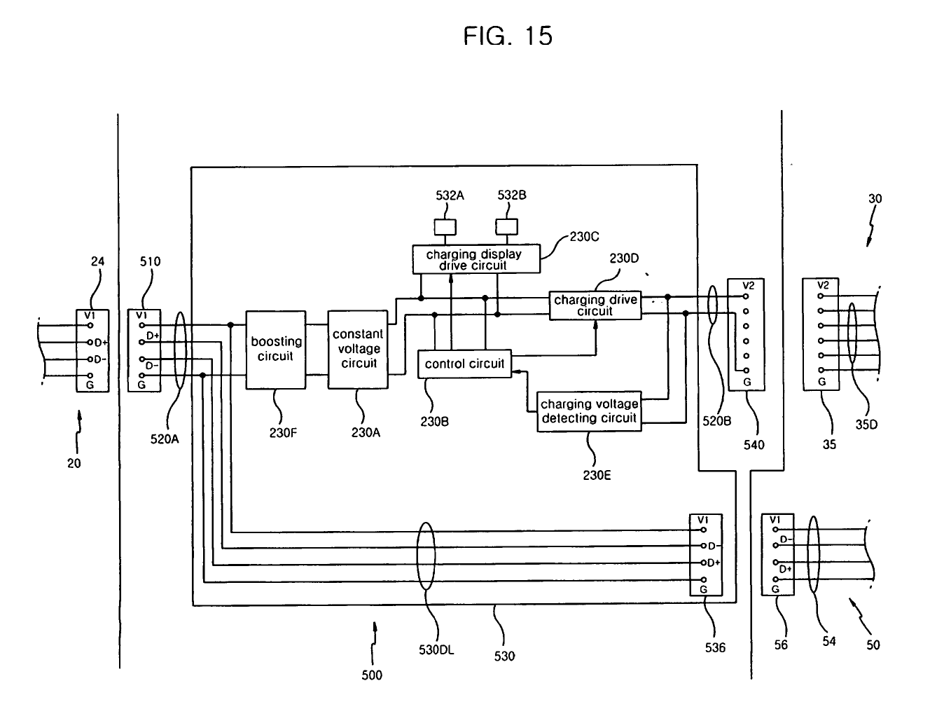

The power supply device 300 has the same circuit structure as the power supply device of FIGS. 4 and 5. However, the structure of the USB jack 24 and the USB plug 310 is identical to a structure of a USB jack 24 and a USB plug 510 of FIG. 15, and thus detailed explanations thereof will later be explained.

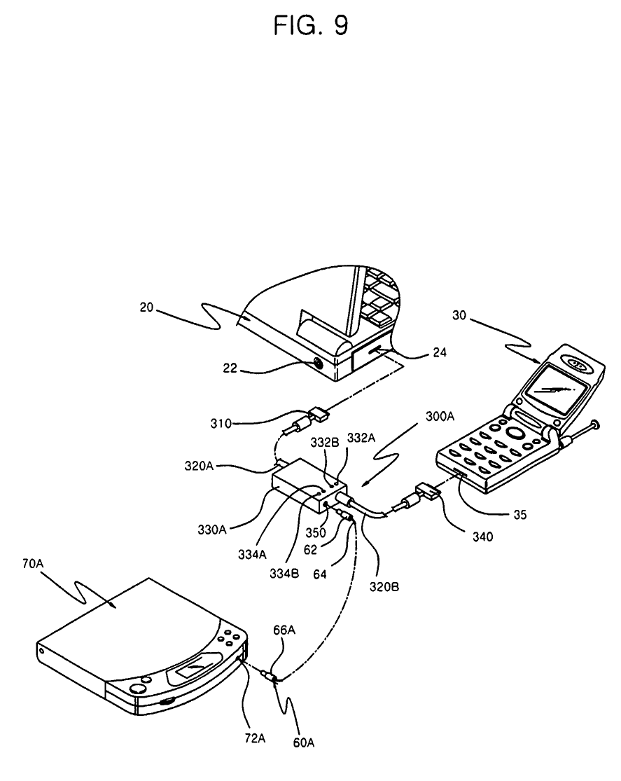

The power supply device for the portable communication terminal using the peripheral device connection port of the computer system in accordance with the fifth embodiment of the present invention will now be explained with reference to FIG. 9.

As compared with the power supply device 200A of FIG. 6, the power supply device 300A is not connected to the keyboard/mouse connection jack 22 of the computer system 20 but to the USB jack 24.

That is, the power supply device 300A has the same structure as the power supply device of FIG. 6, except for the USB plug 310A connected to the USB jack 24 of the computer system 20.

Here, the power supply device 300A has the same circuit structure as the power supply device of FIG. 7. However, the structure of the USB jack 24 and the USB plug 310 is identical to the structure of the USB jack 24 and the USB plug 510 of FIG. 15, and thus detailed explanations thereof will later be explained.

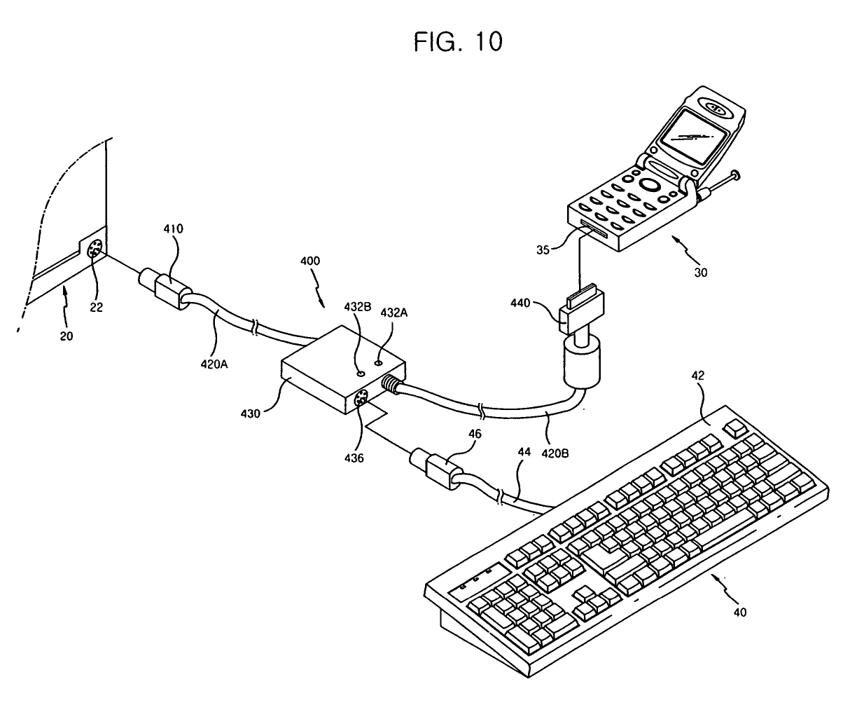

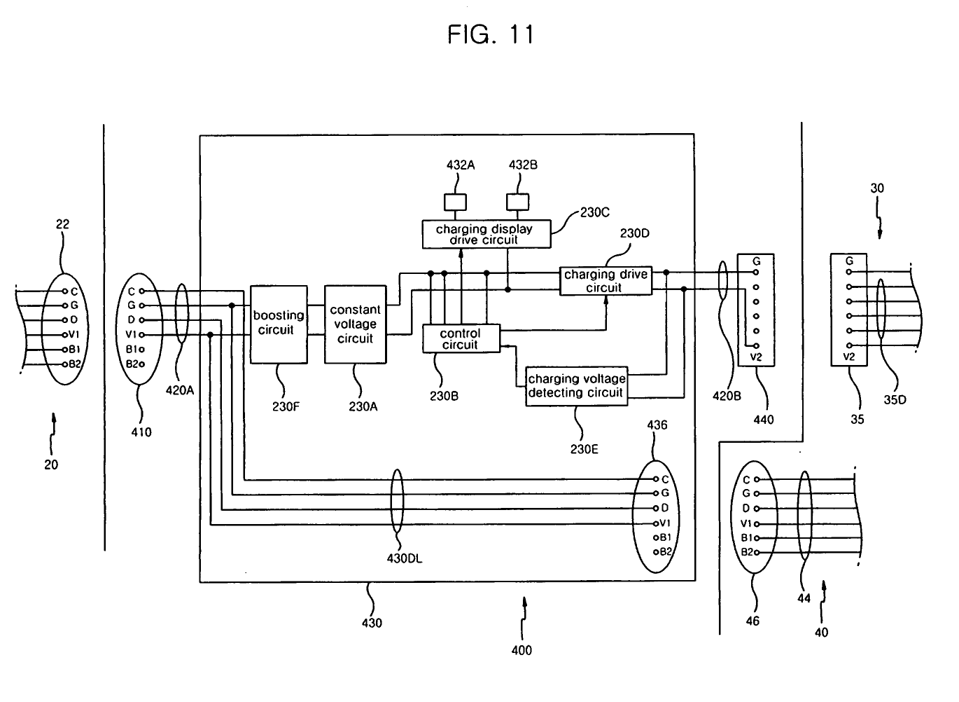

The power supply and data repeater device for supplying power to the portable communication terminal and repeating data to transmit the keyboard input to the computer system by using the peripheral device connection port of the computer system in accordance with the sixth embodiment of the present invention will now be described with reference to FIGS. 10 and 11.

As compared with the power supply device of FIG. 3, the power supply and data repeater device 400 further includes a keyboard/mouse connection jack 436 to which a keyboard 40 or mouse is connectable in a power/data repeater control block 430.

That is, the power supply device 400 includes: a plug 410 connected to the keyboard/mouse connection jack 22 of the computer system 20; the power/data repeater control block 430 in which a power control printed circuit board is built and from which charging display devices 432A and 432B are protruded; a power plug 440 connected to a power jack of a charging load terminal (for example, power/data I/O jack 35 of the portable communication terminal 30); a first cable 420A for connecting the plug 440 to the power/data repeater control block 430; and a second cable 420B for connecting the power/data repeater control block 430 to the power plug 440, which are incorporated.

The circuit structure of the power/data repeater control block 430 will now be explained with reference to FIG. 11. As compared with the circuit structure of FIG. 5, the power/data repeater control block 430 further includes the keyboard/mouse connection jack 436, and a line 430DL electrically connected to a clock pin C, a ground pin G, a data pin D and a power pin V1 through the first cable 420A between the plug 410 and the keyboard/mouse connection jack 436.

As explained above, the power supply and data repeater device can charge the charging load terminal (for example, portable communication terminal) through the keyboard/mouse connection jack of the computer system 20, and also can transmit input data due to key operations of the keyboard 40 (or mouse) to the computer system 20 through the line 430DL.

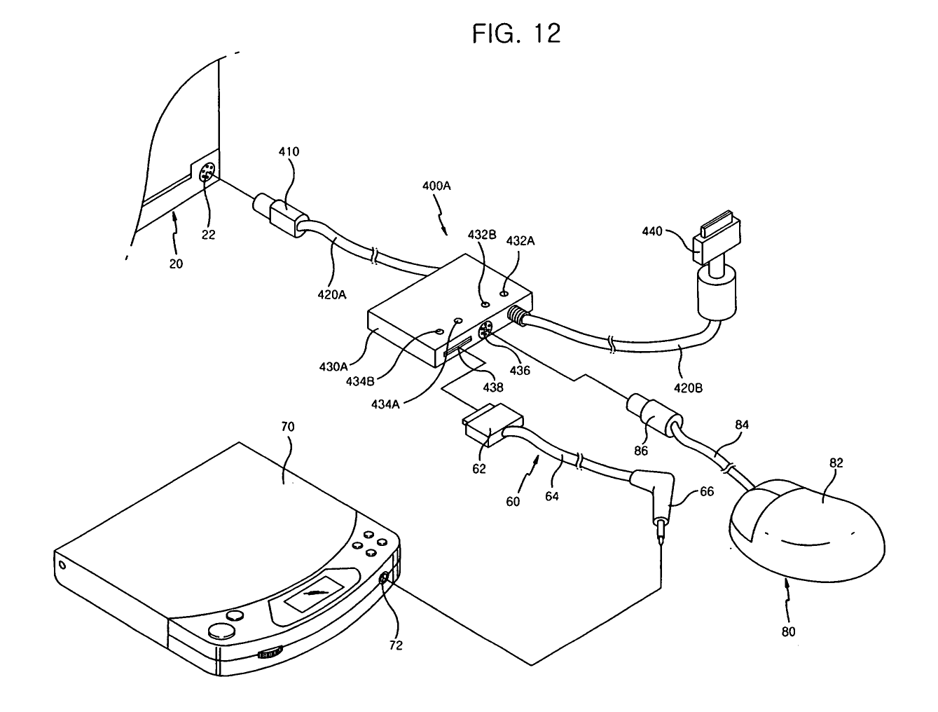

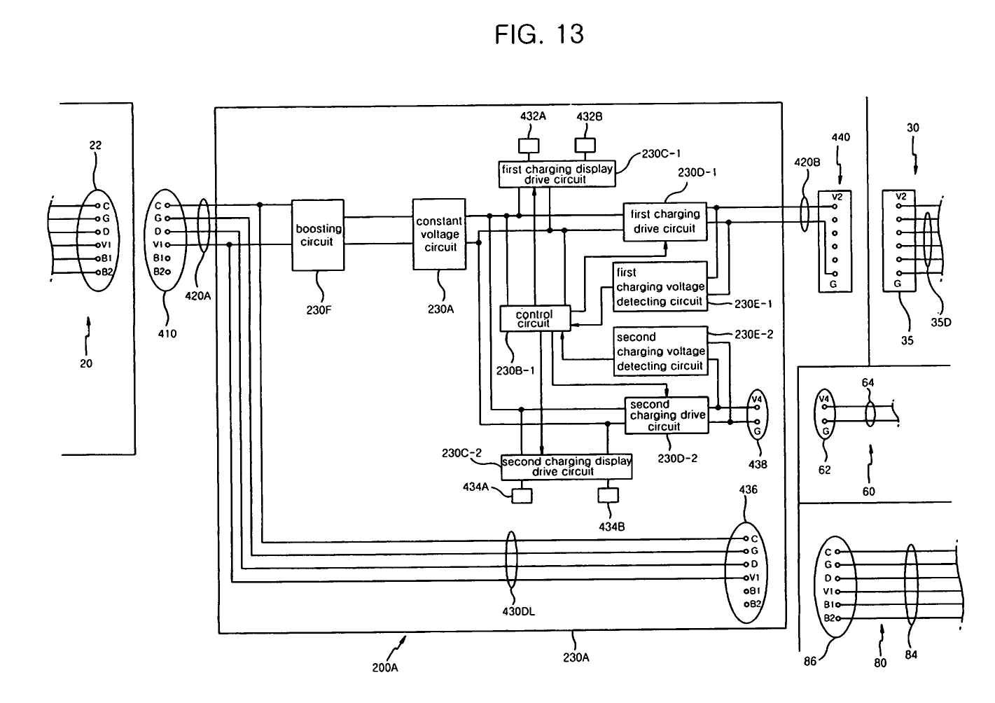

The power supply and data repeater device for the portable communication terminal using the peripheral device connection port of the computer system in accordance with the seventh embodiment of the present invention will now be described with reference to FIGS. 12 and 13.

As compared with the power supply device of FIG. 6, the power supply and data repeater device 400A further includes a keyboard/mouse connection jack 436 to which a keyboard 40 or mouse 80 is connectable in a power/data repeater control block 430A.

The circuit construction of the power supply and data repeater device will now be explained with reference to FIG. 13. As compared with the circuit structure of FIG. 7, the power/data repeater control block 430A further includes the keyboard/mouse connection jack 436, and a line 430DL electrically connected to a clock pin C, a ground pin G, a data pin D and a power pin V1 through the first cable 420A between the plug 410 and the keyboard/mouse connection jack 436.

As described above, the power/data repeater control block 430A can charge the portable communication terminal 30 and the portable audio device 70 through the keyboard/mouse connection jack of the computer system 20, and also can transmit input data due to key operations of the keyboard or mouse to the computer system 20.

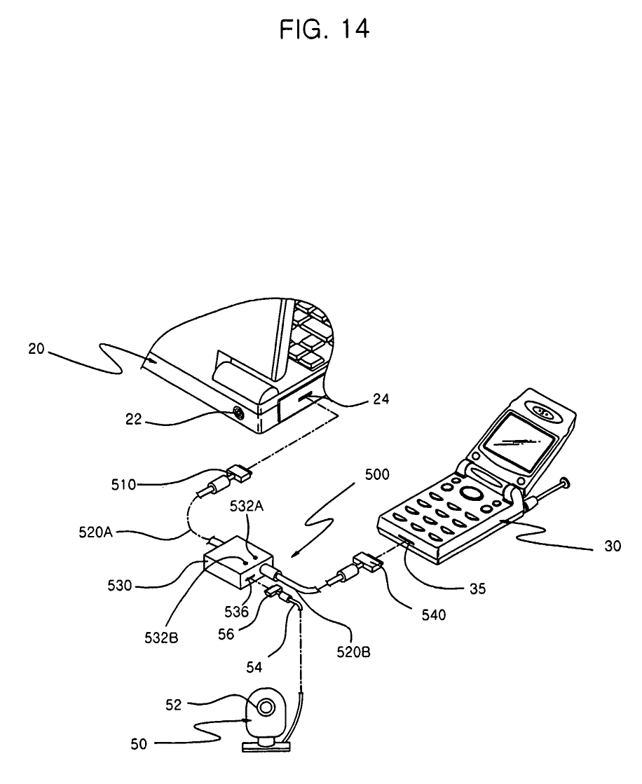

The power supply and data repeater device using the peripheral device connection port of the computer system in accordance with the eighth embodiment of the present invention will now be explained with reference to FIGS. 14 and 15.

As compared with the power supply and data repeater device of FIG. 10, the power supply and data repeater device 500 is not connected to the keyboard/mouse connection jack 22 of the computer system 20 but to the USB jack 24, and includes a USB jack 536 to which a web camera 50 or the like is connectable in a power/data repeater control block 530, instead of the keyboard/mouse connection jack to which the keyboard or mouse is connected.

The circuit construction of the power/data repeater control block 530 will now be explained with reference to FIG. 15. As compared with the circuit structure of FIG. 11, the power/data repeater control block 530 includes a USB connection plug 510 and a USB connection jack 536, instead of the keyboard/mouse connection plug 410 and the keyboard/mouse connection jack 436, and also includes a line 530DL electrically connected to a power pin V1, data pins D+ and D− and a ground pin G through a first cable 520A between the USB connection plug 510 and the USB connection jack 536.

As described above, the power supply and data repeater device can charge the charging load terminal such as the portable communication terminal 30 through the USB port of the computer system 20, and also can transmit data input from the web camera to the computer system 20.

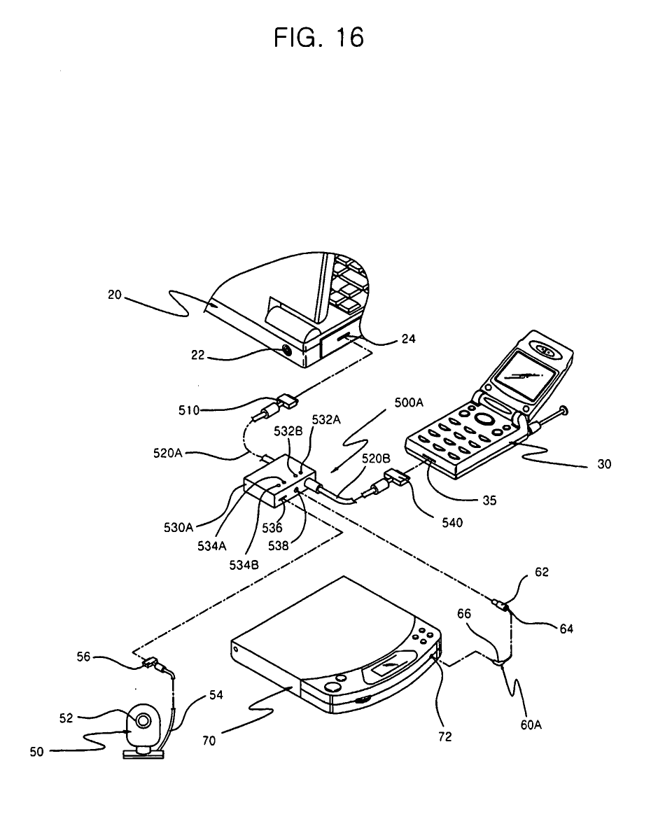

The power supply and data repeater device using the peripheral device connection port of the computer system in accordance with the ninth embodiment of the present invention will now be explained with reference to FIG. 16.

As compared with the power supply and data repeater device of FIG. 14, the power supply and data repeater device 500A further includes a structure for charging the portable audio device 70 (MP3 player, cassette tape player, CD player, etc.).

In addition to charging display devices 532A and 532B for the portable communication terminal 30, the power/data repeater control block 530A further includes charging display devices 534A and 534B for the portable audio device 70, and a power jack 538 for supplying the charging power to the portable audio device 70.

The circuit construction of the power/data repeater control block 530A is easily understood with reference to the circuit structure of FIGS. 7 and 15, and thus drawings and explanations thereof are omitted.

As a result, the power supply and data repeater device 500 can charge a different charging load terminal (for example, portable audio device 70) as well as the portable communication terminal 30 through the USB port of the computer system 20, and also can transmit data input from the web camera to the computer system 20.

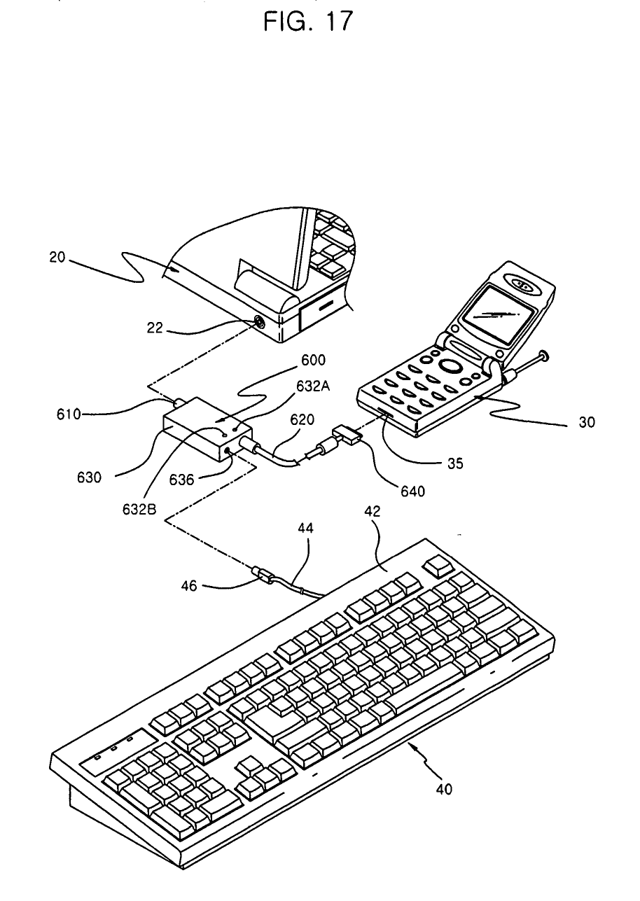

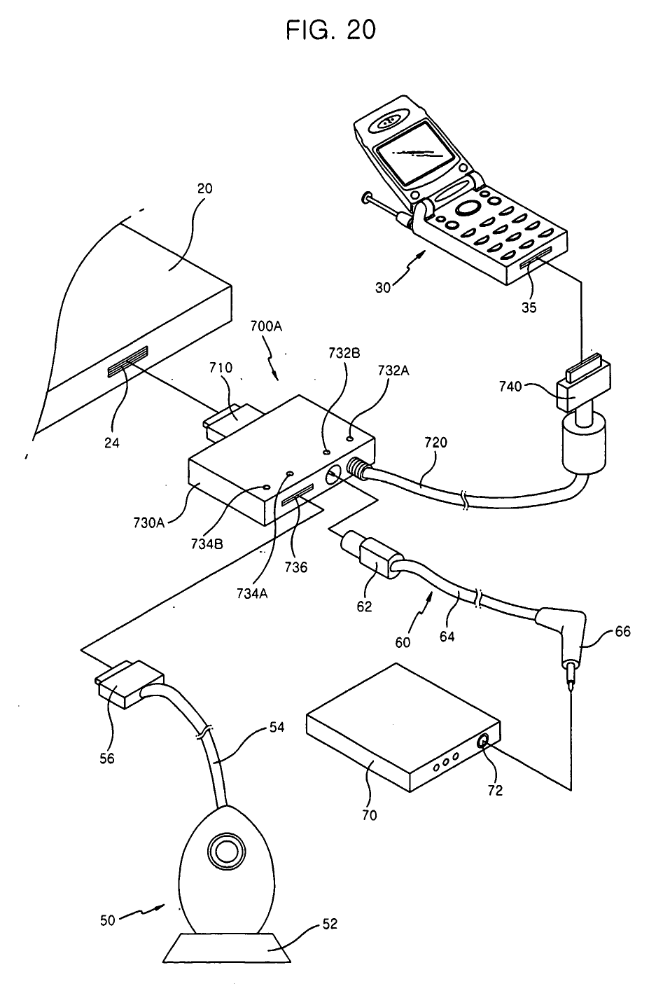

The power supply and data repeater device for the portable communication terminal using the peripheral device connection port of the computer system in accordance with the tenth to thirteenth embodiments of the present invention will now be explained with reference to FIGS. 17 and 20.

As compared with the power supply and data repeater device of FIG. 10, the power supply and data repeater device 600 of the tenth embodiment of FIG. 17 removes the first cable 420A and connects a keyboard/mouse connection plug 610 directly to a power/data repeater control block 630. The power supply and data repeater device 600 has the same circuit structure as the power supply and data repeater device of FIG. 11 except for the first cable 420A, and thus drawings and explanations thereof are omitted.

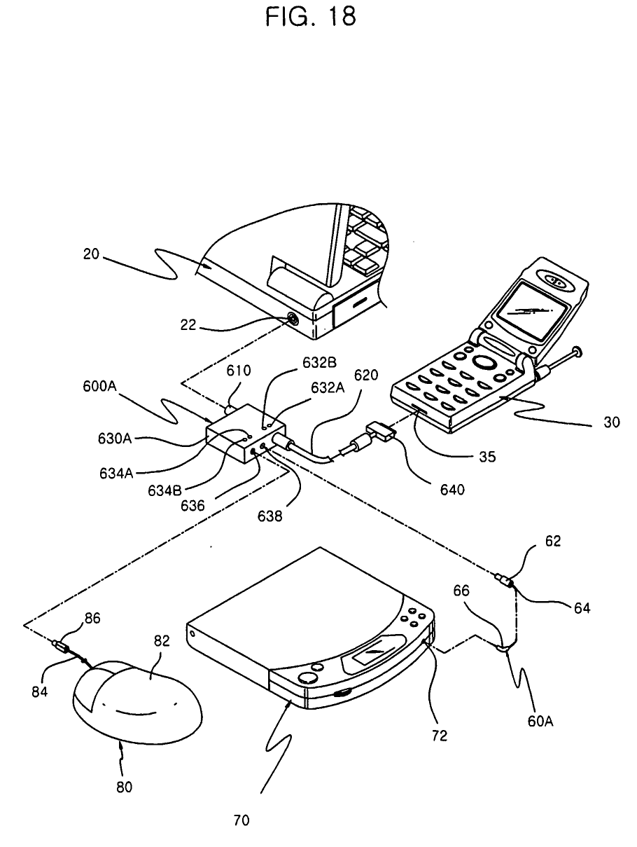

In addition, as compared with the power supply and data repeater device of FIG. 12, the power supply and data repeater device 600A of the eleventh embodiment of FIG. 18 removes the first cable 420A and connects the keyboard/mouse connection plug 610 directly to a power/data repeater control block 630A. The power supply and data repeater device 600A has the same circuit structure as the power supply and data repeater device of FIG. 13 except for the first cable 420A, and thus drawings and explanations thereof are omitted.

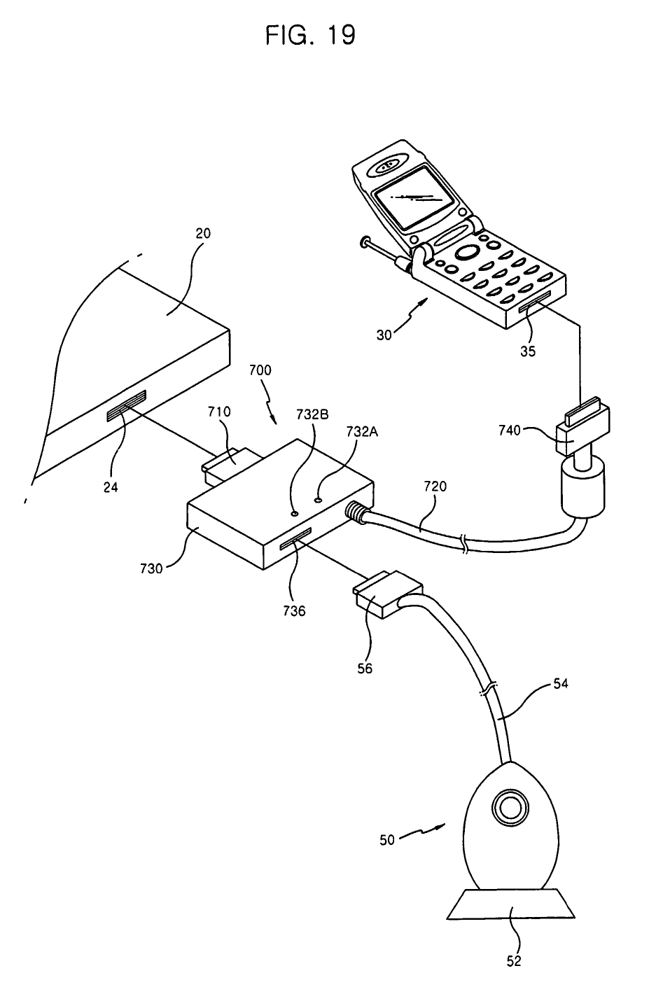

As compared with the power supply and data repeater device of FIG. 14, the power supply and data repeater device 700 of the twelfth embodiment of FIG. 19 removes the first cable 520A and connects a USB plug 710 directly to a power/data repeater control block 730. The power supply and data repeater device 700 has the same circuit structure as the power supply and data repeater device of FIG. 15 except for the first cable 520A, and thus drawings and explanations thereof are omitted.

On the other hand, as compared with the power supply and data repeater device of FIG. 16, the power supply and data repeater device 700A of the thirteenth embodiment of FIG. 20 removes the first cable 520A and connects the USB plug 710 directly to a power/data repeater control block 730A. The circuit structure thereof will be easily understood with reference to FIGS. 13 and 15, and thus drawings and explanations thereof are omitted.

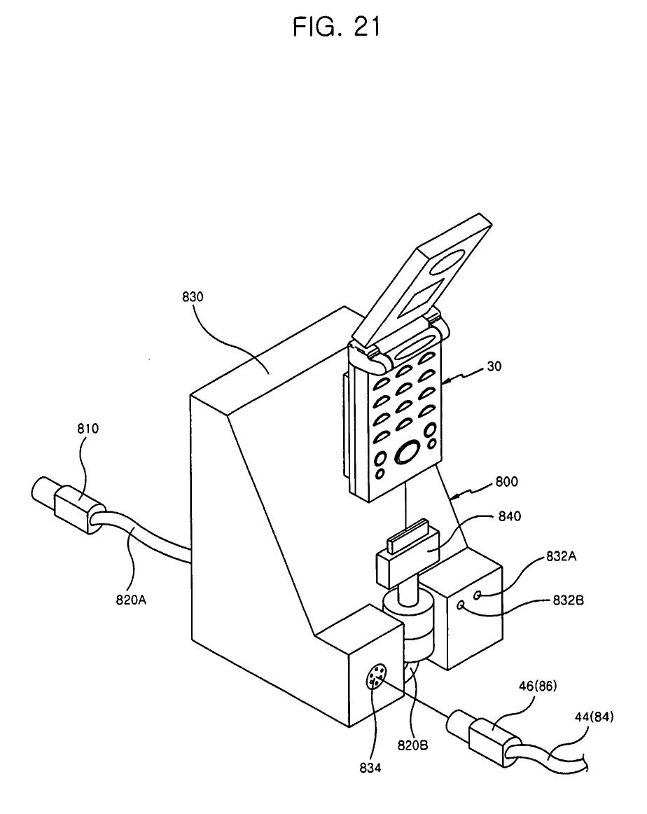

The power supply and data repeater device for the portable communication terminal using the peripheral device connection port of the computer system in accordance with the fourteenth embodiment of the present invention will now be explained with reference to FIG. 21.

Referring to FIG. 21, when the portable communication terminal 30 is used as the charging load terminal, the portable communication terminal 30 can be mounted on a main body 830.

A plug 810 connected to the keyboard/mouse connection jack of the computer system is connected to the rear surface of the main body 830 through a cable 820A, and a plug 840 for supplying power to the portable communication terminal 30 is connected to the front lower surface of the main body 830.

A mouse/keyboard connection jack 834 to which the mouse/keyboard connection plug 46 or 86 is connected to connect the mouse or keyboard to the computer system is installed on the front surface (or side surface) of the main body 830, and a first charging display device 832A displaying the charging operation of the battery of the portable communication terminal 30 and a second charging display device 832B displaying completion of the charging operation of the battery of the portable communication terminal 30 are externally protruded from the front surface of the main body 42.

The power supply and data repeater device has the same circuit construction as the power supply and data repeater device of FIG. 11, and thus drawings and explanations thereof are omitted.

In this embodiment, the power supply and data repeater device can supply power to the charging load terminal, namely the portable communication terminal 30, and charge the battery by inserting the plug 810 into the keyboard/mouse connection jack of the computer system and the plug 840 into the data/power supply jack of the portable communication terminal 30, and also can input a keyboard or mouse input signal to the computer system 20 by inserting the mouse/keyboard connection plug 46 or 86 into the mouse/keyboard connection jack 834.

In accordance with the present invention, the main body 830 may be formed in various shapes.

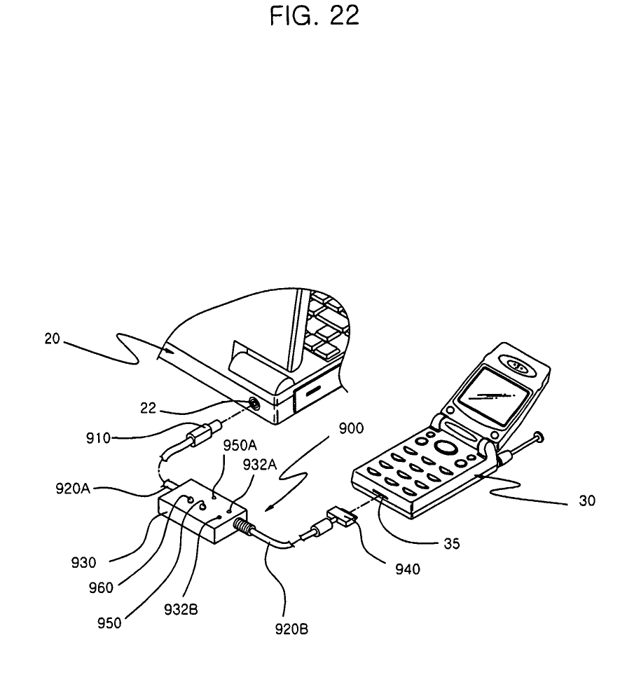

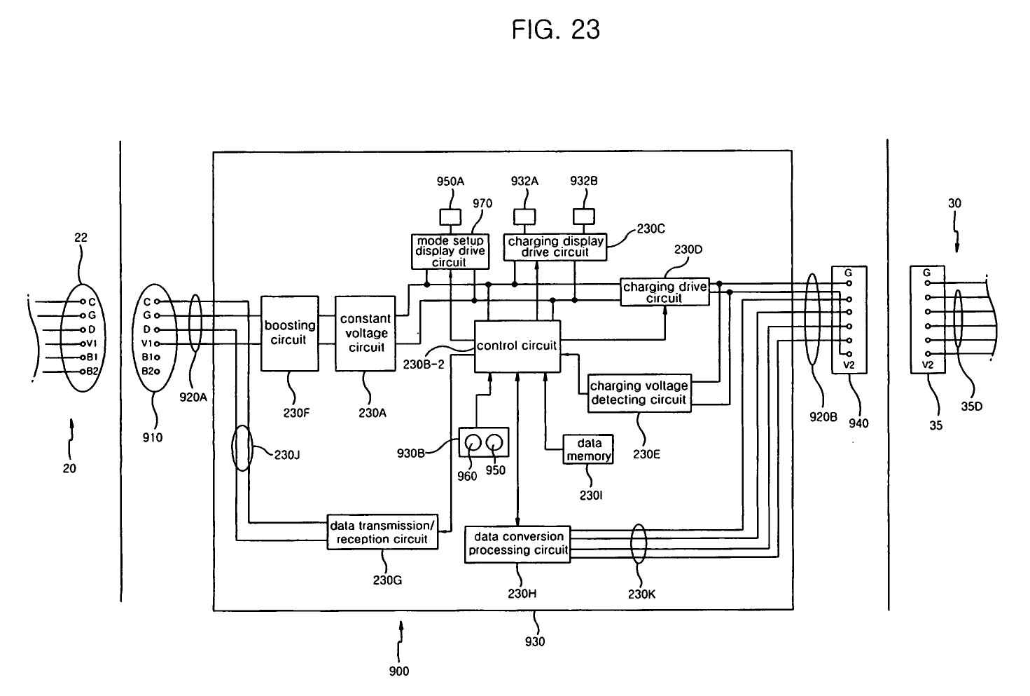

The power supply and data repeater device for the portable communication terminal using the peripheral device connection port of the computer system in accordance with the fifteenth embodiment of the present invention will now be explained with reference to FIGS. 22 and 23.

The power supply and data repeater device 900 includes: a plug 910 inserted and connected to the mouse/keyboard connection jack 22 of the computer system 20; a first cable 920A; a power/data repeater control block 930; a second cable 920B; and a plug 940 inserted and connected to the power/data I/O jack 35 of the portable communication terminal 30, which are incorporated.

A power/data repeater control printed circuit board is built in the power/data repeater control block 930, and charging display devices 932A and 932B, a control mode setup key 950, a control mode display device 950A and a short message transmission key 960 are installed at the outer portion of the power/data repeater control block 930.

The charging display devices 932A and 932B have the same function explained above. The control mode setup key 950 sets up a mode for controlling data communication between the portable communication terminal 30 and the computer system 20. When the control mode is set up, the control mode display device 950A emits light.

In addition, the short message transmission key 960 transmits a short message inputted through the keyboard (not shown) of the computer system 20 to the portable communication terminal 30.

The power/data repeater control block 930 will now be explained with reference to FIG. 23. As shown therein, the power/data repeater control block 930 includes the boosting circuit 230F, the constant voltage circuit 230A, the charging drive circuit 230D, the charging voltage detecting circuit 230E, the charging display drive circuit 230C, the charging display devices 932A and 932B, and the control circuit 230B-2, which have the same functions explained with reference to FIG. 5.

The power/data repeater control block 930 further includes: a key input unit 930B having the mode setup key 950 and the short message transmission key 960; a mode setup display drive circuit 970 controlled by the control circuit 230-2 for displaying and driving the mode setup display device 950A, when the mode setup key 950 is inputted; a data transmission/reception circuit 230G connected to the clock pin C and the data pin D through the mouse/keyboard connection jack 22 of the computer system 20, the plug 910 and the cable 920A, for performing data communication with the computer system 20; a data memory 230I for storing data inputted by the user through the key input unit such as the keyboard and transmitted to the computer system 20, namely short message data to be transmitted through the portable communication terminal 30, and detailed information data (name, firm name, fax number, etc.) corresponding to a phone number according to for example, input of the computer system 20 (or keyboard) or the portable communication terminal 30; and a data conversion processing circuit 230H connected to the data line 35D of the power/data I/O jack 35 of the portable communication terminal 30 through the plug 940, for converting data transmitted from the portable communication terminal 30 to the computer system 20 to have a data format suitable for the computer system 20, and also converting data transmitted from the computer system 20 to the portable communication terminal 30 to have a data format suitable for the portable communication terminal 30.

When the mode setup key 950A is set up to have the portable communication terminal control mode, the mode setup display drive circuit 970 is operated to enable the mode setup display device 950A to emit light under the control of the control circuit 230B-2.

Here, when caller information is transmitted from the portable communication terminal 30, the caller information is transmitted to the data conversion processing circuit 230H through the data line 35, the power/data I/O jack 35 and the plug 940 and the cable 920B of the power/data repeater control block 900. The data conversion processing circuit 230H transmits the caller information data converted to have a data format suitable for the computer system 20 to the control circuit 230B-2.

The control circuit 230B-2 searches the data memory 230I to find a phone number identical to the caller phone number of the caller information, reads detailed information data of the caller (for example, name, firm name, fax number, etc.) corresponding to the phone number, and transmits the information to the computer system 20 through the data transmission/reception circuit 230G.

When the short message data transmitted through the portable communication terminal 30 and the detailed information data (name, firm name, fax number, etc.) corresponding to the phone number are inputted from the computer system 20 through the data transmission/reception circuit 230G, the control circuit 230B-2 stores the input data in the data memory 230I. Thereafter, when the user operates the short message transmission key 960, the control circuit 230B-2 reads the short message data from the data memory 230i, and outputs the data to the data conversion processing circuit 230H. The data conversion processing circuit 230H converts the short message data to have a data format suitable for the portable communication terminal 30, and outputs the data to the data line 35D of the power/data I/O jack 35 of the portable communication terminal 30 through the data line 230K and the plug 940.

In addition, when the control data signal for controlling the portable communication terminal 30 is inputted from the computer system 20 through the data transmission/reception circuit 230G, the control circuit 230B-2 outputs the control data signal to the data conversion processing circuit 230H. The data conversion processing circuit 230H converts the control data signal to have a data format suitable for the portable communication terminal 30, and outputs the data to the data line 35D of the power/data I/O jack 35 of the portable communication terminal 30 through the data line 230K and the plug 940.

Accordingly, the power supply and data repeater device can supply the operation power to the portable communication terminal 30 and charge the battery by inserting the plug 910 into the keyboard/mouse connection jack 22 of the computer system 20 and the plug 940 into the power/data I/O jack 35 of the portable communication terminal 30. Moreover, when the portable communication terminal 30 receives caller information and the memory stores detailed caller information corresponding to a caller phone number of the caller information, the power supply and data repeater device can transmit the detailed information to the computer system 20, transmit short message data made by using the computer system 20 to the portable communication terminal 30, and control the portable communication terminal 30 by using the computer system 20.

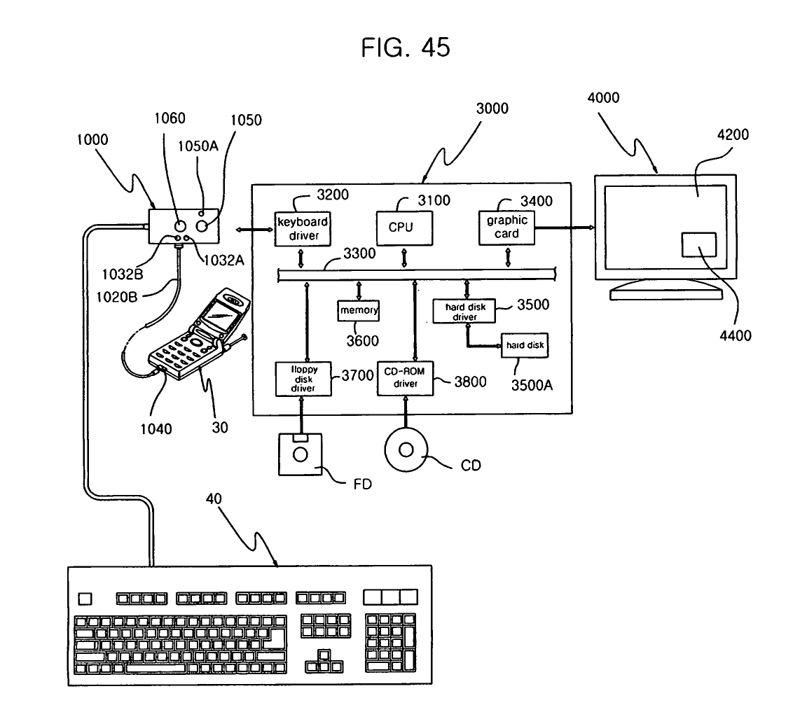

The concrete embodiments thereof will later be explained in more detail with reference to FIGS. 45 to 56.

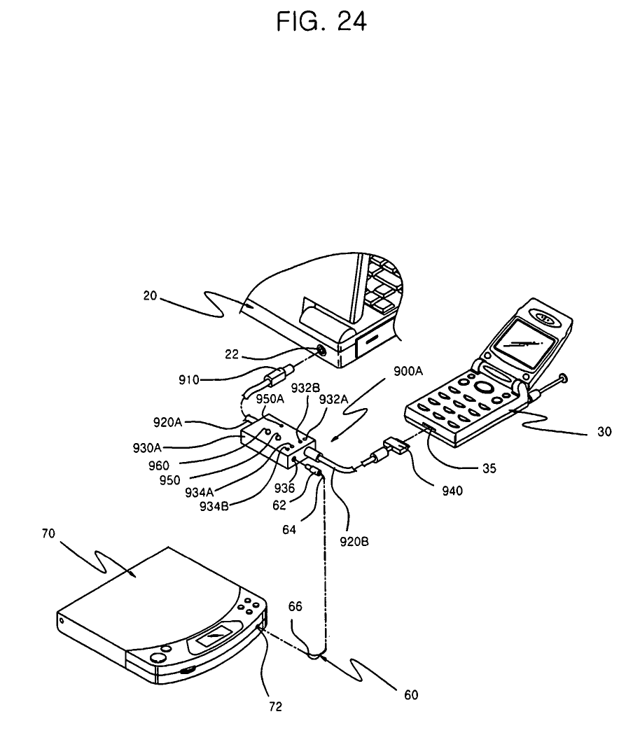

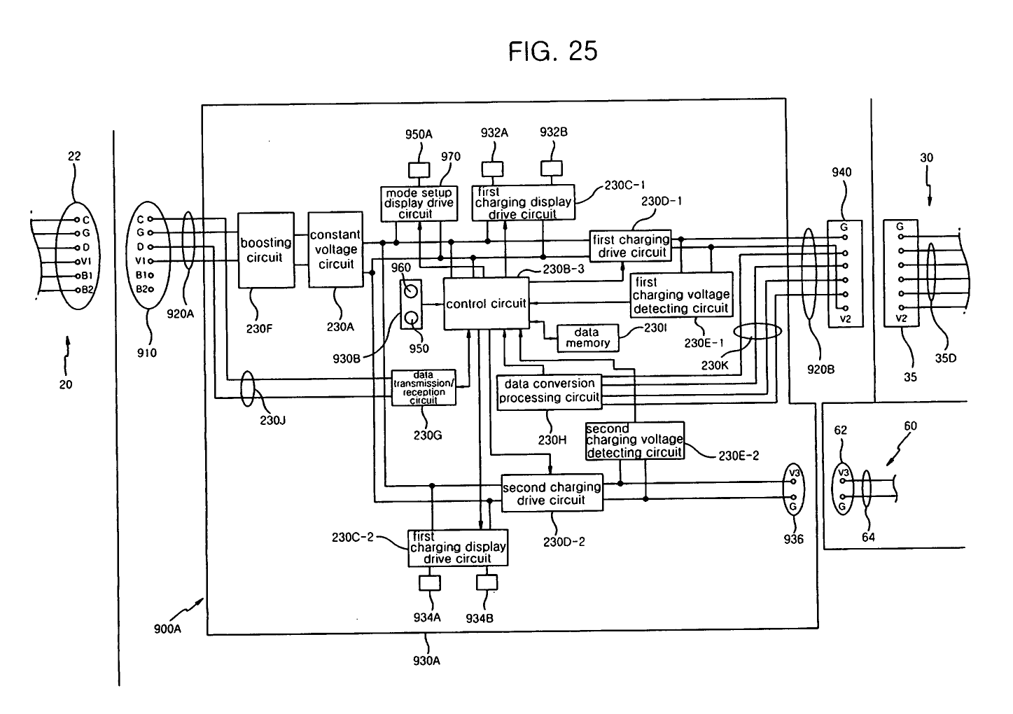

The power supply and data repeater device for the portable communication terminal using the peripheral device connection port of the computer system in accordance with the sixteenth embodiment of the present invention will now be explained with reference to FIGS. 24 and 25.

As compared with the power supply and data repeater device of FIG. 22, the power supply and data repeater device 900A further includes a structure for charging a portable audio device (MP3 player, cassette tape player, CD player, etc.) in the power/data repeater control block.

In addition to the charging display devices 932A and 932B for the portable communication terminal 30, charging display devices 934A and 934B for the portable audio device 70 are further protruded from the power supply and data repeater device 900A, and a power jack 936 for supplying the charging power to the portable audio device 70 is further installed in the power supply and data repeater device 900A.

The power/data repeater control block 930A will now be described with reference to FIG. 25. As shown in FIG. 25, as compared with the power/data repeater control block of FIG. 23, the power/data repeater control block 930A further includes the second charging drive circuit 230D-2, the second charging voltage detecting circuit 230E-2, the power jack 936, the second charging display drive circuit 230C-2 and the charging display devices 934A and 934B. The first charging drive circuit 230D-1, the first charging voltage detecting circuit 230E-1 and the first charging display drive circuit 230C-1 have the same functions as the charging drive circuit 230D, the charging voltage detecting circuit 230E and the charging display drive circuit 230C of FIG. 23. The respective components are operated similarly or identically as described with reference to FIG. 7.

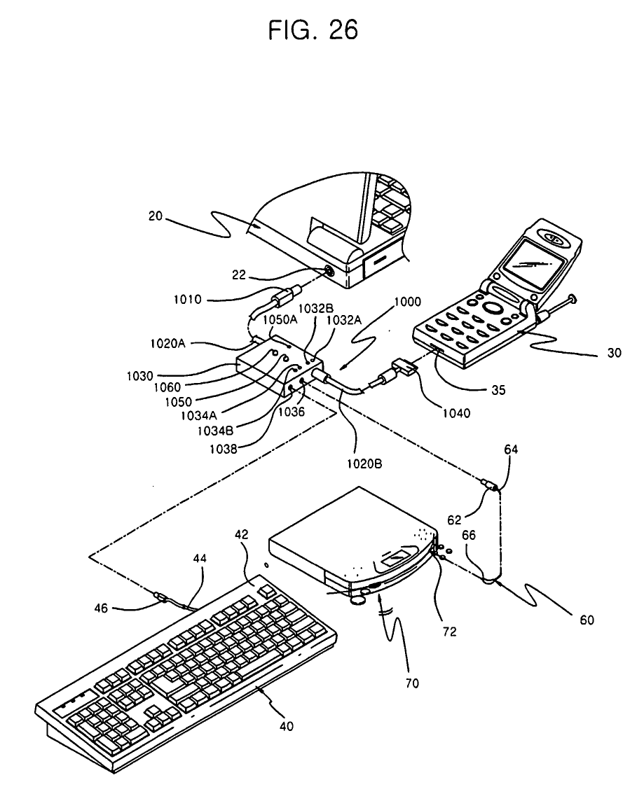

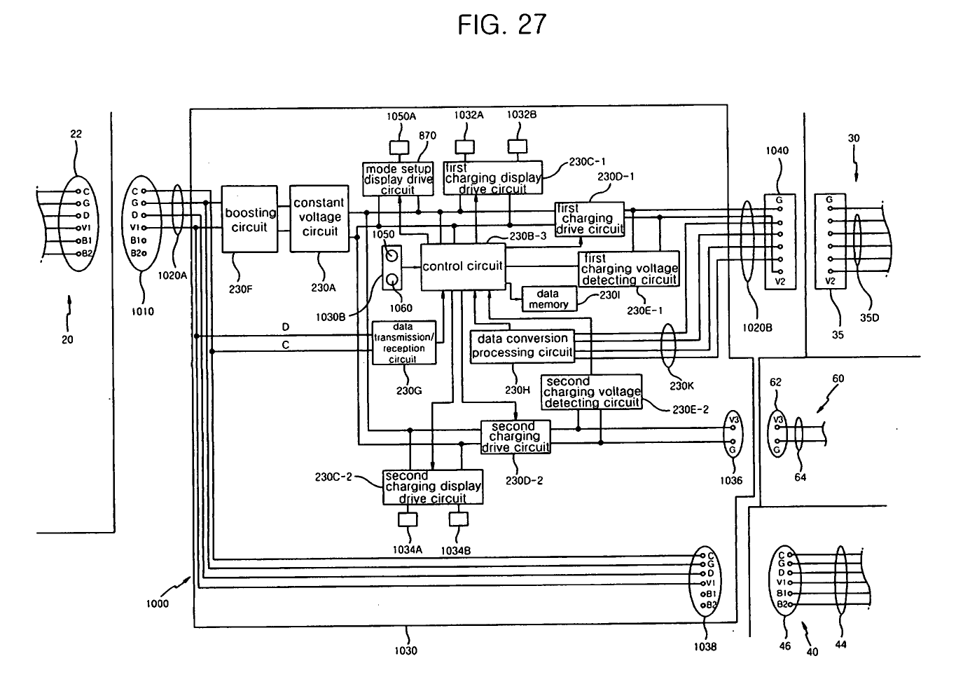

The power supply and data repeater device for the portable communication terminal using the peripheral device connection port of the computer system in accordance with the seventeenth embodiment of the present invention will now be explained with reference to FIGS. 26 and 27.

As compared with the power supply and data repeater device of FIG. 24, the power supply and data repeater device 1000 further includes a structure for connecting the mouse or keyboard in the power/data repeater control block.

As depicted in FIG. 27, in addition to the circuit structure of FIG. 25, the power supply and data repeater device 1000 further includes a keyboard/mouse connection jack 1038; and a line 430DL electrically connected to a clock pin C, a ground pin G, a data pin D and a power pin V1 through a first cable 1020A between a plug 1010 inserted and connected to the keyboard/mouse connection jack 22 of the computer system 20 and the keyboard/mouse connection jack 1038.

Here, the data transmission/reception circuit 230G performs data communication with the computer system 20, when data are not inputted from the mouse or keyboard.

In this embodiment, the power supply and data repeater device can supply the power to the portable communication terminal 30 and the portable audio device 70, charge the battery, and control the portable communication terminal 30 through the keyboard/mouse connection jack of the computer system 20, and operate and input the keyboard or mouse.

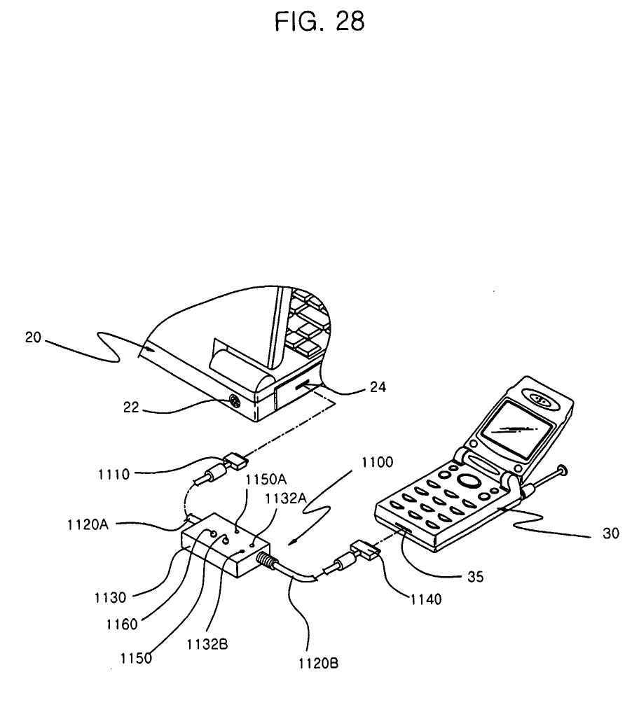

The power supply and data repeater device for the portable communication terminal using the peripheral device connection port of the computer system in accordance with the eighteenth embodiment of the present invention will now be explained with reference to FIG. 28.

As compared with the power supply and data repeater device of FIG. 22, the power supply and data repeater device 1100 is not connected to the keyboard/mouse connection jack 22 of the computer system 20 but to the USB jack 24. Except for that, the power supply and data repeater device 1100 has the circuit structure and operation identical or similar to the power supply and data repeater device of FIG. 23.

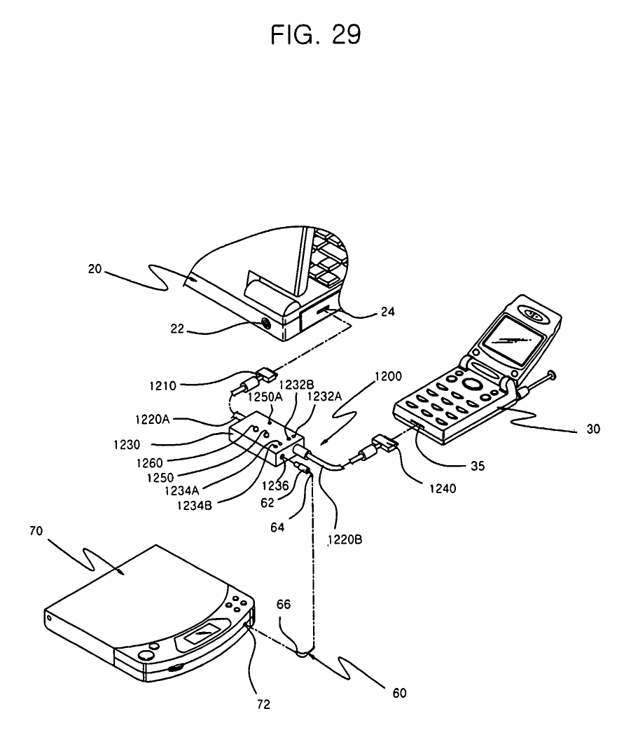

The power supply and data repeater device for the portable communication terminal using the peripheral device connection port of the computer system in accordance with the nineteenth embodiment of the present invention will now be described with reference to FIG. 29.

As compared with the power supply and data repeater device of FIG. 24, the power supply and data repeater device 1200 is not connected to the keyboard/mouse connection jack 22 of the computer system 20 but to the USB jack 24. Except for that, the power supply and data repeater device 1200 has the circuit structure and operation identical or similar to the power supply and data repeater device of FIG. 25.

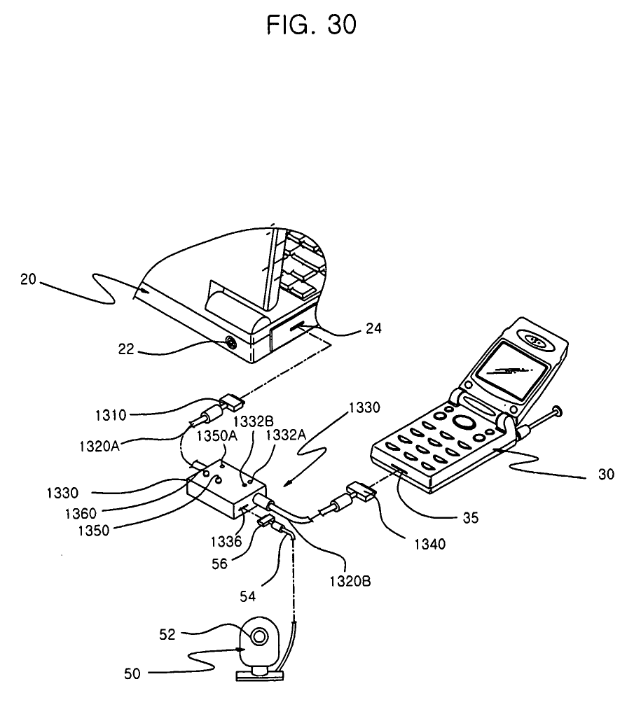

The power supply and data repeater device for the portable communication terminal using the peripheral device connection port of the computer system in accordance with the twentieth embodiment of the present invention will now be explained with reference to FIG. 30.

As compared with the power supply and data repeater device of FIGS. 14 and 15, the power supply and data repeater device 1300 further includes: a key input unit having a mode setup key 1350 and a short message transmission key 1360; a mode setup display drive circuit (not shown; corresponding to 970 of FIG. 25) controlled by a control circuit (not shown; corresponding to 230B-3 of FIG. 25) for displaying and driving a mode setup display device 1350A, when the mode setup key 1350 is inputted; a data transmission/reception circuit (not shown; corresponding to 230G of FIG. 25) connected to data pins D+ and D− through the USB connection jack 24 of the computer system 20, the USB plug 1310 and the cable 1320A, for performing data communication with the computer system 20; a data memory (not shown; corresponding to 230I of FIG. 25) for storing data inputted by the user through the key input unit and transmitted to the computer system 20, namely short message data to be transmitted through the portable communication terminal 30, and detailed information data (name, firm name, fax number, etc.) corresponding to a phone number; and a data conversion processing circuit (not shown; corresponding to 230H of FIG. 25) connected to the data line 35D of the power/data I/O jack 35 of the portable communication terminal 30 through the plug 1340, for converting the data for data communication with the portable communication terminal 30. Since the power supply and data repeater device has the components shown in FIG. 25, it performs the operation as described above.

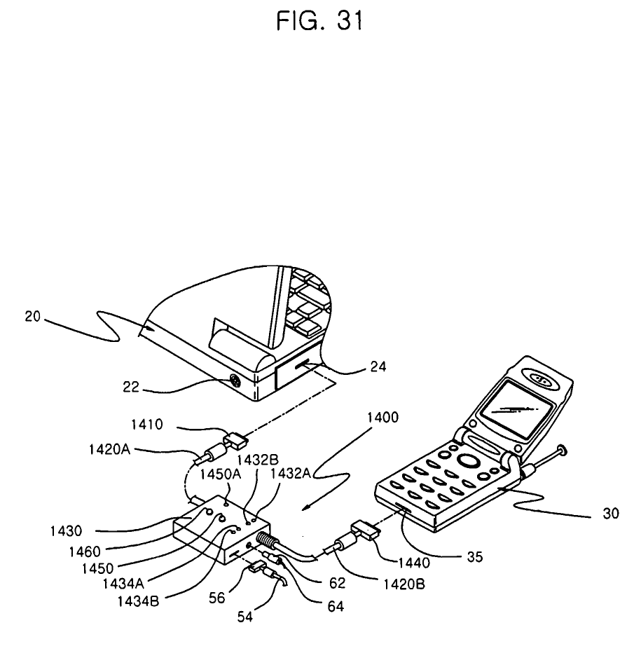

The power supply and data repeater device for the portable communication terminal using the peripheral device connection port of the computer system in accordance with the twenty-first embodiment of the present invention will now be explained with reference to FIG. 31.

As compared with the power supply and data repeater device of FIG. 16, the power supply and data repeater device 1400 further includes: a key input unit having a mode setup key 1450 and a short message transmission key 1460; a mode setup display drive circuit (not shown; corresponding to 970 of FIG. 27) controlled by a control circuit (not shown; corresponding to 230B-3 of FIG. 27) for displaying and driving a mode setup display device 1450A, when the mode setup key 1450 is inputted; a data transmission/reception circuit (not shown; corresponding to 230G of FIG. 27) connected to data pins D+ and D− through the USB connection jack 24 of the computer system 20, the USB plug 1410 and the cable 1420A, for performing data communication with the computer system 20; a data memory (not shown; corresponding to 230I of FIG. 27) for storing data inputted by the user through the key input unit and transmitted to the computer system 20, namely short message data to be transmitted through the portable communication terminal 30, and detailed information data (name, firm name, fax number, etc.) corresponding to a phone number; and a data conversion processing circuit (not shown; corresponding to 230H of FIG. 27) connected to the data line 35D of the power/data I/O jack 35 of the portable communication terminal 30 through the plug 1440, for converting the data for data communication with the portable communication terminal 30. As the power supply and data repeater device 1400 has the components shown in FIG. 27, it performs the operation described above.

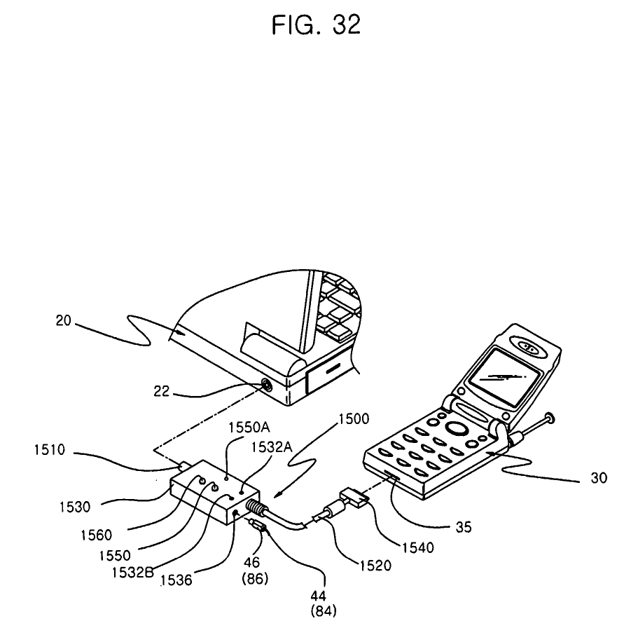

The power supply and data repeater device for the portable communication terminal using the peripheral device connection port of the computer system in accordance with the twenty-second embodiment of the present invention will now be explained with reference to FIG. 32.

As compared with the power supply and data repeater device of FIG. 26, the power supply and data repeater device 1500 removes the structure for charging the portable audio device 70 (MP3 player, cassette tape player, CD player, etc.) and the first cable 1020A, and connects a keyboard/mouse connection plug 1510 directly to a power/data repeater control block 1530.

In addition, the power supply and data repeater device 1500 has the same circuit structure as the power supply and data repeater device of FIG. 27, except for the structure (230C-2, 230D-2, 230E-2, 1036, 1034A and 1034B) for charging the portable audio device 70 (MP3 player, cassette tape player, CD player, etc.) and the first cable 1020A, and thus performs the operation explained above.

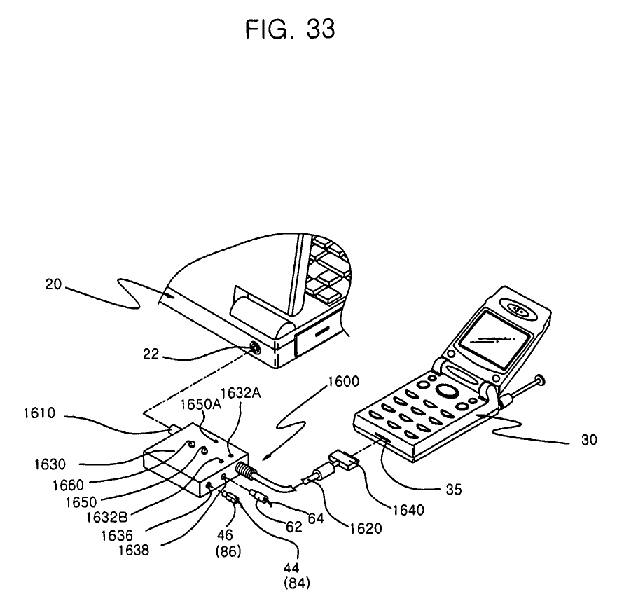

The power supply and data repeater device for the portable communication terminal using the peripheral device connection port of the computer system in accordance with the twenty-third embodiment of the present invention will now be explained with reference to FIG. 33.

As compared with the power supply and data repeater device of FIG. 26, the power supply and data repeater device 1600 removes the first cable 1020A and connects a keyboard/mouse connection plug 1610 directly to a power/data repeater control block 1630.

Therefore, the power supply and data repeater device 1600 has the same circuit structure as the power supply and data repeater device of FIG. 27 except for the first cable 1020A, and thus the operations thereof will not be explained.

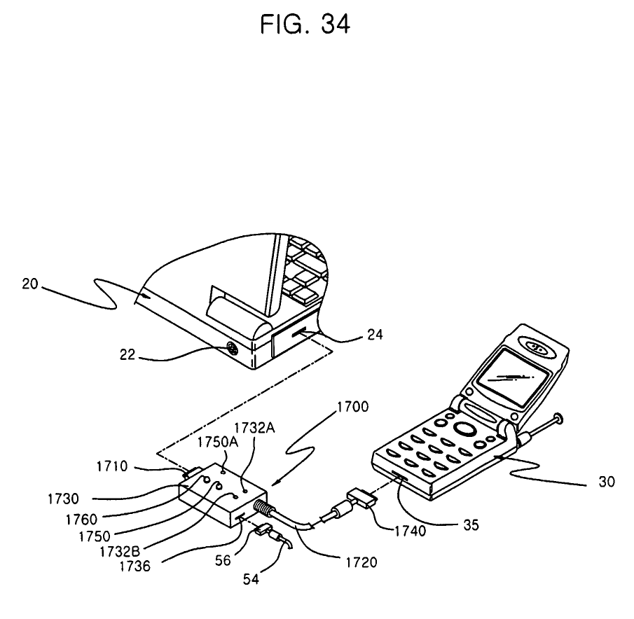

The power supply and data repeater device for the portable communication terminal using the peripheral device connection port of the computer system in accordance with the twenty-fourth embodiment of the present invention will now be explained with reference to FIG. 34.

As compared with the power supply and data repeater device of FIG. 30, the power supply and data repeater device 1700 removes the first cable 1320A and connects a USB plug 1710 directly to a power/data repeater control block 1730.

The circuit structure of the power supply and data repeater device 1700 will be easily understood by referring to explanations of FIG. 30.

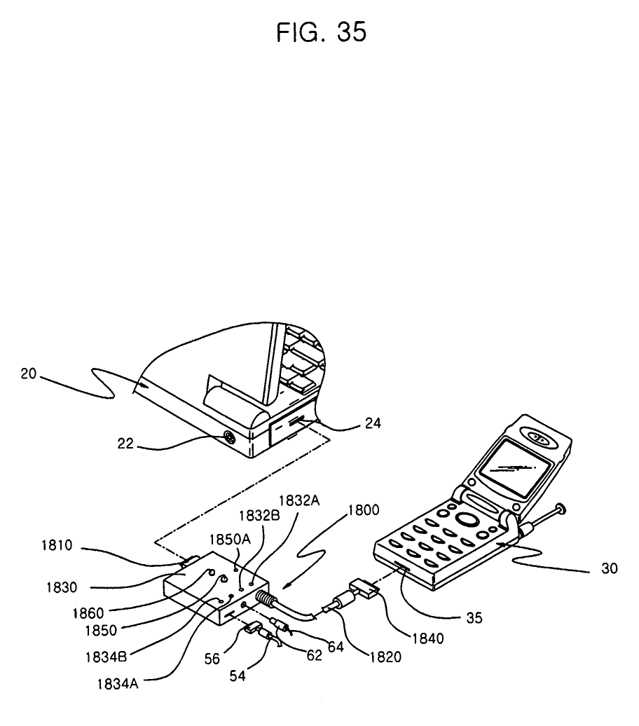

The power supply and data repeater device for the portable communication terminal using the peripheral device connection port of the computer system in accordance with the twenty-fifth embodiment of the present invention will now be explained with reference to FIG. 35.

As compared with the power supply and data repeater device of FIG. 31, the power supply and data repeater device 1800 removes the first cable 1420A and connects a USB plug 1810 directly to a power/data repeater control block 1830.

The circuit structure of the power supply and data repeater device 1800 will be easily understood by referring to explanations of FIG. 31.

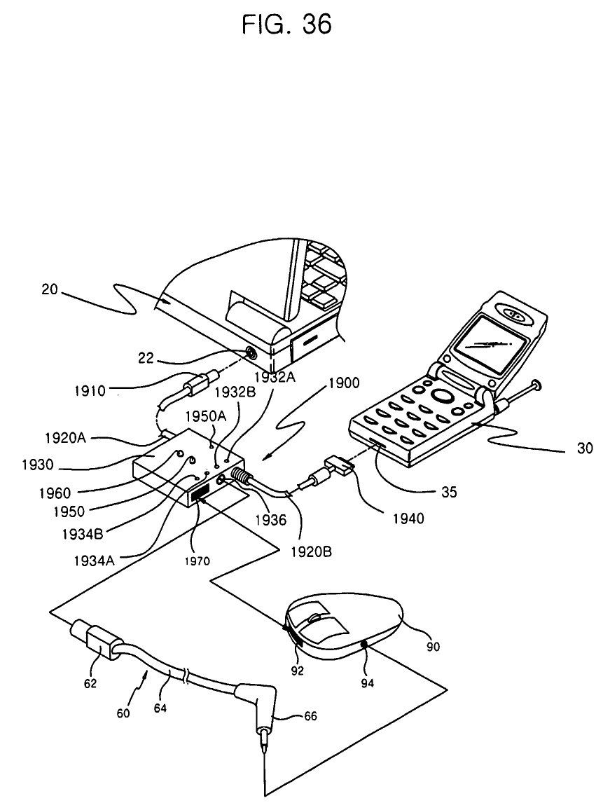

The power supply and data repeater device for the portable communication terminal using the peripheral device connection port of the computer system in accordance with the twenty-sixth embodiment of the present invention will now be explained with reference to FIG. 36.

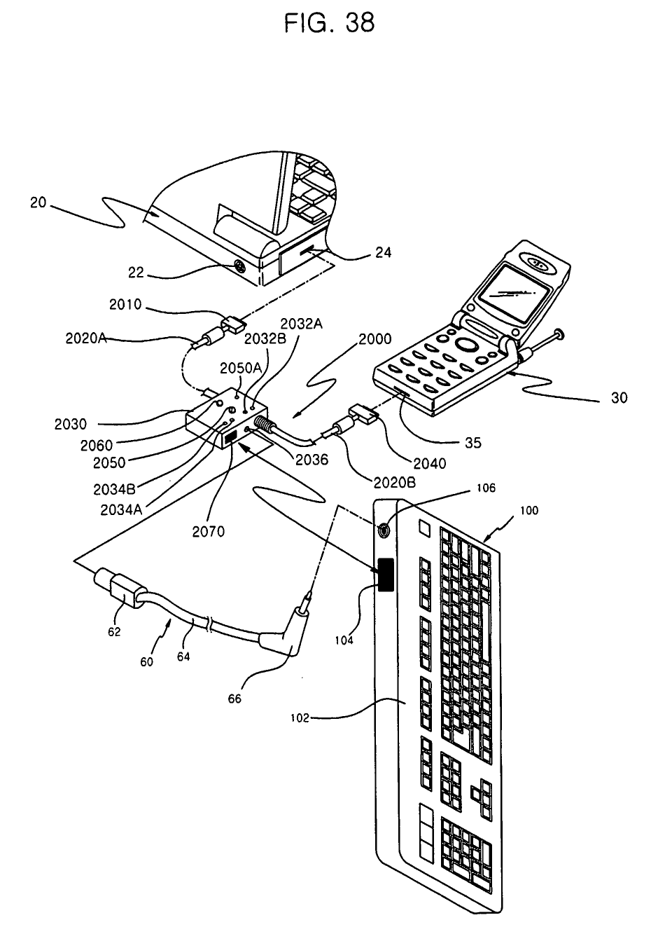

As compared with the power supply and data repeater device of FIG. 24, the power supply and data repeater device 1900 further includes a wireless data communication circuit 1970 for performing wireless communication with a wireless mouse 90 (for example, optical mouse) or wireless keyboard (100 of FIG. 38). The cable 60 for charging the wireless mouse 90 or wireless keyboard (100 of FIG. 38) is connected to a power jack 1936.

The wireless mouse 90 may use an infrared ray (IR) method or radio frequency (RF) method. In the case of the IR type wireless mouse 90, the wireless data communication circuit 1970 is designed in the IR method, and in the case of the RF type wireless mouse 90, the wireless data communication circuit 1970 is designed in the RF method.

As compared with the power supply and data repeater device 900A of FIG. 25, the power supply and data repeater device 1900 further includes the wireless data communication circuit 1970; and a signal line installed between the wireless data communication circuit 1970 and the clock pin C and the data pin D of the plug 1910.

When an IR or RF type data signal is inputted from a wireless data communication circuit 92 of the wireless mouse 90 to the wireless data communication circuit 1970, the input data signal is converted to have a signal format suitable for the computer system 20, and inputted to the computer system 20 through the plug 1910 and the mouse/keyboard connection jack 22. In addition, when receiving the data signal from the wireless mouse 90, the wireless data communication circuit 1970 notifies the data input to the control circuit 230B-4. Thus, the control circuit 230B-4 prevents data collision by the data transmission/reception circuit 230G.

The other components of the power supply and data repeater device 1900 are identical to the components of FIG. 25, and thus the operations thereof are performed as explained above.

The power supply and data repeater device for the portable communication terminal using the peripheral device connection port of the computer system in accordance with the twenty-seventh embodiment of the present invention will now be explained with reference to FIG. 38.

As compared with the power supply and data repeater device of FIG. 26, the power supply and data repeater device 2000 uses a USB plug 2010 as a plug connected to the computer system 20. The cable 60 for charging the wireless mouse or wireless keyboard 100 is connected to a power jack 2036.

The wireless keyboard 100 may use an infrared ray (IR) method or radio frequency (RF) method. In the case of the IR type wireless keyboard 100, the wireless data communication circuit 2070 is designed in the IR method, and in the case of the RF type wireless keyboard 100, the wireless data communication circuit 2070 is designed in the RF method.

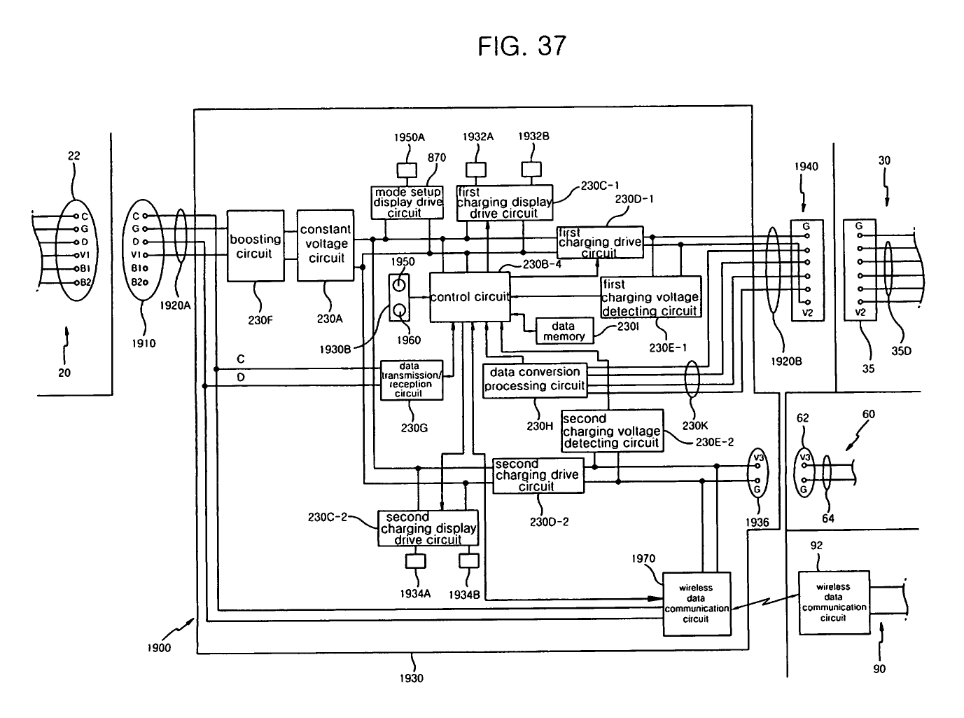

The circuit structure of the power supply and data repeater device will be easily understood by referring to FIG. 37.

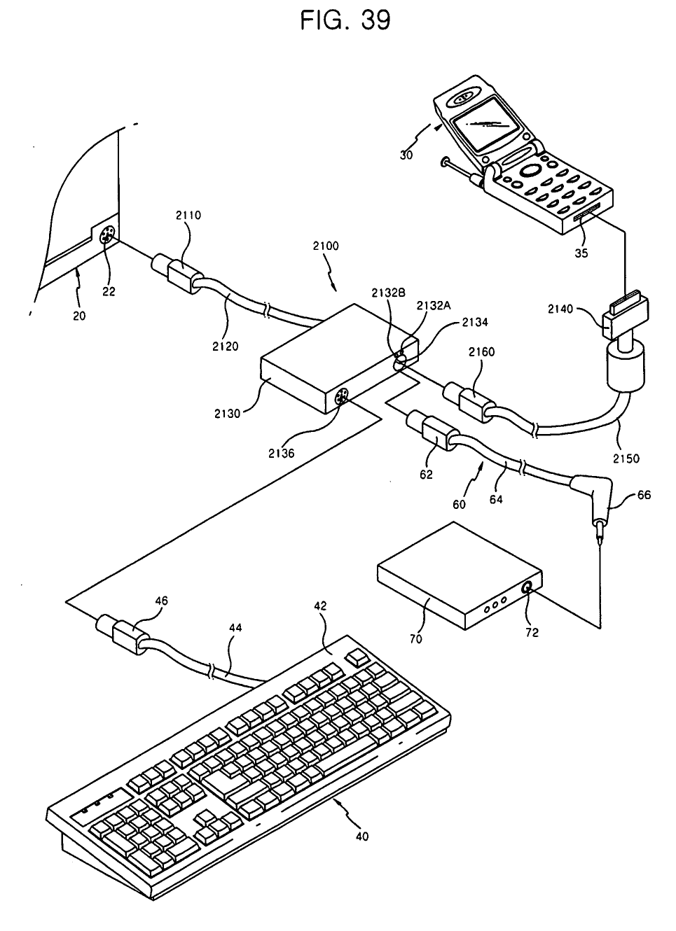

The power supply and data repeater device for the portable communication terminal using the peripheral device connection port of the computer system in accordance with the twenty-eighth embodiment of the present invention will now be explained with reference to FIG. 39.

As compared with the power supply and data repeater device of FIG. 10, the power supply and data repeater device 2100 separates a cable device having a second cable 2150 and a plug 2140 for charging the portable communication terminal 30 from a power/data repeater control block 2130. Preferably, a jack to which a connection plug 2160 of the cable device of the power supply and data repeater device 2100 is connected has a special shape so that the plug 62 of the cable for charging, for example the portable audio device 70 can be connected thereto.

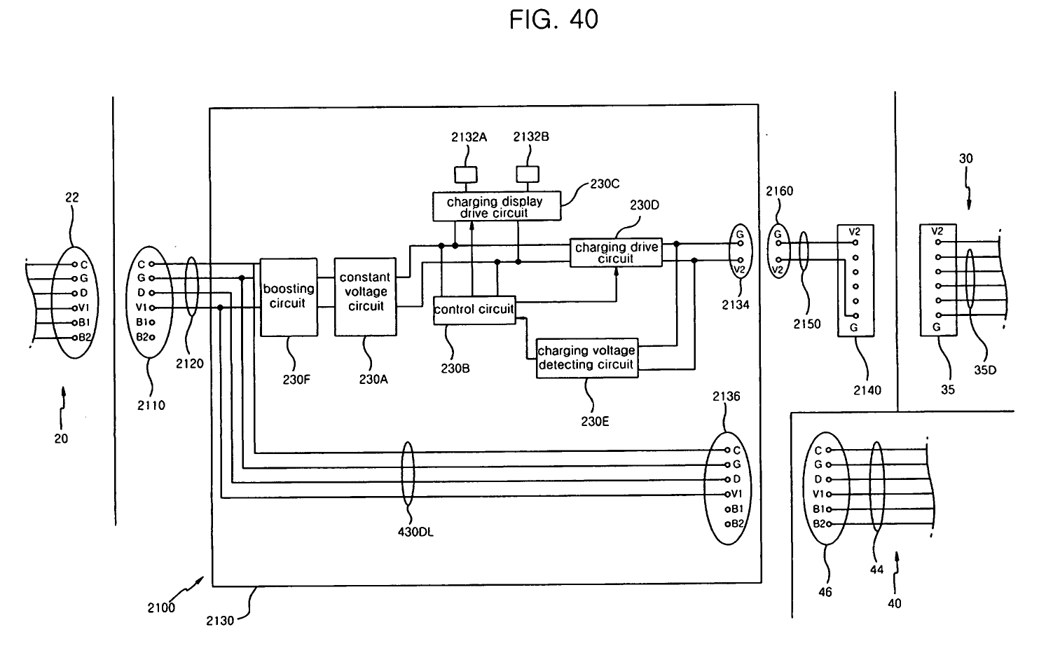

The power supply and data repeater device 2100 has the same circuit construction as the power supply and data repeater device of FIG. 40. That is, the difference exists merely on that the cable device having the second cable 2150 and the plug 2140 for charging the portable communication terminal 30 is separated from the power/data repeater control block 2130 in the circuit of FIG. 11.

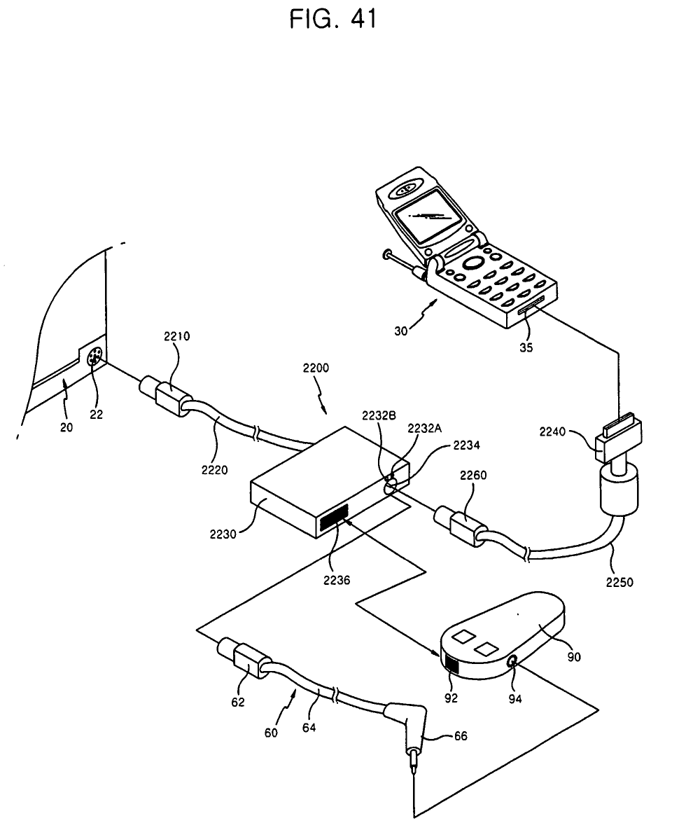

The power supply and data repeater device for the portable communication terminal using the peripheral device connection port of the computer system in accordance with the twenty-ninth embodiment of the present invention will now be explained with reference to FIG. 41.

As compared with the power supply and data repeater device of FIG. 36, the power supply and data repeater device 2200 separates a cable device having a second cable 2250 and a plug 2240 for charging the portable communication terminal 30 from a power/data repeater control block 2230, and does not have a structure for charging for example, the portable audio device 70. Preferably, a jack to which a connection plug 2260 of the cable device of the power supply and data repeater device 2200 is connected has a special shape so that the plug 62 of the cable for charging the wireless mouse 90 can be connected thereto.

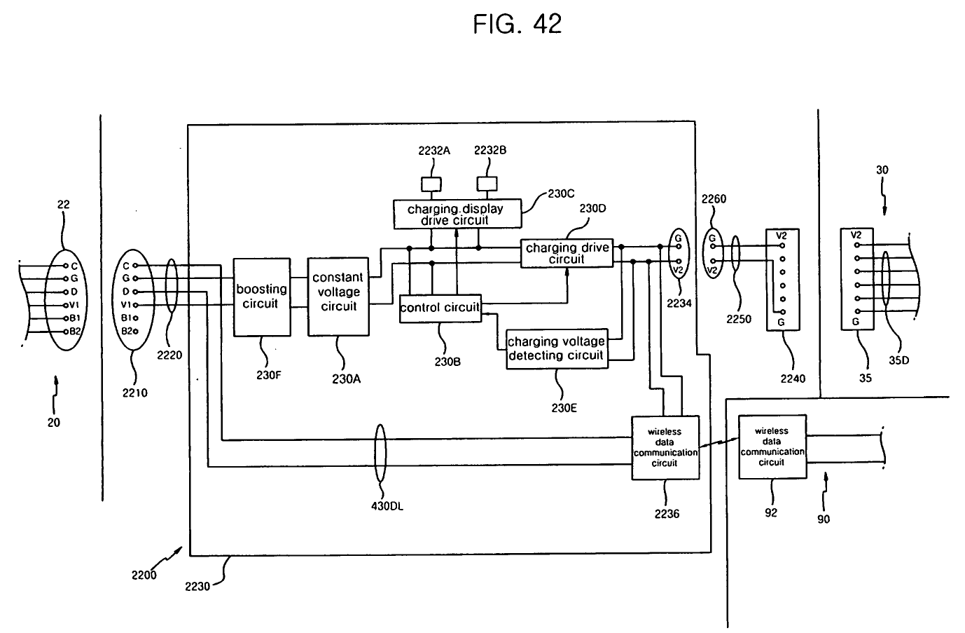

The circuit structure of the power supply and data repeater device 2200 of FIG. 42 is similar to the circuit structure of FIG. 37, and thus the operations thereof are performed in the same manner.

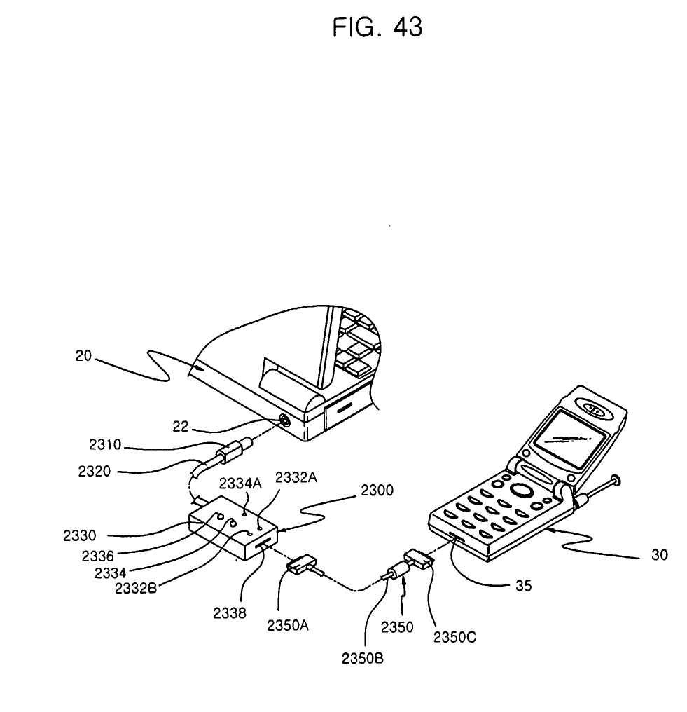

The power supply and data repeater device for the portable communication terminal using the peripheral device connection port of the computer system in accordance with the thirtieth embodiment of the present invention will now be explained with reference to FIG. 43.

As compared with the power supply and data repeater device of FIG. 22, the power supply and data repeater device 2300 separates a cable device 2350 for charging the portable communication terminal 30 from a power/data repeater control block 2300.

As illustrated in FIG. 22, a plug 2310 inserted and connected to the mouse/keyboard connection jack 22 of the computer system 20 through the medium of a cable 2320 is incorporated with the power/data repeater control block 2300, and charging display devices 2332A and 2332B, a control mode setup key 2334, a control mode display device 2334A, a short message transmission key 2336 and a jack 2338 to which a plug 2350A of the cable device 2350 is inserted and connected are installed at the outer portion of the power/data repeater control block 2330. Moreover, the cable device 2350 incorporates the first plug 2350A inserted into the jack 2338 of the power/data repeater control block 2330, a cable 2350B and a second plug 2350C inserted into the power/data I/O jack 35 of the portable communication terminal 30.

Here, the jack 2338 of the power/data repeater control block 2300 and the plug 2350A of the cable device 2350 are formed in a rectangular shape, but may be formed in a circular shape as shown in FIG. 39.

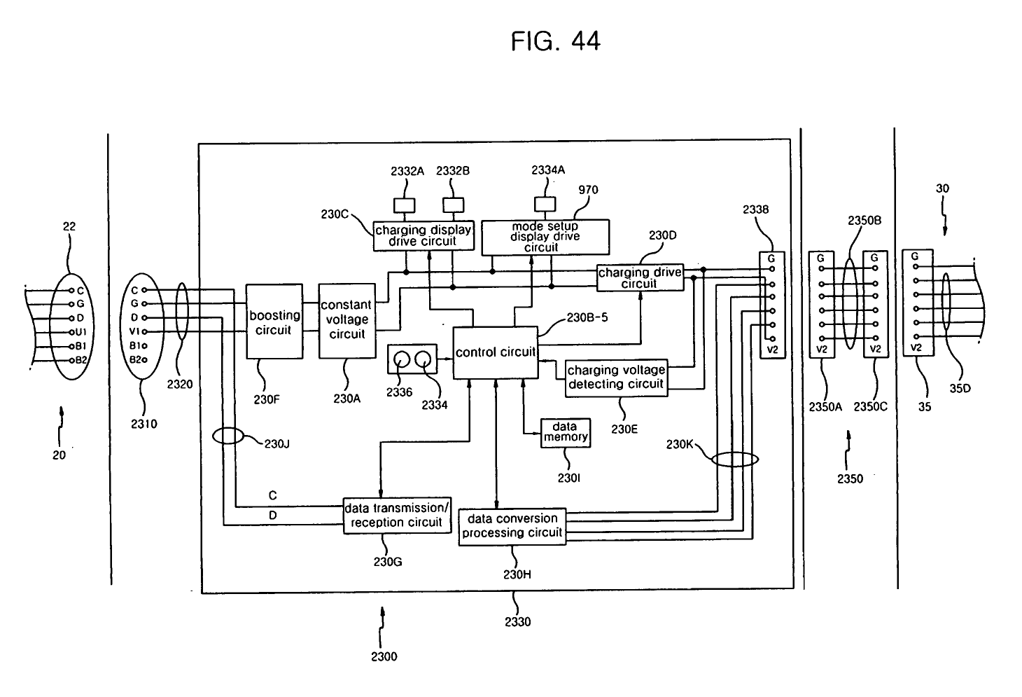

Referring to FIG. 44, the power supply and data repeater device 2300 has the same circuit structure as the power supply and data repeater device 900 of FIGS. 22 and 23, except that the power/data repeater control block 2330 is separated from the cable device 2350, and thus detailed explanations of the operations are omitted.

In this embodiment, the power supply and data repeater device 2300 is inserted and connected to the mouse/keyboard connection jack 22 of the computer system 20, but may be connected to the USB connection jack of the computer system 20.

In addition, a structure for supplying power to the portable audio device or the like can be added to the power supply and data repeater device 2300 as shown in FIGS. 24 and 25, a structure for connecting the wire mouse device or wire keyboard device can be added thereto as shown in FIGS. 26 and 27, and a structure for connecting the wireless mouse device or wireless keyboard device can be added thereto as shown in FIGS. 36 to 38. When the power supply and data repeater device 2300 is connected to the USB connection jack of the computer system 20, a structure for connecting an I/O device through the USB port such as the web camera can be added thereto as shown in FIG. 30.

Here, the power supply and data repeater device 2300 incorporates the plug 2310 and the cable 2320 to be connected to the computer system 20, and thus the plug 2310 is inserted and connected to the mouse/keyboard connection jack 22 of the computer system 20. However, the power supply and data repeater device 2300 can remove the cable and incorporate the plug 2310 and the power/data repeater control block 2330 as shown in FIGS. 17 to 20.

The control operation of the portable communication terminal by the power supply and data repeater device in accordance with the present invention will now be explained with reference to FIGS. 22 to 43.

FIGS. 45 to 47 are system construction views illustrating the charging operation and control operation of the portable communication terminal 30 and the data input operation of the keyboard device 40, the mouse device 80 or the USB input device 50, in a state where the power supply and data repeater device of FIGS. 22 to 43 is connected to the keyboard connection jack, the mouse connection jack or the USB jack of the computer system.

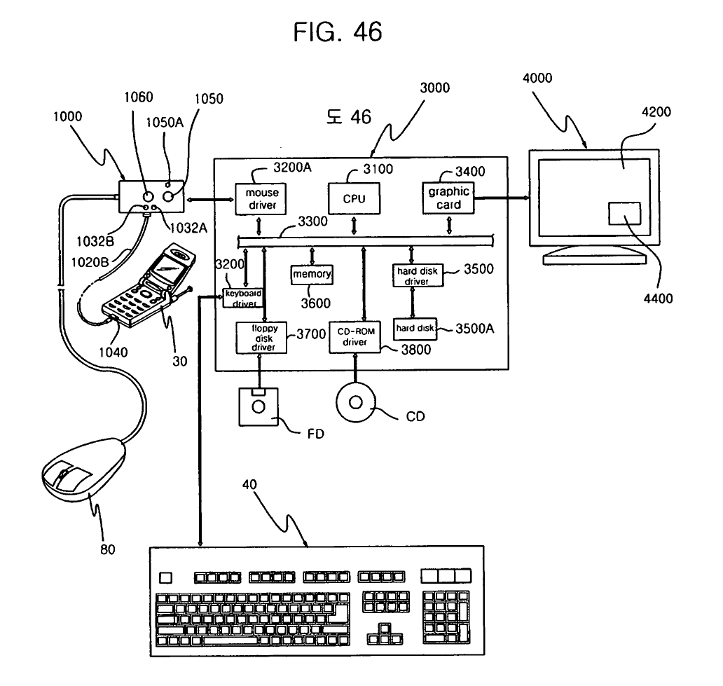

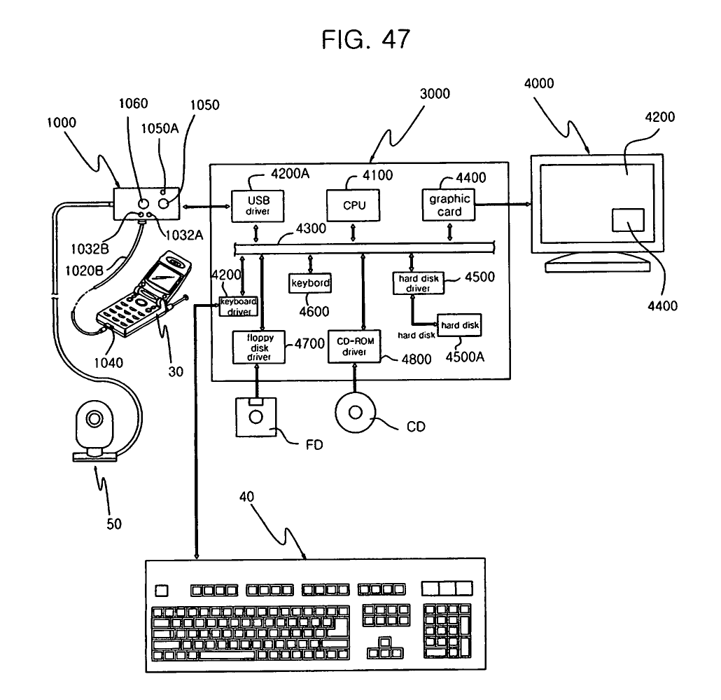

FIG. 45 is a system construction view illustrating a state where the power supply and data repeater device 1000 of FIG. 26 is connected to the keyboard connection jack of the computer system 3000, FIG. 46 is a system construction view illustrating a state where the power supply and data repeater device 1000 of FIG. 26 is connected to the mouse connection jack of the computer system 3000, and FIG. 47 is a system construction view illustrating a state where the power supply and data repeater device 1300 of FIG. 30 is connected to the USB connection jack of the computer system 3000.

In accordance with the present invention, a software for interface compatibility of control signals and data signals among the computer system 3000, the power supply and data repeater device of the invention and the portable communication terminal 30 and a software for composing an interface screen between the computer system 3000 and the power supply and data repeater device are required to supply the power to the portable communication terminal 30, and embody various functions such as a function of displaying a short message received by the portable communication terminal 30 through the short message service on a display device 4000 by using the computer system 3000, a function of displaying caller information received by the portable communication terminal 30 on the display device 4000 by using the computer system 3000, a function of transmitting a short message through the short message service of the portable communication terminal 30 by using the keyboard 40 of the computer system 3000, and a function of setting up a function mode of the portable communication terminal 30 by using the computer system 3000.

When the user purchases the device of the invention, the software recorded on a portable recording medium, for example a floppy disk (FD) or compact disk (CD) is provided to the user. In addition, the user can upgrade the software by accessing an internet homepage of the provider, and downloading the update program.

The user inserts the portable recording medium (CD or FD) storing the portable communication terminal control driving drive program into an FD driver 3700 or CD-ROM driver 3800 of the computer system 3000, and installs the portable communication terminal control driving drive program.

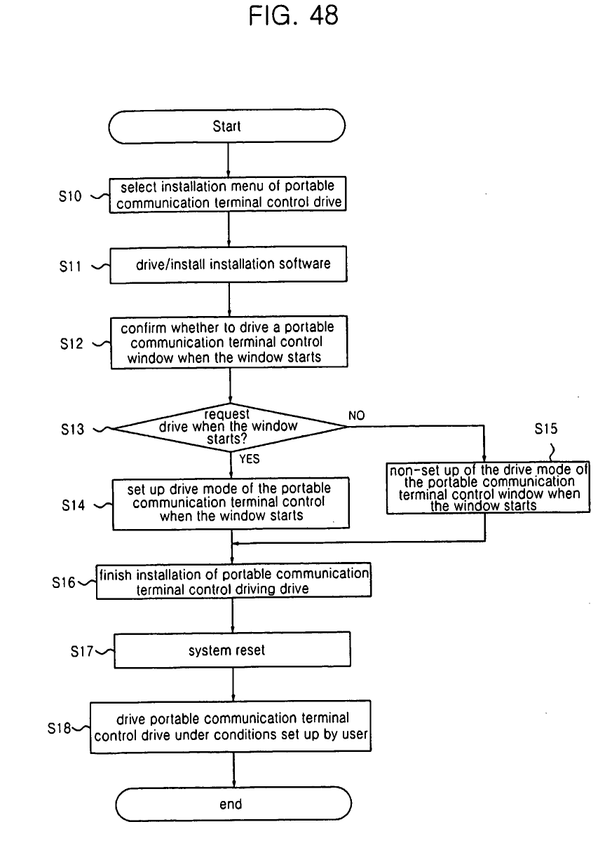

One example of the installation process will now be explained with reference to FIG. 48.

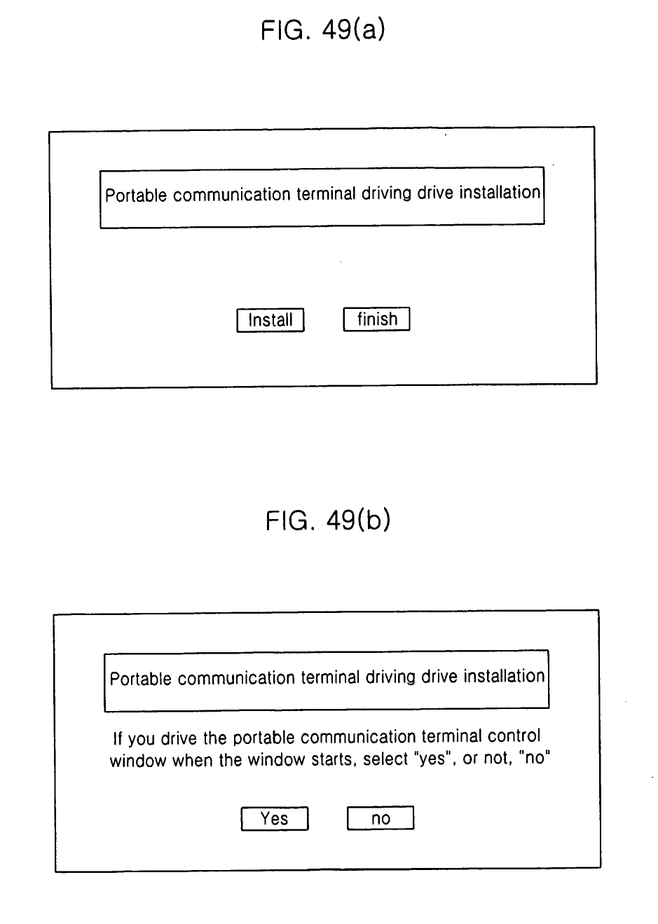

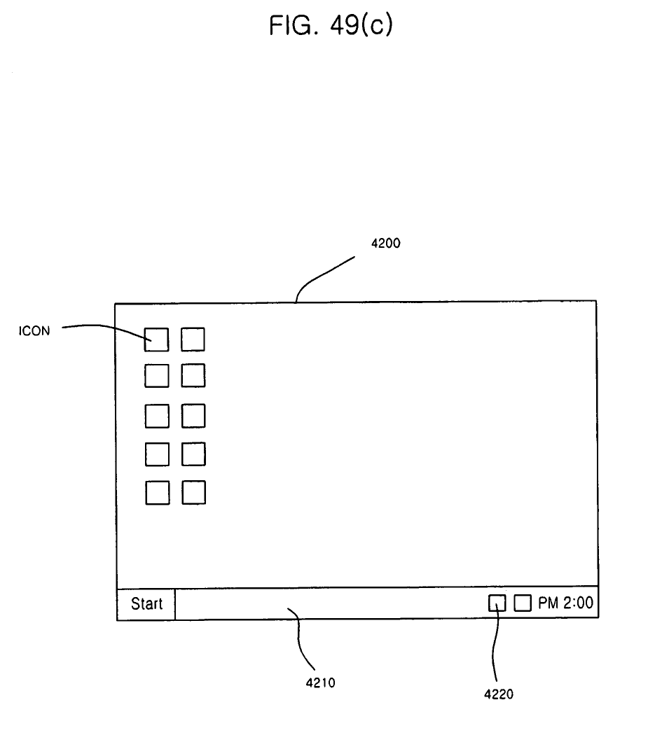

When the portable recording medium (CD or FD) storing the portable communication terminal control driving drive program is inserted into the FD driver 3700 or CD-ROM driver 3800 of the computer system 3000, a central processing unit (CPU) 3100 controls a graphic card 3400 so that an initial screen for installation of the portable communication terminal control driving drive program shown in FIG. 49(a) can be automatically displayed on a screen 4200 of a display device 4000.

Thereafter, when the user selects an installation menu of the initial screen of FIG. 49(a) by using the keyboard device 40 or mouse device 80 (S10), the CPU 3100 recognizes input of the keyboard device or mouse device, controls the driver device 3700 or 3800 which the recording medium FD or CD storing the portable communication terminal control driving drive program is inserted into to drive a corresponding installation software, and simultaneously controls a hard disk driver 3500 to store the drive program recorded on the recording medium FD or CD in an empty storage region of a hard disk 3500A (S11).

As shown in FIG. 49(b), the CPU 3100 controls the graphic card 3400 to display a screen for enabling the user to select whether to drive a portable communication terminal control window when the window starts on the screen 4200 of the display device 4000 by the corresponding installation software.

When the user inputs ‘Yes’ or ‘No’ to the screen of FIG. 49(b) by using the keyboard device or mouse device, the CPU 3100 confirms the input (S12-S13).

When the CPU 3100 confirms that the user selects ‘Yes’, the CPU 3100 renews information of a start program (for example, autoexec.bat and config.sys files) of the corresponding computer system by the corresponding installation software, and sets up to drive the portable communication terminal control window when the computer system starts to be driven (S14). Conversely, when the user selects ‘No’, the CPU 3100 recognizes the input and goes to the next step without changing the information of the start program (S15).

When installation of the portable communication terminal control driving drive program is finished, the CPU 3100 controls the graphic card 3400 to display a message screen for displaying completion of the installation and re-driving the system on the screen 4100 of the display device 4000 by the installation software (S16).

Thereafter, when the user demands to newly start the computer system, the CPU 3100 finishes the computer system, resets the computer system and drives the window (S17).

The portable communication terminal control driving drive program is driven under the conditions set up by the user in the steps of S14 or S15 (S18).

That is, if information of the start program of the computer system is renewed in S14, when the computer system starts according to the information of the start program (for example, autoexec.bat and config.sys files), the portable communication terminal window is driven to be displayed in an icon shape 4220 at a predetermined region of an operation display line 4210 on the screen 4200 of the display device 4000 having a plurality of background screen icons and the operation display line 4210, as shown in FIG. 49(c).

The operation when the user connects the power supply and data repeater device of FIGS. 22 to 44 to the portable communication terminal 30 and the computer system 20 and operates the control mode setup button 1050A in a state where the portable communication terminal control driving drive program is installed by the operation of FIG. 48 will now be explained with reference to FIGS. 26, 27, 45 and 50.

Firstly, when the user operates the control mode setup button 1050 of the power supply and data repeater device 1000, the control circuit 230B-3 recognizes the operation, and drives the mode setup display drive circuit 870 so that a mode setup display device 1050A can emit light (S20).

The control circuit 230B-3 sets up the communication mode for the portable communication terminal, transmits a communication mode setup request to the portable communication terminal 30 through the data conversion processing circuit 230H, sets up a communication mode for the computer systems 20 and 3000, and transmits a communication mode setup request to the computer system 20 through the data transmission/reception circuit 230G at the same time (S21).

The portable communication terminal 30 receiving the communication mode setup request sets up a communication mode for the power supply and data repeater device 1000 (S22).

The CPU 3100 of the computer system 20 which receives the communication mode setup request through for example, the keyboard driver 3200 sets up the communication mode for the power supply and data repeater device 1000 (S23), and drives the portable communication terminal control window.

Here, when the portable communication terminal control driving drive program is not driven at the time of starting the computer system 20, the CPU 3100 controls the hard disk driver 3500 to drive the portable communication terminal control driving drive program previously installed and stored in a predetermined region of the hard disk 3500A, and also controls the graphic card 3400 to display the portable communication terminal control window 4400 on a predetermined region of the screen 4200 of the display device 4000.

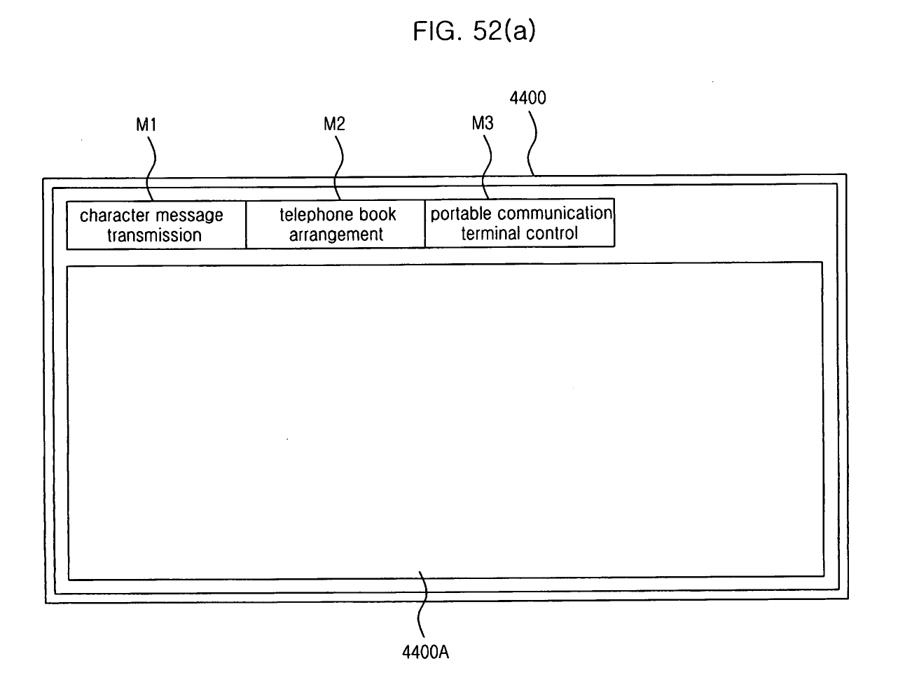

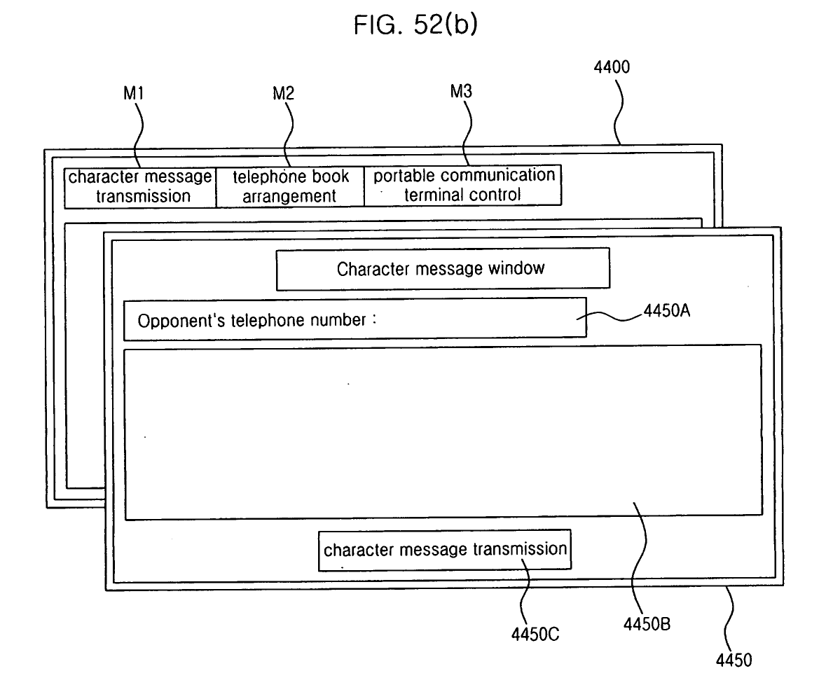

Conversely, when the portable communication terminal control driving drive program is driven at the time of starting the computer system 20 and when the portable communication terminal control window is displayed in an icon shape at a predetermined region of the operation display line 4210 of the screen 4200 of the display device 4000 as shown in FIG. 49(c), the CPU 3100 drives the portable communication terminal control window display program of the memory 3600, and controls the graphic card 3400 to display the portable communication terminal control window 4400 on a predetermined region of the screen 4200 of the display device 4000 as shown in FIG. 52(a) (S24-S25).

When the portable communication terminal control window 4400 is displayed, if the portable communication terminal 30 receives caller information (Caller ID; i.e., caller phone number), the portable communication terminal 30 transmits the caller information to the power supply and data repeater device 1000 (S26).

That is, the caller information is transmitted to the data conversion processing circuit 230H through the data line 35D, the power/data I/O jack 35, and the plug 1040 and the cable 1020B of the power supply and data repeater device 1000. The data conversion processing circuit 230H transmits the caller information data converted to have a data format suitable for the computer systems 20 and 3000 to the control circuit 230B-3.

The control circuit 230B-3 searches the data memory 230I. When a phone number identical to the caller phone number of the caller information has been previously stored in the data memory 230I by for example, the keyboard, the control circuit 230B-3 reads detailed information data of the caller (for example, name, firm name, fax number, etc.) corresponding to the phone number, and transmits the data to the computer systems 20 and 3000 through the data transmission/reception circuit 230G (S27).

The CPU 3100 of the computer system drives the graphic card 3400 to display the detailed information data of the caller received from the power supply and data repeater device 1000 through for example, the keyboard driver 3200 on the portable communication terminal control window (S28).

Accordingly, the caller information and the detailed information thereof are displayed on the portable communication terminal control window 4400 of the display device screen 4200 (S29).

In the case that the control circuit 230B-3 of the power supply and data repeater device 1000 fails to find the detailed caller information corresponding to the caller information in the step of S27, the control circuit 230B-3 outputs the caller information from the portable communication terminal 30 to the computer system. The computer system displays the caller information on the portable communication terminal control window of the display device.

On the other hand, when the portable communication terminal 30 receives a short message, it transmits the short message to the power supply and data repeater device 1000 (S30).

That is, the short message is transmitted to the data conversion processing circuit 230H through the data line 35D, the power/data I/O jack 35, and the plug 1040 and the cable 920B of the power supply and data repeater device 1000. The data conversion processing circuit 230H transmits the short message converted to have a data format suitable for the computer systems 20 and 3000 to the control circuit 230B-3.

The control circuit 230B-3 transmits the short message to the computer systems 20 and 3000 through the data transmission/reception circuit 230G (S31).

Thereafter, the CPU 3100 of the computer systems 20 and 3000 drives the graphic card 3400 to display the short message received from the power supply and data repeater device 1000 through for example, the keyboard driver 3200 on the portable communication terminal control window (S32).

Therefore, the short message is displayed on the portable communication terminal control window 4400 of the display device screen 4200 (S33).

The operation of transmitting the short message with the support of the computer systems 20 and 3000 when the user connects the power supply and data repeater device of FIGS. 22 to 44 to the portable communication terminal 30 and the computer systems 20 and 3000 in a state where the portable communication terminal control driving drive program is installed by the operation of FIG. 48 will now be explained with reference to FIGS. 26, 27, 45 and 51.

When the user sets up the short message input mode by selecting a short message menu M1 of the portable communication terminal control window 4400 of FIG. 52(a) by using the keyboard or mouse as the input device (S40), the CPU 3100 of the computer system 3000 recognizes the input and controls the graphic card 3400 to display the short message window (S41).

Accordingly, the short message window 4450 is displayed on the display device screen 4200 as shown in FIG. 52(b) (S42).

Thereafter, when the user inputs a receiver phone number to a receiver phone number input window 4450A by using the short message input unit such as the keyboard and also inputs the short message to a short message input window 4450B, the CPU 3100 controls the graphic card 3400 to display the receiver phone number and the short message on the short message window 4450 (S43-S44).

Here, the inputted receiver phone number and short message are stored in the data memory 230I under the control of the control circuit 230B-3 of the power supply and data repeater device 1000, and temporarily stored in the memory 3600 of the computer system.

When the user operates the short message transmission button 1060, the control circuit 230B-3 recognizes the operation, and transmits the stored short message transmission data to the portable communication terminal 30 through the data conversion processing circuit 230H (S47).

In addition, the inputted short message transmission data can be transmitted to the portable communication terminal 30 without operating the short message transmission button 1060 in the steps of S46 and S47.

In the case of the notebook computer, when the user inputs the short message and sets up a short message transmission mode by selecting a short message transmission menu 4450C by using the keyboard or mouse as the input device, the CPU 3100 recognizes the operation, reads the receiver phone number and short message temporarily stored in the memory 3600, and transmits them to the power supply and data repeater device 1000 through for example, the keyboard driver 3200.

Here, the transmitted data contains a header for displaying that the data is the short message transmission data.

The control circuit 230B-3 of the power supply and data repeater device 1000 receiving the short message transmission data through the data transmission/reception circuit 230G recognizes the short message transmission data by analyzing the header of the data, stores the data in the data memory 230I, and transmits the data to the portable communication terminal 30 (S46).

The portable communication terminal 30 receives the short message transmission data, recognizes the short message by analyzing the header of the data, separates the receiver phone number and the short message, and transmits the short message to the receiver phone number (S48).

Then, the portable communication terminal 30 notifies completion of the short message transmission to the power supply and data repeater device 1000 (S49).

The control circuit 230B-3 of the power supply and data repeater device 1000 which is informed of completion of the short message transmission by the data conversion processing circuit 230H notifies completion of the short message transmission to the computer systems 20 and 3000 through the data transmission/reception circuit 230G (S50).

The CPU 3100 of the computer system informed of completion of the short message transmission by for example, the keyboard driver 3200 controls the graphic card 3400 to display completion of the short message transmission on the short message window 4450 of the display device 4000 of FIG. 52(b) (S51-S52).

The operation of renewing a telephone directory of the power supply and data repeater device by using the computer systems 20 and 3000 when the user connects the power supply and data repeater device of FIGS. 22 to 44 to the portable communication terminal 30 and the computer systems 20 and 3000 in a state where the portable communication terminal control driving drive program is installed by the operation of FIG. 48 will now be explained with reference to FIGS. 26, 27, 45 and 53.

In order to renew telephone directory information stored in the power supply and data repeater device 1000, when the user sets up a telephone directory renewal mode by selecting a telephone directory sorting menu M2 of the portable communication terminal control window 4400 of FIG. 52(a) by using the keyboard or mouse as an input device (S60), the CPU 3100 of the computer system 3000 recognizes the operation, and outputs a message of requesting previously-stored phone number information to the power supply and data repeater device 1000 through for example, the keyboard driver 3200 (S61).

The control circuit 230B-3 of the power supply and data repeater device 1000 receiving the phone number information transmission request message through the data transmission/reception circuit 230G reads the phone number information from the data memory 230I and transmits the information to the computer system 3000 through the data transmission/reception circuit 230G (S62).

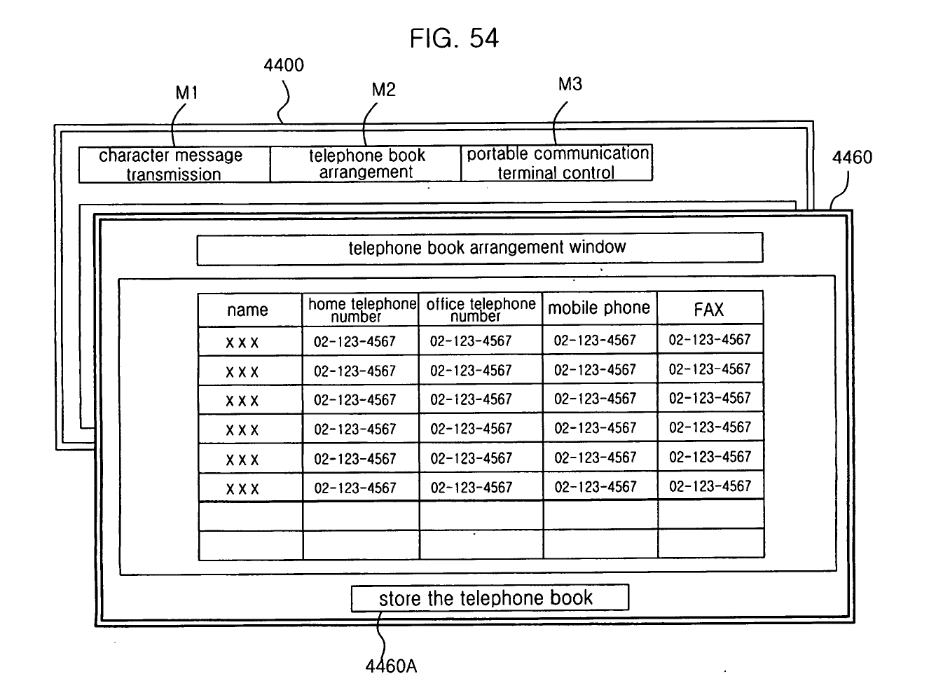

The CPU 3100 of the computer system 3000 receiving the phone number information from the power supply and data repeater device 1000 through for example, the keyboard driver 3200 controls the graphic card 3400 to display the phone number information on the telephone directory sorting window 4460 as shown in FIG. 54 (S63-S64).

Thereafter, when the user corrects or deletes a phone number list displayed on the telephone directory sorting window 4460, or inputs a new phone number list, the CPU 3100 controls the graphic card 3400 to display the corrected, deleted or newly-inputted phone number list on the telephone directory sorting window 4460 (S65-S66).

Here, the phone number information renewed by the correction, deletion or input is temporarily stored in the memory 3600.

When the user renews the phone number information and sets up a renewed phone number information storage mode by selecting a telephone directory storage menu 4460A by using the keyboard or mouse as the input device (S67), the CPU 3100 recognizes the operation, reads the phone number information temporarily stored in the memory 3600, and transmits the information to the power supply and data repeater device 1000 through for example, the keyboard driver 3200 (S68).

Here, the transmitted data contains a header for displaying that the data is the phone number information renewal data.

As a result, the user does not have to store contents of the phone number database one by one in replacement of the portable communication terminal, by moving the phone number database from one portable communication terminal to another.

The control circuit 230B-3 of the power supply and data repeater device 1000 receiving the phone number information renewal data through the data transmission/reception circuit 230G recognizes the phone number information renewal data by analyzing the header of the data, and renews the phone number information stored in the data memory 230I (S69).

The control circuit 230B-3 of the power supply and data repeater device 1000 transmits a message of displaying completion of the phone number information renewal to the computer system 3000 through the data transmission/reception circuit 230G (S70).

The CPU 3100 of the computer system 3000 receiving the phone number information renewal completion message through for example, the keyboard driver 3200 controls the graphic card 3400 to display the phone number information renewal completion message on the telephone directory sorting window 4460 of the display device (S71-S72).

The operation of renewing setup control information of the portable communication terminal by using the computer systems 20 and 3000 when the user connects the power supply and data repeater device of FIGS. 22 to 44 to the portable communication terminal 30 and the computer systems 20 and 3000 in a state where the portable communication terminal control driving drive program is installed by the operation of FIG. 48 will now be explained with reference to FIGS. 26, 27, 45 and 54.

In order to renew the setup control information of the portable communication terminal 30, when the user sets up a portable communication terminal setup information renewal mode by selecting a portable communication terminal control menu M3 of the portable communication terminal control window 4400 of FIG. 52(a) by using the keyboard or mouse as the input device (S80), the CPU 3100 of the computer system 3000 recognizes the operation, and outputs a portable communication terminal setup information request message to the power supply and data repeater device 1000 through for example, the keyboard driver 3200 (S81).

Here, a header of the message contains information displaying that the message is the portable communication terminal setup information request message.

The control circuit 230B-3 of the power supply and data repeater device 1000 receiving the portable communication terminal setup information request message through the data transmission/reception circuit 230G recognizes the message and transmits it to the portable communication terminal 30 through the data conversion processing circuit 230H.

The portable communication terminal receiving the portable communication terminal setup information request message recognizes the message, reads previously-determined setup information from the memory, and transmits the portable communication terminal setup information message having the setup information and header to the power supply and data repeater device 1000 (S83).

Here, the header contains information displaying that the message is the portable communication terminal setup information message.

The control circuit 230B-3 of the power supply and data repeater device 1000 receiving the portable communication terminal setup information message through the data conversion processing circuit 230H recognizes the portable communication terminal setup information message and transmits the message to the computer system 3000 through the data transmission/reception circuit 230G (S84).

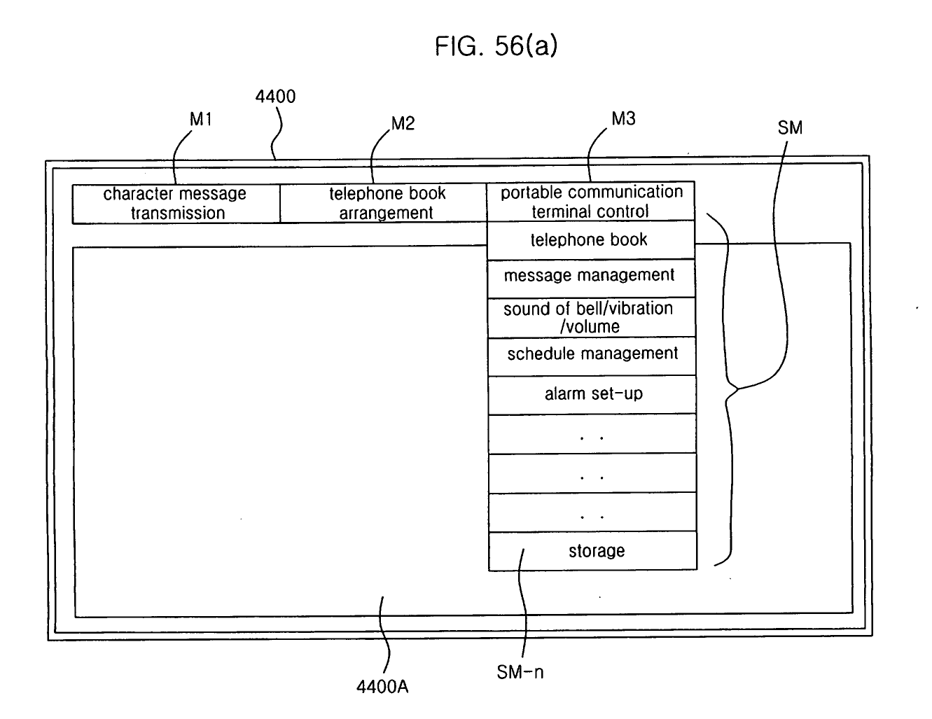

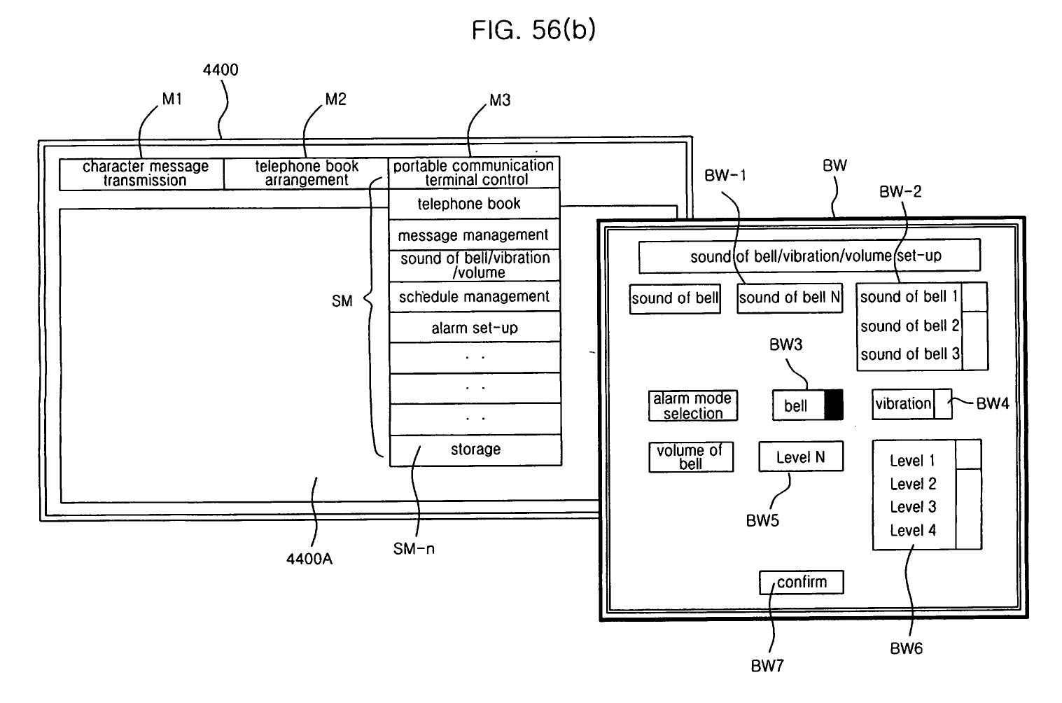

The CPU 3100 of the computer system 3000 receiving the portable communication terminal setup information message from the power supply and data repeater device 1000 through for example, the keyboard driver 3200 temporarily stores the message in the memory 3600, and controls the graphic card 3400 to display a portable communication terminal control sub menu SM as shown in FIG. 56(a).

Then, when the user selects for example, a bell sound/vibration/loudness menu, the CPU 3100 reads the portable communication terminal setup information relating to the menu from the memory 3600, and controls the graphic card 3400 to display a bell sound/vibration/loudness setup window BW corresponding to the menu as shown in FIG. 56(b) (S84, S85).

When the user intends to change bell sound N of a bell sound setup window BW_1 to a different bell sound in the bell sound/vibration/loudness setup window BW, the user searches a wanted bell sound by moving a scroll bar at the right side of a bell sound selection window BW-2 by using the input unit such as the mouse and clicks the bell sound, to set up the bell sound in the bell sound setup window BW1. In addition, when the user wants to change bell of a bell selection window BW3 to vibration, the user clicks a vibration selection window BW4 to select vibration. In the case that the user intends to change level N of a bell loudness setup window BW-5 into a different level, the user searches a wanted level by moving the scroll bar at the right side of a level selection window BW-6 by using the input unit such as the mouse and clicks the level, to set up the bell sound level in the bell loudness setup window BW-5.

When the user sets up the bell sound, vibration and loudness on the bell sound/vibration/loudness setup window BW and clicks a confirmation menu BW7 through the mouse, the CPU 3100 recognizes it and stores the setup contents in the memory 3600 (S86-S88). In the same manner, the user can select a different sub menu of FIG. 56(a) and renews the setup contents. For brief explanations, drawings and explanations thereof are omitted.

When the user renews the setup contents of the portable communication terminal, and selects a storage menu SM-n which is the last item of the sub menu of FIG. 56(a) by using for example, the mouse (S89), the CPU 3100 recognizes the operation, reads the setup information of the portable communication terminal renewed and stored in the memory 3600, generates a portable communication terminal setup renewal information message by adding the header to the information, and transmits the message to the power supply and data repeater device 1000 through for example, the keyboard driver 3200 (S89).

Here, the header of the message includes information displaying that the message is the portable communication terminal setup renewal information.

The control circuit 230B-3 of the power supply and data repeater device 1000 which receives the portable communication terminal setup renewal information message through the data transmission/reception circuit 230G recognizes the portable communication terminal setup renewal information by analyzing the header of the message, and transmits the message to the portable communication terminal 30 through the data conversion processing circuit 230H (S90).

The portable communication terminal 30 receiving the portable communication terminal setup renewal information message recognizes the setup renewal information by analyzing the header of the message, and stores the renewal information in the memory as new setup information (S91).

Thereafter, the portable communication terminal 30 notifies completion of the setup information renewal to the power supply and data repeater device 1000 (S92). The control circuit 230B-3 of the power supply and data repeater device 1000 informed of completion of the renewal by the data conversion processing circuit 230H notifies it to the computer system 3000 through the data transmission/reception circuit 230G (S93).

The CPU 3100 of the computer system informed of completion of the renewal through for example, the keyboard driver 3200 controls the graphic card 3400 to display completion of the renewal of the portable communication terminal setup information on a window 4440 of the display device 4000 as shown in FIG. 56(a) (S94-S95).

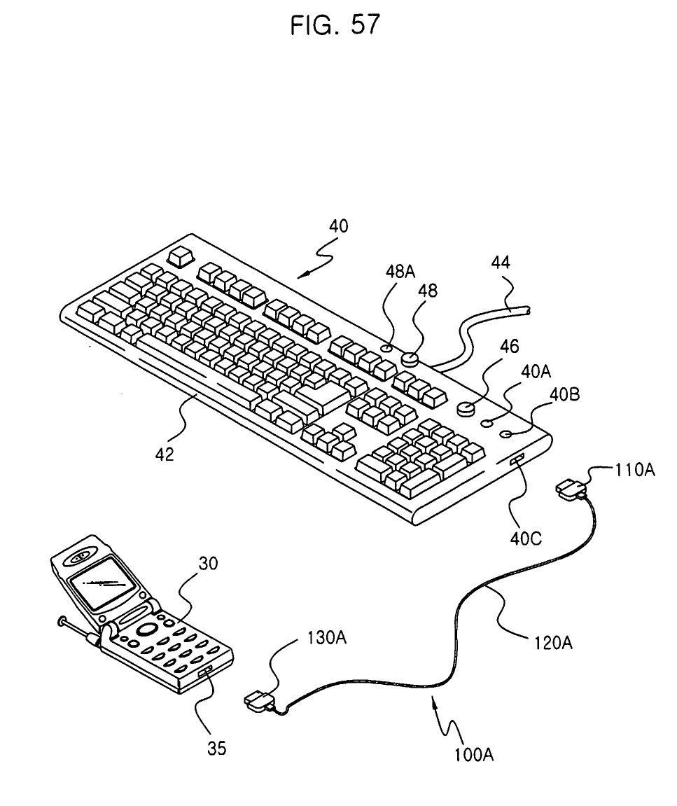

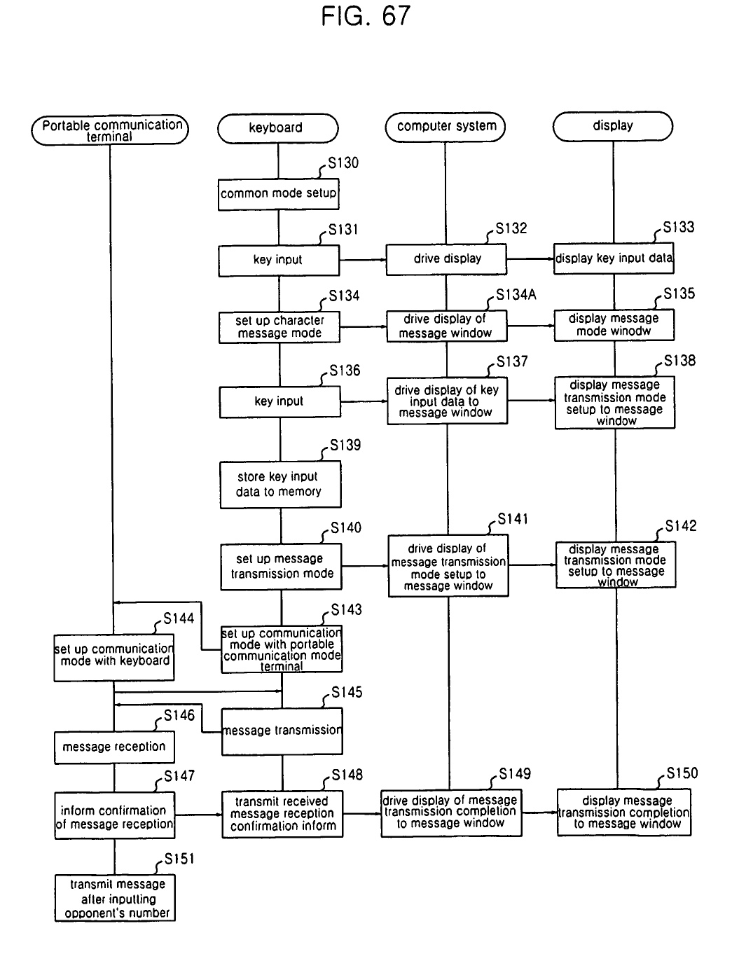

The keyboard device having the portable communication terminal connection structure in accordance with the thirty-first to thirty-third embodiments of the present invention will now be explained in detail with reference to FIGS. 57 to 67.

FIG. 57 is a schematic external view illustrating the keyboard device having the portable communication terminal connection structure in accordance with the thirty-first embodiment of the present invention.

Reference numeral 40 denotes the keyboard device including an operation panel 42 having a plurality of character and number keys for inputting characters and numbers, and a plurality of function keys for setting up special functions on its front surface.

A computer system connection cable 44 connected to for example, the computer system for receiving the key scan power, and transmitting data corresponding to a key operation generated on the operation panel 42 to the computer system is connected to the keyboard device 40.

A short message mode key 48 for setting up a short message mode for transmitting a short message through the portable communication terminal (30 of FIG. 57) is installed on the operation panel 42 of the keyboard device 40.

In addition, a connection jack 40C for connection to the portable communication terminal 30 is positioned at the side portion of the keyboard device 40.

A mode display device 48A composed of for example, an LED device for displaying the short message mode set up by the short message mode key 48 is installed on the operation panel 42.

A short message transmission key 46 for transmitting short message data inputted by the character keys and number keys of the operation panel 42 to the portable communication terminal 30 in a state where the keyboard device 40 has the short message mode by the operation of the short message mode key 40 is selectively provided on the operation panel 42. The short message transmission key 46 may not be required by using the short message transmission function set up by the portable communication terminal 30.

Charging display devices 40A and 40B are installed on the operation panel 42. The charging display devices 40A and 40B are for example, two LED devices emitting light according to the charging state of the charging battery of the portable communication terminal 30 when the portable communication terminal 30 is connected to the connection jack 40C through the medium of a portable communication terminal connection device 100A. For example, the charging display devices 40A and 40B include a red LED device displaying the charging state and a green LED device displaying completion of the charging state.

The portable communication terminal connection device 100A for connection to the portable communication terminal 30 is connected to the connection jack 40C. Here, the portable communication terminal connection device 100A includes: a connection plug 110A inserted and connected to the connection jack 40C; a connection plug 130A inserted and connected to the power/data I/O jack 35 of the portable communication terminal 30; and a cable 120A for connecting the connection plugs 110A and 130A. Since different power/data I/O jacks 35 are used according to kinds of portable communication terminals 30, a wiring structure of power lines and data lines of the connection plug 130A of the portable communication terminal connection device 100A is changed to obtain compatibility. If necessary, different connection jacks 40C and portable communication terminal connection devices 100A can be used according to kinds of portable communication terminals 30.

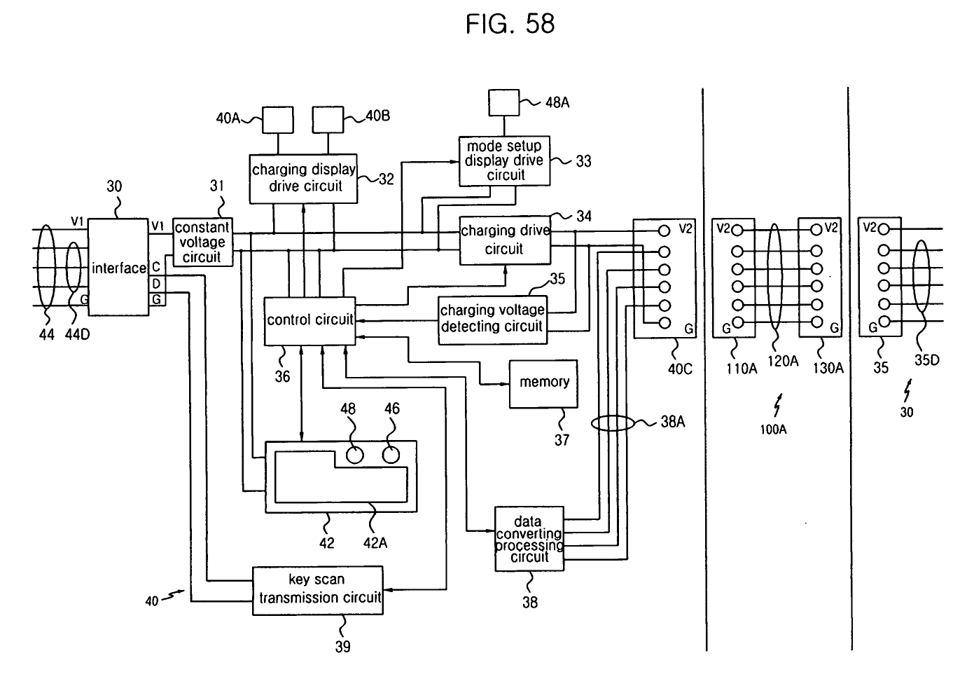

FIG. 58 is a block view illustrating an internal circuit of the keyboard device having the portable communication terminal connection structure of FIG. 57 in accordance with the thirty-first embodiment of the present invention.

Referring to FIG. 58, the keyboard device 40 includes: an interface 30; a constant voltage circuit 31; a charging drive circuit 34; a charging voltage detecting circuit 34A; a charging display drive circuit 32; charging display devices 40A and 40B; a mode setup display drive circuit 33; a mode display device 48A; an operation panel 42 including a plurality of keys (character keys, number keys and function keys), a short message mode key 48 and a short message transmission key 46; a key scan data transmission circuit 39; a data conversion processing circuit 38; a memory 38, a connection jack 40C and a control circuit 36.

The interface 30 is connected to a key scan power line V1, a ground line G, a clock line C and a data line D at the computer system connection cable side of the keyboard device 40, for transmitting key scan data corresponding to the operation of the character keys, number keys and function keys on the operation panel 42 to the computer system side.

Here, the key scan power (about 5V) is transmitted to the keyboard connection jack to which the keyboard devices of the notebook computer system and the desktop computer system are connected in order to detect a key operation state of the externally-connected keyboard device.

The constant voltage circuit 31 rectifies and stabilizes the key scan power inputted through the ground line G and the key scan power line V1 of the computer system connection cable 44 connected to the keyboard connection jack of the computer system, and outputs the power of a necessary level.

The charging drive circuit 34 transmits the power of the constant voltage circuit 31 to the ground pin G and the power pin V2 of the power/data I/O jack 35 of the portable communication terminal 30 through the medium of the portable communication terminal connection device 100A connected to the connection jack 40A, and thus provides the operation power and the charging power to the portable communication terminal 30 to charge a battery (not shown).

The charging display driving circuit 32 drives the first charging display device 40A displaying the charging operation and the second charging display device 40B displaying completion of the charging operation under the control of the control circuit 36, and the charging voltage detecting circuit 35 detects the charging voltage of the battery of the portable communication terminal 30.

In addition, the control circuit 36 confirms a charging state (overcharging state) of the portable communication terminal 30 and a connection state of the power load terminal on the basis of the voltage detected by the charging voltage detecting circuit 34A. When the portable communication terminal 30 is not overcharged, the control circuit 36 controls the charging drive circuit 34 to constantly output the power to the power/data I/O jack 35 of the portable communication terminal 30 through the medium of the portable communication connection device 100A connected to the power jack 40C, and simultaneously controls the charging display drive circuits 40A and 40B to enable the first charging display device 40A to display the charging operation. In the case that the portable communication terminal 30 is overcharged, the control circuit 36 controls the charging drive circuit 34 not to output the power to the power/data I/O jack 35 of the portable communication terminal 30 through the connection jack 40C, and simultaneously controls the charging display drive circuit 32 to enable the second charging display device 40B to display completion of the charging operation. When the portable communication terminal 30 is not connected to the connection jack 40C through the medium of the portable communication terminal connection device 100A, the control circuit 36 controls the charging display drive circuit 32 to stop the display operation of the display devices 40A and 40B.

The control circuit 36 performs various control operations. That is, the control circuit 36 generates key scan data corresponding to the operation of the character keys, number keys and function keys on the operation panel 42, transmits the data to the computer system through the key scan data transmission circuit 39, the interface 30 and the computer system connection cable 44, sets up the short message mode of the keyboard device 40 in the operation of the short message mode key 48, controls the mode setup display drive circuit 33 to turn on the mode display device 48A, temporarily stores the input data in the memory 37 in response to the key operation on the operation panel 42 in the short message mode, and transmits the short message stored in the memory 37 in the short message transmission mode to the portable communication terminal 30 through the data conversion processing circuit 38, the connection jack 40A and the portable communication terminal connection device 100A.

The key scan data transmission circuit 39 for outputting the key scan data corresponding to the key operation on the operation panel 42 in the general keyboard mode through the interface 30 and the computer system connection cable 44 is connected to the control circuit 36.

The memory 37 for storing the short message data inputted from the operation panel 42 in the short message mode is connected to the control circuit 36, and the data conversion processing circuit 38 for converting the short message data stored in the memory 37 to have a data format recognizable by the portable communication terminal 30, and transmitting the data to the portable communication terminal 30 through the connection jack 40C and the portable communication terminal connection device 100A in the short message transmission mode is installed in the control circuit 36.

In accordance with the keyboard device having the portable communication connection structure as shown in FIGS. 57 and 58, when the computer system is turned on, the key scan power V1 is transmitted from the computer system to the operation panel 42 through the computer system connection cable 44, the interface 30 and the constant voltage circuit 31, and thus the control circuit 36 recognizes the key operation of the operation panel 42.

The key scan data is transmitted from the key scan data transmission circuit 39 to the computer system through the computer system connection cable 44 connected to the interface 30 under the control of the control circuit 36, and characters corresponding to the key operation are displayed on the display device (monitor) under the control of the computer system.

The key scan power V1 is stabilized by the constant voltage circuit 31 and supplied as the operation power and the charging power of the portable communication terminal 30 through the charging drive circuit 34, the connection jack 40C and the portable communication terminal connection device 100A.

When the short message mode key 48 is operated on the operation panel 42, the control circuit 36 sets up the short message mode of the keyboard device 40 not to transmit the short message data inputted from the operation panel 42 to the computer system side, and lights the mode display device 48A to visually display the short message mode.

Here, the short message data inputted from the operation panel 42 is stored in the memory 37. When the short message transmission key 46 is operated, the data conversion processing circuit 38 converts the short message data stored in the memory 37 to have a data format recognizable by the portable communication terminal 30, and transmits the data to the portable communication terminal 30 through the connection jack 40A and the portable communication terminal connection device 100A.

Accordingly, the short message data inputted through the operation panel 42 is displayed on the LCD panel of the portable communication terminal 30. When the message transmission function of the portable communication terminal 30 is operated, the short message inputted from the keyboard device 40 is transmitted to a short message receiver designated by the portable communication terminal 30.

On the other hand, when the operation panel 42 is not provided with the short message transmission key 46, the data conversion processing circuit 38 converts the short message data inputted through the operation panel 42 in the short message mode to have a data format recognizable by the portable communication terminal 30 under the control of the control circuit 36, and transmits the data to the portable communication terminal 30 through the connection jack 40C and the portable communication terminal connection device 100A. Therefore, the short message data inputted through the operation panel 42 is displayed on the LCD panel of the portable communication terminal 30. When the message transmission function of the portable communication terminal 30 is operated, the short message inputted from the keyboard device 40 is transmitted to a short message receiver designated by the portable communication terminal 30.

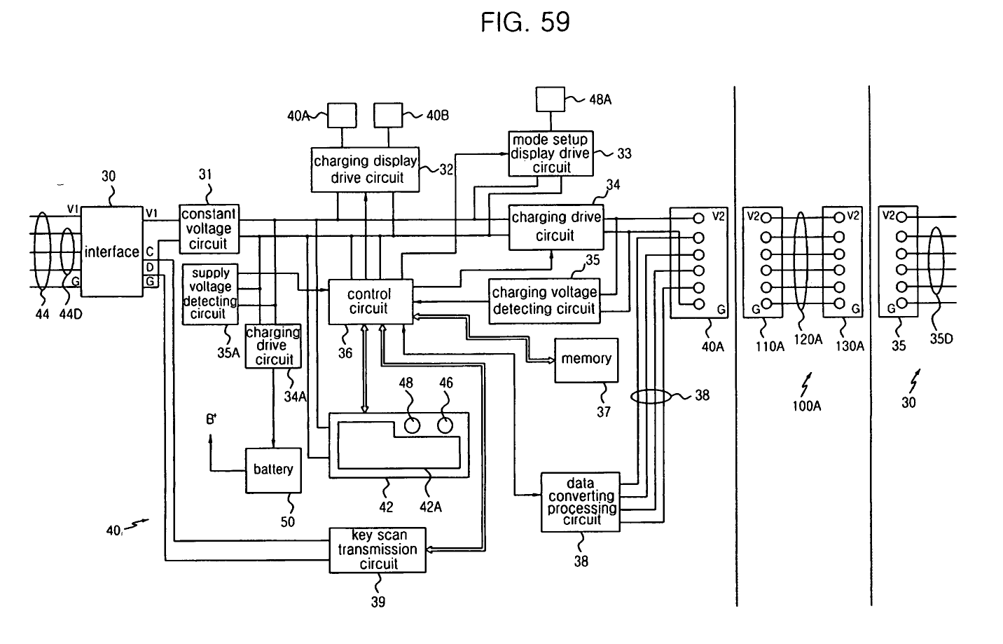

FIG. 59 is a block view illustrating another internal circuit of the keyboard device having the portable communication terminal connection structure in accordance with the thirty-first embodiment of the present invention.

In the keyboard device having the portable communication terminal connection structure of FIGS. 57 and 58, the key scan power V1 is used to charge the portable communication terminal 30 and also transmitted to the operation panel 42. That is, the keyboard device is operated when the computer system is turned on. In the modified example of FIG. 59, the keyboard device further includes: a charging battery 50 for charging the power when the computer system is turned on (for example, large capacity capacitor or rechargeable charging battery); a charging drive circuit 34B for supplying the charging power from the constant voltage circuit 31 to the charging battery 50; and a supply voltage detecting circuit 35A for detecting the voltage from the constant voltage circuit 31.

Here, the control circuit 36 detects an off state of the computer system according to the voltage detection result of the supply voltage detecting circuit 35A, and supplies the charging power of the charging battery 50 as the operation power of the keyboard device and the operation power and charging power of the portable communication terminal 30 in the off state of the computer system.

It is thus possible to supply the power to the portable communication terminal in the off state of the computer system. Moreover, the keyboard device 40 executes a control function for processing a short message of the portable communication terminal 30 under the control of the control circuit 36.

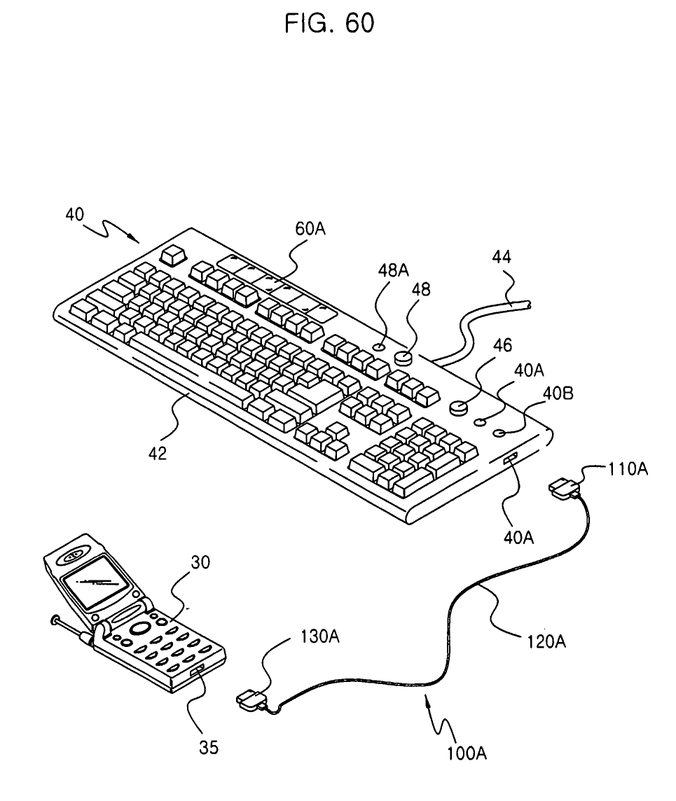

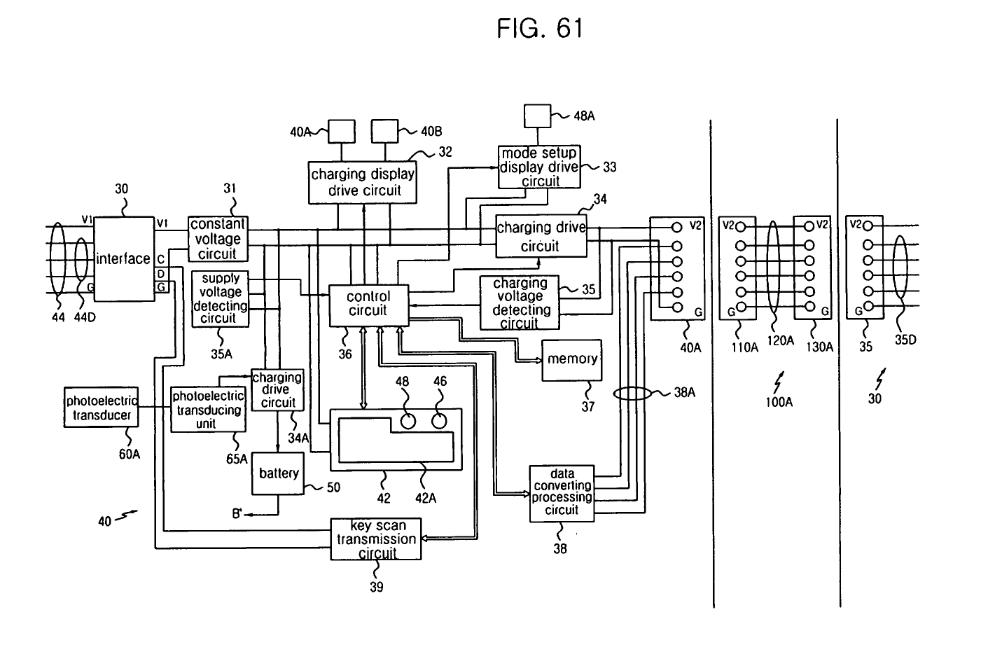

FIGS. 60 and 61 are views illustrating the keyboard device having the portable communication terminal connection structure in accordance with the thirty-second embodiment of the present invention.

As compared with the keyboard device of FIG. 59, the keyboard device of FIGS. 60 and 61 further includes a photoelectric transducer (preferably, solar battery) or thermal-electric transducer 60A for obtaining the charging power of the charging battery 50 on the operation panel 42, and a photoelectric transducing unit 65A for transducing a power signal from the photoelectric transducer 60A into a stable power signal, and transmitting the power signal to the charging drive circuit 34B.

In the structure of FIGS. 60 and 61, the battery 50 is charged with the power obtained by the photoelectric transducer 60A, regardless of the on/off state of the computer system. Thus, the corresponding keyboard device is used as the keyboard device for supplying power and inputting a short message to the portable communication terminal 30.

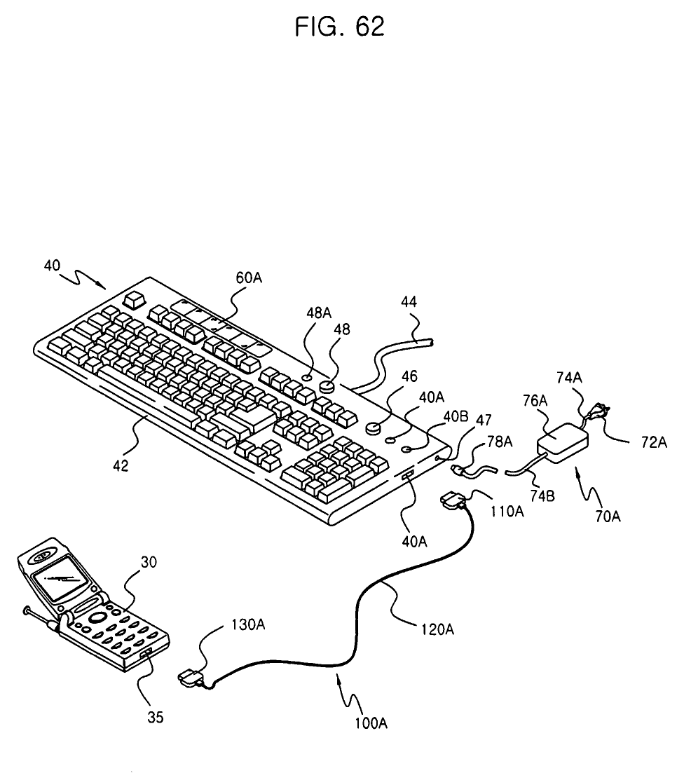

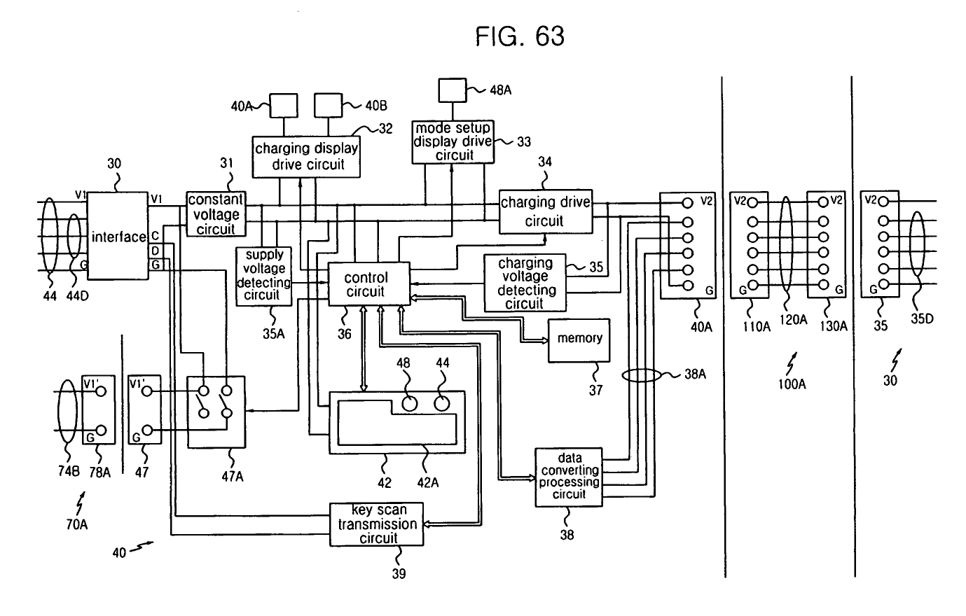

FIGS. 62 and 63 are views illustrating the keyboard device having the portable communication terminal connection structure in accordance with the thirty-third embodiment of the present invention. In this embodiment, the keyboard device includes an adapter connection port 47 for connection of an adapter device 70A for converting AC power to DC power, instead of the photoelectric transducer 60. Identically to a general adapter device, the adapter device 70A includes: a power plug 72A connected to the AC power, a first power cable 74A, a power conversion block 76A for converting the AC power to the DC power of a predetermined level; a second cable 74B; and a keyboard connection plug 78A inserted and connected to the adapter connection port 72.

A switch circuit 47A is installed in the adapter connection port 47, and a supply voltage detecting circuit 35A for detecting a supply voltage is installed in the constant voltage circuit 31.

Here, the control circuit 36 detects the off state of the computer system according to the voltage detection result of the supply voltage detecting circuit 35A, and supplies the adapter power of the adapter device 70A as the operation power of the keyboard device 40 and the operation power and charging power of the portable communication terminal 30 in the off state of the computer system.

It is therefore possible to supply the power to the portable communication terminal even in the off state of the computer system. Moreover, the keyboard device 40 executes a control function for processing a short message of the portable communication terminal 30 under the control of the control circuit 36.

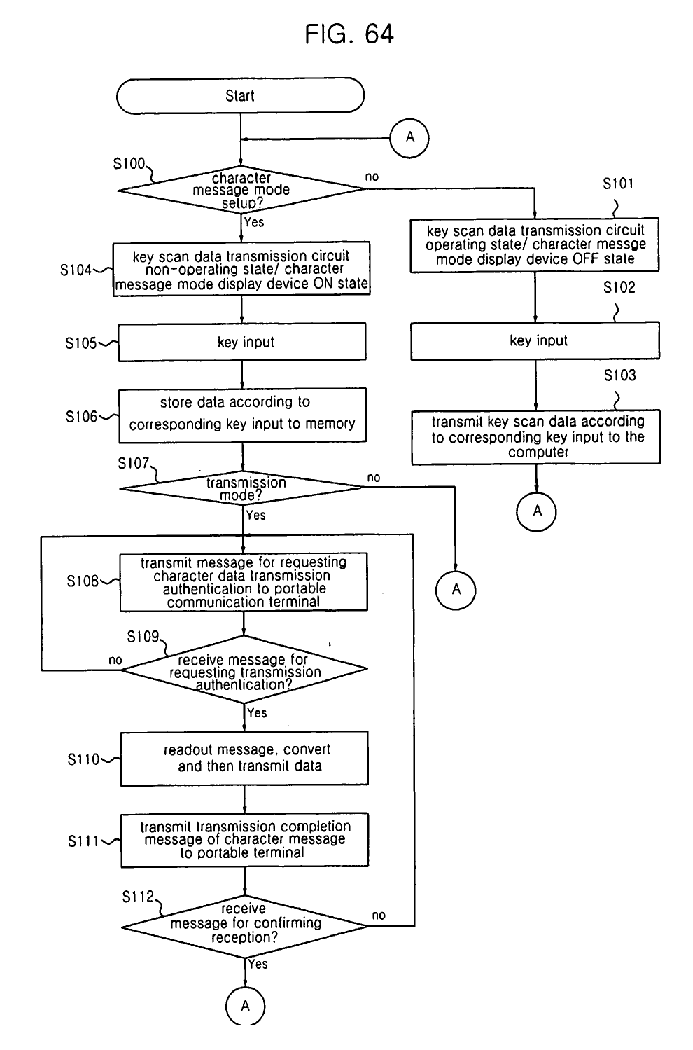

The operation of the keyboard device having the portable communication terminal connection structure in accordance with the thirty-first to thirty-third embodiments of the present invention will now be described with reference to FIG. 64.

When the portable communication terminal connection device 100A is inserted and connected to the connection jack 40A of the keyboard device 40 and the power/data I/O jack 35 of the portable communication terminal 30, the control circuit 36 confirms whether the short message mode is set up by the short message mode key 48 (S100).

When the short message mode is not set up, the control circuit 36 controls the short message mode display device 48A to maintain an off state, and simultaneously controls the key scan data transmission circuit 39 to maintain an on state (S101).

Thereafter, when the key input is generated from the operation panel 42, the control circuit 36 generates the key scan data corresponding to the key input, and outputs the data to the key scan data transmission circuit 39, thereby maintaining the general keyboard operation state of transmitting the key scan data to the computer system through the interface 30 (S102-S103).

On the other hand, when the short message mode is set up in S100, the control circuit 36 controls the short message mode display device 48A to maintain an on state, and simultaneously controls the key scan data transmission circuit 39 to maintain a non-operation state (S104).

When the key input is generated from the operation panel 42, the control circuit 36 generates the key scan data corresponding to the key input, and stores the data in the memory 37 (S105-S106).

The control circuit 36 confirms that the short message transmission mode is set up by the short message transmission key 46 (S107). When the short message transmission mode is set up, the control circuit 36 transmits a short message data transmission authentication request message to the portable communication terminal 30 through the data conversion processing circuit 38, the connection jack 40C and the portable communication terminal connection device 100A (S108).

Then, the control circuit 36 confirms whether the short message data transmission request authentication message is inputted from the portable communication terminal 30 through the data conversion processing circuit 38 (S109). When the short message data transmission request authentication message is inputted from the portable communication terminal 30, the control circuit 36 reads the short message data stored in the memory 37, and transmits the data to the portable communication terminal 30 through the data conversion processing circuit 38, the connection jack 40C and the portable communication terminal connection device 100A (S110). The control circuit 36 transmits a short message data transmission completion message to the portable communication terminal 30 through the data conversion processing circuit 38, the connection jack 40C and the portable communication terminal connection device 100A (S111). When receiving a short message data reception confirmation message from the portable communication terminal 30 through the data conversion processing circuit 38, the control circuit 36 ends the short message transmission mode (S112).

FIG. 64 is a flowchart when the short message transmission key 46 is provided to the operation panel 42. When the short message transmission key 46 is not installed on the operation panel 42, the data conversion processing circuit 38 converts the short message data inputted from the operation panel 42 in the short message processing mode to have a data format recognizable by the portable communication terminal 30 under the control of the control circuit 36, and transmits the data to the portable communication terminal 30 through the connection jack 40C and the portable communication terminal connection device 100A. Accordingly, the short message data inputted through the operation panel 42 is displayed on the LCD panel of the portable communication terminal 30. When the user operates the message transmission function added to the portable communication terminal 30, the short message inputted to the keyboard device 40 is transmitted to a short message receiver designated by the portable communication terminal 30.

The operation when the keyboard device having the portable communication terminal connection structure is connected to the computer system will now be explained in accordance with the thirty-first to thirty-third embodiments of the present invention.

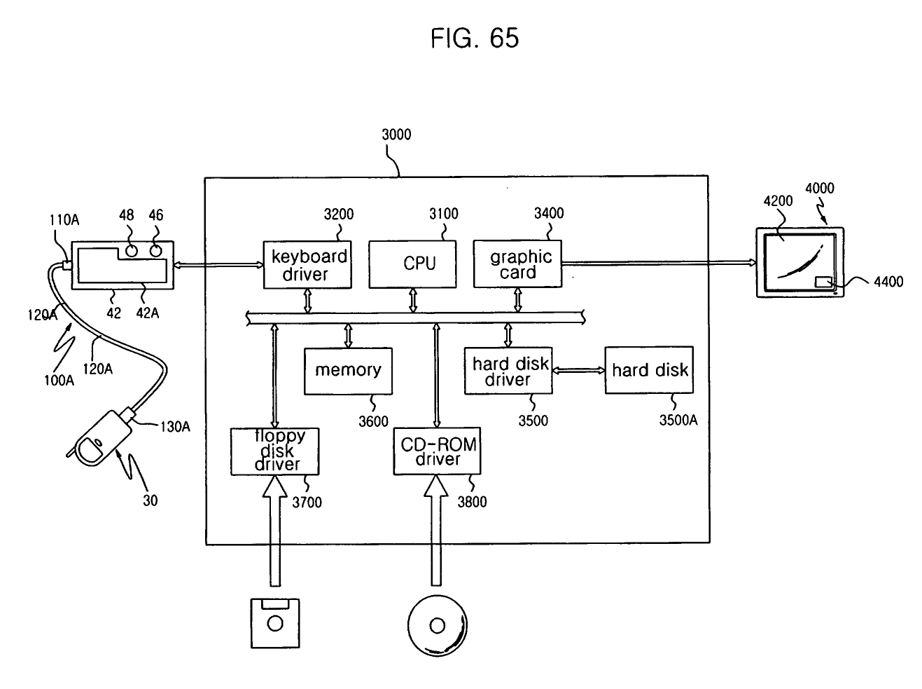

FIG. 65 is a view illustrating an operation relation in a state where the keyboard device having the portable communication terminal connection structure is connected to the portable communication terminal and the computer system in accordance with the present invention.

In order to supply the power to the portable communication terminal 30 by the keyboard device 40 and to display the short message inputted from the operation panel in the short message mode of the keyboard device 40 on the display device 4000 by the computer system 3000, a software composing a screen of the short message data signal between the computer system 3000 and the keyboard device 40 is required.

When the user purchases the device of the invention, the software recorded on a portable recording medium, for example a floppy disk (FD) or compact disk (CD) is provided to the user. In addition, the user can upgrade the software by accessing an internet homepage of the provider, and downloading the update program.

The user inserts the portable recording medium (CD or FD) storing the keyboard drive software into the FD driver 3700 or CD-ROM driver 3800 of the computer system 3000, and installs the keyboard drive program.

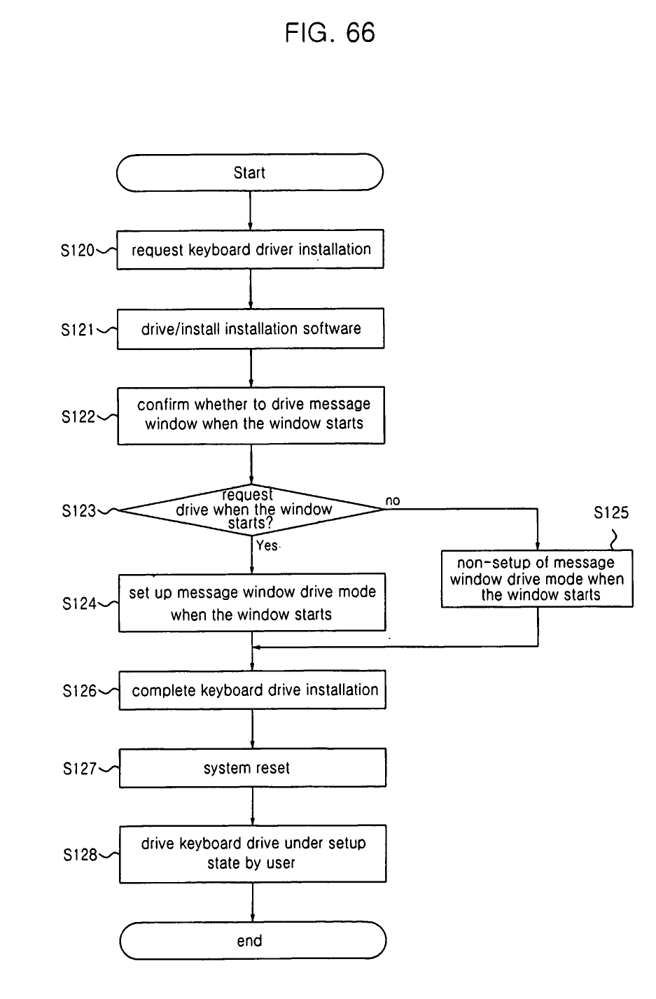

One example of the installation operation will now be explained with reference to FIG. 66.

When the portable recording medium (CD or FD) storing the keyboard drive program is inserted into the FD driver 3700 or CD-ROM driver 3800 of the computer system 3000, the CPU 3100 controls the graphic card 3400 so that an initial screen for installation of the keyboard drive program can be automatically displayed on the screen 4200 of the display device 4000 by the window program mounted on the computer system 3000.

Thereafter, when the user selects an installation menu of the initial screen by using the keyboard device 40 or mouse device (S120), the CPU 3100 recognizes input of the keyboard device or mouse device, controls the driver device 3700 or 3800 which the recording medium FD or CD storing the keyboard drive program is inserted into to drive a corresponding installation software, and simultaneously controls a hard disk driver 3500 to store the drive program recorded on the recording medium FD or CD in an empty storage region of a hard disk 3500A (S121).

The CPU 3100 controls the graphic card 3400 to display a screen for enabling the user to select whether to drive a message window when the window starts on the screen 4200 of the display device 4000 by the corresponding installation software.

The CPU 3100 confirms input contents which the user selects by the keyboard device or mouse device (S122-S123).

When the CPU 3100 confirms that the user selects to drive the message window at the time of starting the window, the CPU 3100 renews information of the start program (for example, autoexec.bat and config.sys files) of the corresponding computer system by the corresponding installation software, and sets up to drive the message window when the computer system starts to be driven (S124). Conversely, when the user selects not to drive the message window at the time of starting the window, the CPU 3100 recognizes the input and goes to the next step without changing the information of the start program (S125).

When installation of the keyboard drive program is finished, the CPU 3100 controls the graphic card 3400 to display a message screen for displaying completion of the installation and re-driving the system on the screen 4100 of the display device 4000 by the installation software (S126).

Thereafter, when the user demands to newly start the computer system, the CPU 3100 finishes the computer system, resets the computer system and drives the window (S127).

The keyboard drive program is driven under the conditions set up by the user in S124 or S125 (S128).

That is, if information of the start program of the computer system is renewed in S124, when the computer system starts according to the information of the start program (for example, autoexec.bat and config.sys files), the message window is driven to be displayed in an icon shape at a predetermined region of the operation display line on the screen 4200 of the display device 4000.

The operation when the user connects the keyboard device of the invention to the portable communication terminal 30 and the computer system 3000 in a state where the keyboard drive program is installed by the operation of FIG. 66 will now be explained with reference to FIGS. 57, 58, 65 and 67.

Firstly, when the user does not operate the short message mode key 48 of the keyboard device 40 to set up the general mode, if the key input is generated from the operation panel 42, the control circuit 36 transmits the key scan data corresponding to the key input to the computer system 3000 through the key scan data transmission circuit 39 (S130-S131).

Therefore, the CPU 3100 of the computer system 3000 recognizes the key scan data, and controls the graphic card 3400 to display the data on the screen 4200 of the display device 4000 (S132, S133).

On the other hand, when the user operates the short message mode key 48 of the keyboard device 40 to set up the short message processing mode, the control circuit 36 transmits the setup state of the short message processing mode to the computer system 3000 through the key scan data transmission circuit 39 (S134).

The CPU 3100 of the computer system 3000 recognizes the operation, and controls the graphic card 3400 to display the short message window 4400 on the screen 4200 of the display device 4000 (S134A, S135).

When the key input is generated from the operation panel 42 of the keyboard device 40, the control circuit 36 transmits the key scan data corresponding to the key input to the computer system 3000 through the key scan data transmission circuit 39 (S136).

Accordingly, the CPU 3100 of the computer system 3000 recognizes the key scan data, and controls the graphic card 3400 to display the data on the short message window 4400 of the screen 4200 of the display device 4000 (S137, S138).

At the same time, the control circuit 36 stores the key scan data corresponding to the key input of the operation panel 42 in the memory 37 (S139).

When the user operates the short message transmission key 46 of the keyboard device 40 to set up the short message transmission mode, the control circuit 36 transmits the setup state of the short message transmission mode to the computer system 3000 through the key scan transmission circuit 39 (S140).

The CPU 3100 of the computer system 3000 recognizes the operation, and controls the graphic card 3400 to display setup of the short message transmission mode on the short message window 4400 of the screen 4200 of the display device 4000 (S141, S142).

At the same time, in order to set up a communication mode for the portable communication terminal 30, the control circuit 36 transmits a short message data transmission authentication request message to the portable communication terminal 30 through the data conversion processing circuit 36, the connection jack 40C and the portable communication terminal connection device 100A (S143).

The portable communication terminal 30 receiving the short message data transmission authentication request message sets up the communication mode for the keyboard device 40, and transmits a short message transmission request authentication message to the keyboard device 40 (S144).

Thereafter, when the control circuit 36 of the keyboard device 40 receives the short message data transmission request authentication message from the portable communication terminal 30 through the data conversion processing circuit 36, the control circuit 36 reads the short message data stored in the memory 37, and transmits the data to the portable communication terminal 30 through the data conversion processing circuit 36, the connection jack 40C and the portable communication terminal connection device 100A (S145).

The portable communication terminal 30 receiving the short message data transmits a message reception confirmation message to the keyboard device 40 (S146, S147).

The control circuit 36 of the keyboard device 40 which receives the message reception confirmation message transmits the contents to the computer system 3000 through the key scan data transmission circuit 39 (S148).

Thus, the CPU 3100 of the computer system 3000 recognizes the operation, and controls the graphic card 3400 to display setup of the short message transmission mode on the short message window 4400 of the screen 4200 of the display device 4000 (S149, S150).

When the user operates the message transmission function added to the portable communication terminal 30 to input the receiver phone number and set up the transmission mode, the short message inputted to the keyboard device 40 is transmitted to the designated short message receiver (S151).

The desktop computer where the keyboard device is separated from the computer system is exemplified in the thirty-first to thirty-third embodiments of the present invention. However, the invention can also be applied to the keyboard structure of the notebook computer where the keyboard device and the computer system are incorporated.

In addition, the portable communication terminal connection device is separated from the keyboard device in the thirty-first to thirty-third embodiments of the present invention. However, the connection device and the keyboard device can also be incorporated.

The structure for charging the portable communication terminal and transmitting the short message is explained in the thirty-first to thirty-third embodiments of the present invention. However, the invention includes the keyboard device having the structure for supplying the operation power to the portable audio reproducing device (MP3 player, portable compact disk player and portable cassette tape player) and the speaker as well as the portable communication terminal.

In regard to the short message transmission function, the keyboard is connected to the power supply and data repeater device 1000, so that the short message data inputted from the keyboard can be directly transmitted through the portable communication terminal 30.

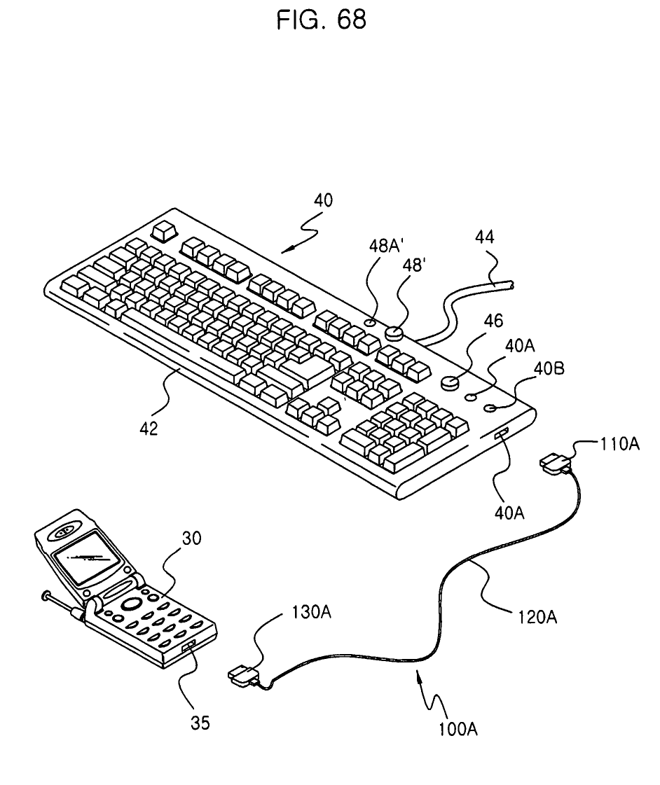

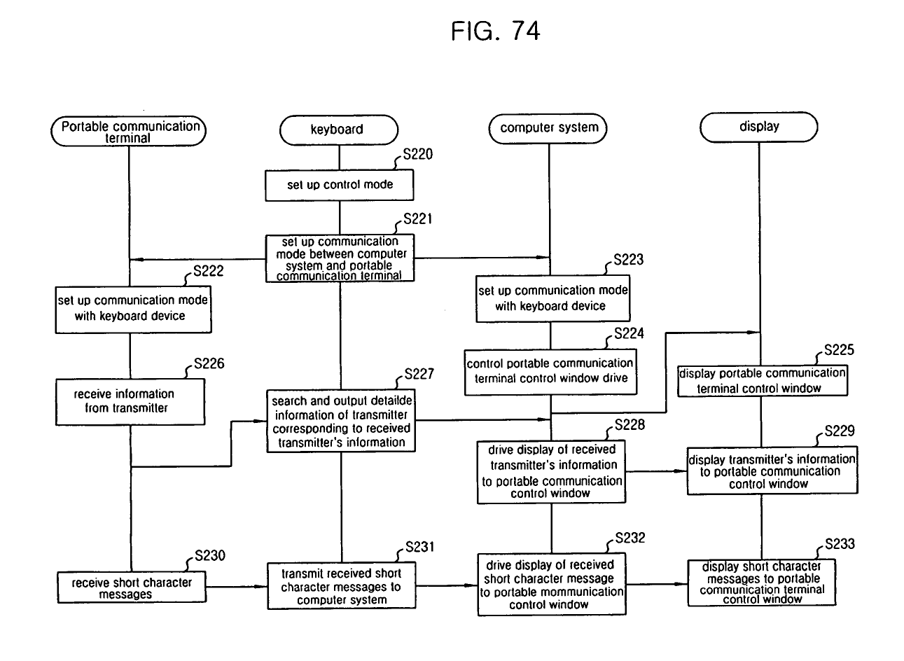

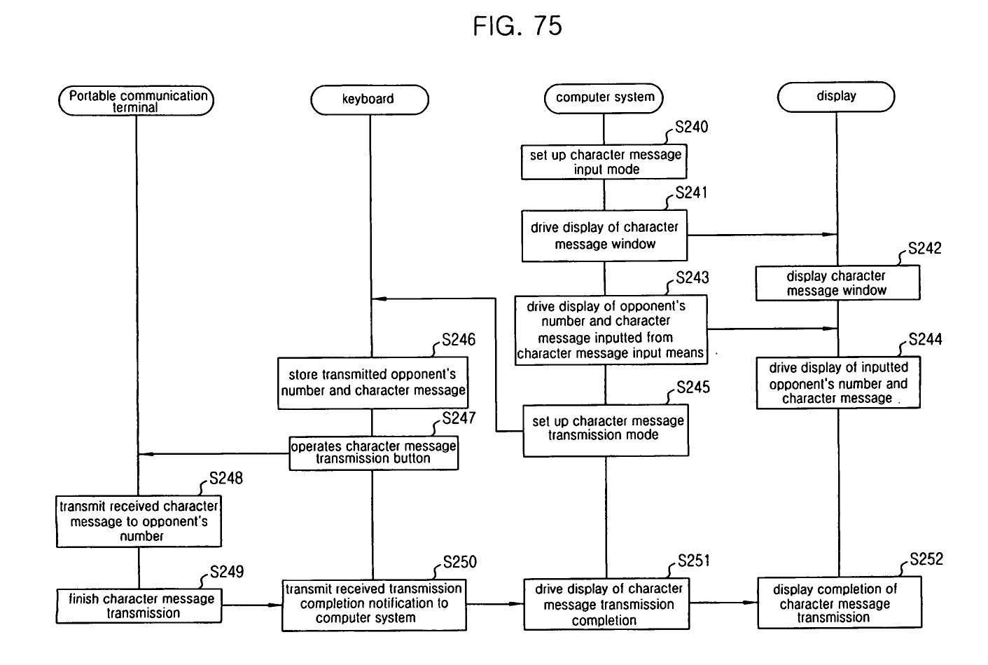

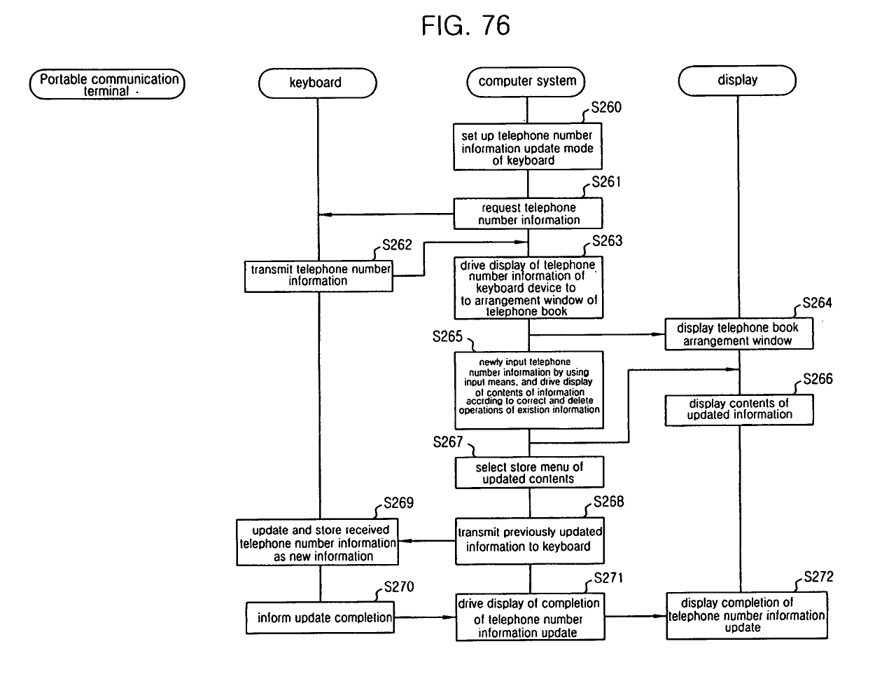

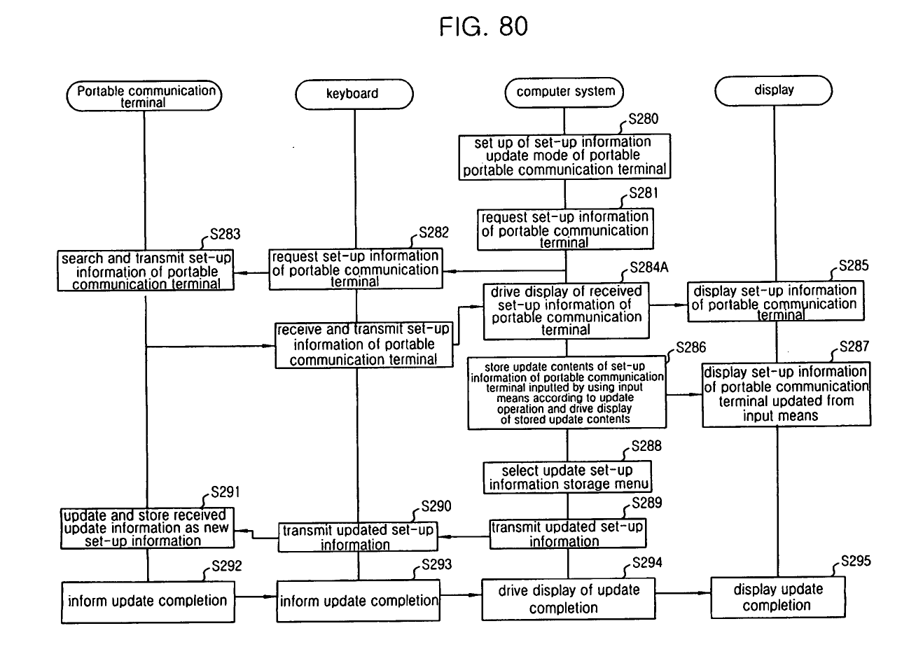

The keyboard device having the portable communication terminal control function in accordance with the thirty-fourth to thirty-fifth embodiments of the present invention will now be explained in detail with reference to FIGS. 68 to 77.

FIG. 68 is a schematic external view illustrating the keyboard device having the portable communication terminal control function in accordance with the thirty-fourth embodiment of the present invention.

As compared with the thirty-first embodiment of FIG. 57, a portable communication terminal control mode key 48′ for setting up the portable communication terminal control mode is installed on the operation panel 42, and a mode display device 48A′ composed of for example, an LED device for displaying the portable communication terminal control mode set up by the portable communication terminal control mode key 48 is also installed on the operation panel 42.

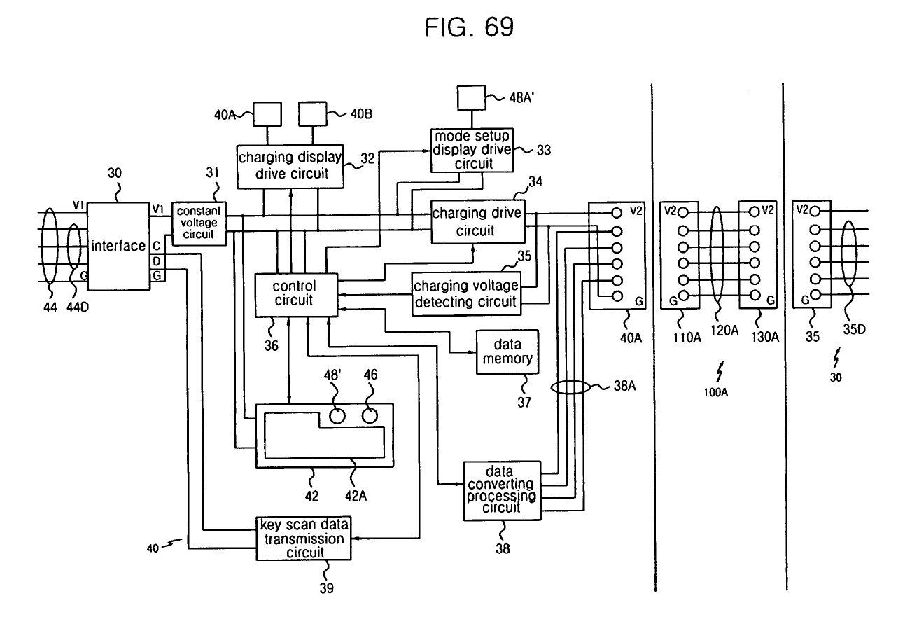

FIG. 69 is a block view illustrating an internal circuit of the keyboard device having the portable communication terminal control function of FIG. 68 in accordance with the thirty-fourth embodiment of the present invention.

As illustrated in FIG. 69, the keyboard device 40 includes: an interface 30; a constant voltage circuit 31; a charging drive circuit 34; a charging voltage detecting circuit 34A; a charging display drive circuit 32; charging display devices 40A and 40B; a mode setup display drive circuit 33; a mode display device 48A′; an operation panel 42 including a plurality of keys (character keys, number keys and function keys), a portable communication terminal control mode key 48′ and a short message transmission key 46; a key scan data transmission circuit 39; a data conversion processing circuit 38; a memory 37, a connection jack 40C and a control circuit 36.

The keyboard device 40 has the same structure to the keyboard device of the thirty-first embodiment of FIG. 58, except for the portable communication terminal control mode key 48′, the mode display device 48A′, the control circuit 36 and the memory 37.

The control circuit 36 generates key scan data corresponding to the operation of the character keys, number keys and function keys on the operation panel 42, transmits the data to the computer system through the key scan data transmission circuit 39, the interface 30 and the computer system connection cable 44, sets up the portable communication terminal control mode of the keyboard device 40 in the operation of the portable communication terminal control mode key 48′, controls the mode setup display drive circuit 33 to turn on the mode display device 48A, performs the control operation explained in the FIGS. 52 to 56 in the portable communication terminal control mode, and performs the control operation for transmitting the short message processed by the computer system in the short message transmission mode to the portable communication terminal 30 through the data conversion processing circuit 38, the connection jack 40A and the portable communication terminal connection device 100A.

The key scan data transmission circuit 39 for outputting the key scan data corresponding to the key operation on the operation panel 42 in the general keyboard mode through the interface 30 and the computer system connection cable 44 is connected to the control circuit 36.

The data conversion processing circuit 38 for converting the short message data transmitted from the computer system in the short message transmission mode to have a data format recognizable by the portable communication terminal 30, and transmitting the data to the portable communication terminal 30 through the connection jack 40C and the portable communication terminal connection device 100A is installed in the control circuit 36.

The portable communication terminal control mode key 48′ is operated to control the short message transmission to the portable communication terminal 30, the setup information of the portable communication terminal (for example, phone number registration/correction/deletion, data movement to new portable communication terminal, bell sound/vibration/loudness, schedule management, alarm setup, etc.), generation of the visual display control signal of the caller information transmitted to the portable communication terminal 30, and the detailed information providing function of the caller information.

In addition, the memory 37 for temporarily storing the short message data inputted from the operation panel 42, the short message data and caller information transmitted from the portable communication terminal 30, and the phone number data registered in the portable communication terminal 30 in the portable communication terminal control mode, or storing the detailed phone number information (name, phone number, home phone number, office phone number, fax number, portable communication terminal phone number, etc.) inputted by the user is connected to the control circuit 36.

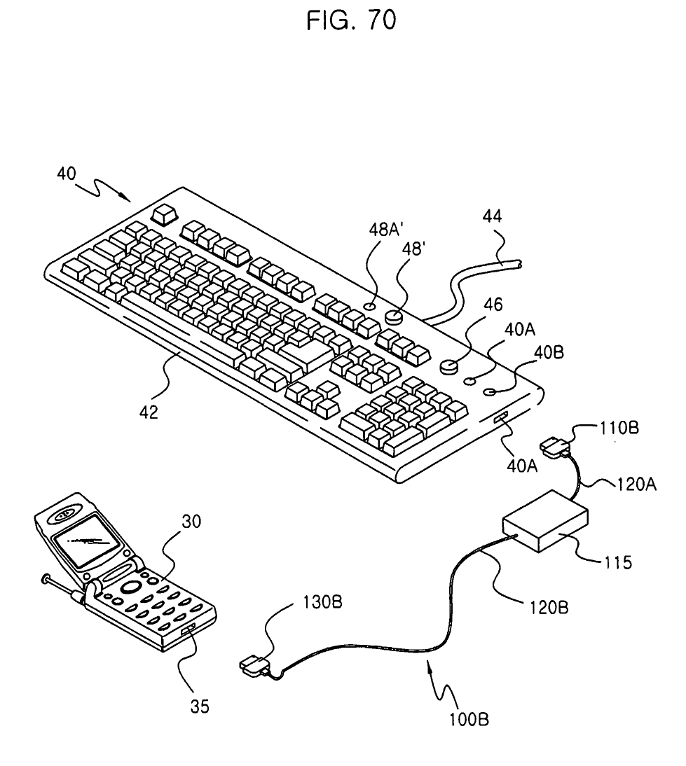

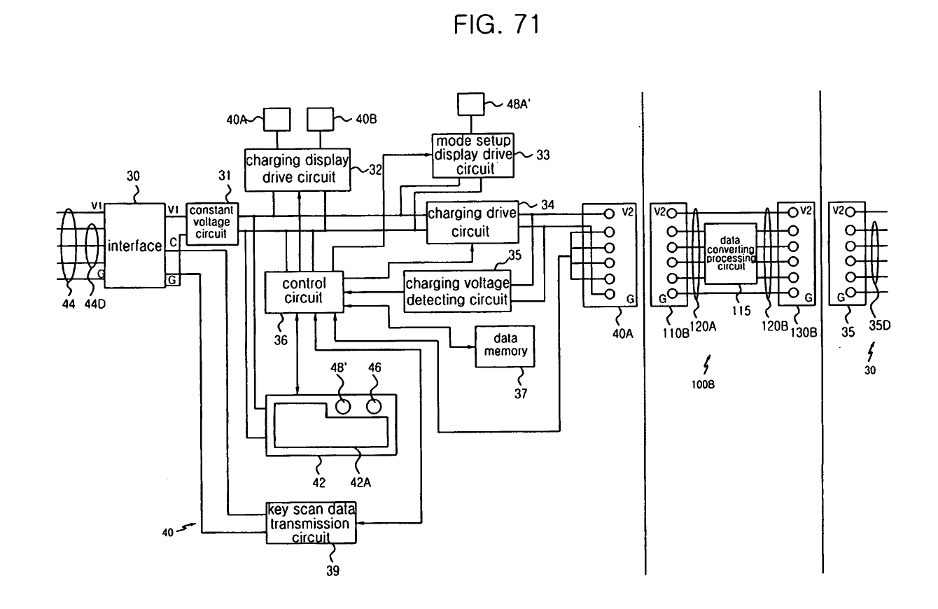

FIG. 70 is a schematic external view illustrating the keyboard device having the portable communication terminal control function in accordance with the thirty-fifth embodiment of the present invention, and FIG. 71 is a block diagram illustrating an internal circuit of the keyboard device having the portable communication terminal control function of FIG. 69 in accordance with the present invention.

The keyboard device of the thirty-fifth embodiment has the same structure as the keyboard device of the thirty-fourth embodiment, except that a data conversion processing circuit 115 is installed in a portable communication terminal connection device 100B.

The data conversion processing circuit 115 uses different programs according to kinds of portable communication terminals. Since the data conversion processing circuit 115 is installed in the portable communication terminal connection device 100B, the keyboard device 40 obtains compatibility to all kinds of portable communication terminals 30 by changing the portable communication terminal connection device 100B according to the kind of the portable communication terminal 30.

The operation when the keyboard device having the portable communication terminal control function is connected to the computer system will now be explained.

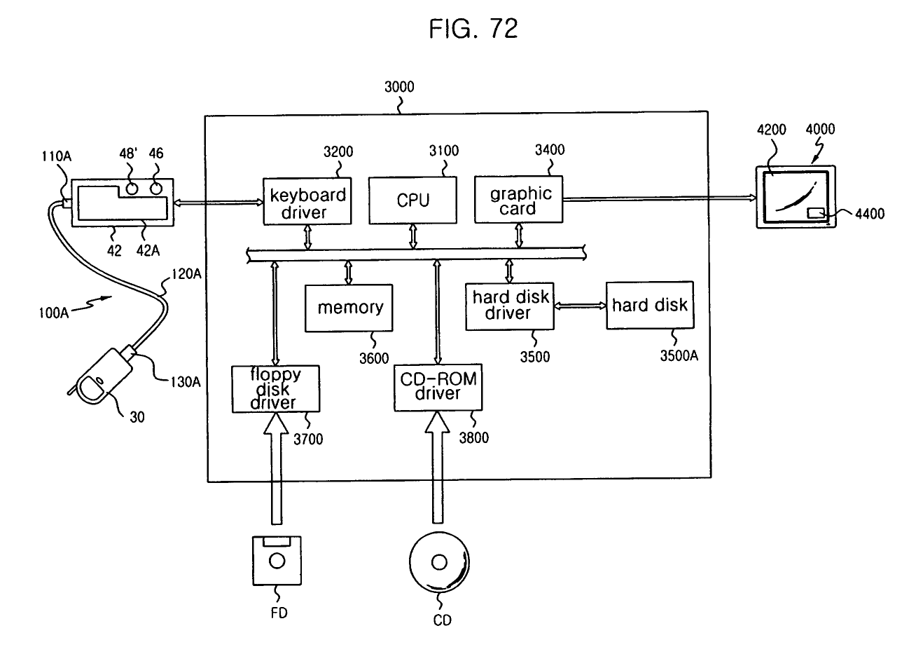

FIG. 72 is a view illustrating an operation relation in a state where the keyboard device having the portable communication terminal control function is connected to the portable communication terminal and the computer system in accordance with the present invention.

In accordance with the present invention, a software for interface compatibility of control signals and data signals among the computer system 3000, the keyboard device of the invention and the portable communication terminal 30 and a software for composing an interface screen between the computer system 3000 and the keyboard device are required to supply the power to the portable communication terminal 30, and embody various functions such as a function of displaying the short message received by the portable communication terminal 30 through the short message service on the display device 4000 by using the computer system 3000, a function of displaying the caller information received by the portable communication terminal 30 on the display device 4000 by using the computer system 3000, a function of transmitting the short message through the short message service of the portable communication terminal 30 by using the input device of the computer system 3000, and a function of setting up the function mode of the portable communication terminal 30 by using the computer system 3000.

When the user purchases the device of the invention, the software recorded on a portable recording medium, for example a floppy disk (FD) or compact disk (CD) is provided to the user. In addition, the user can upgrade the software by accessing an internet homepage of the provider, and downloading the update program.

The user inserts the portable recording medium (CD or FD) storing the portable communication terminal control driving drive program into the FD driver 3700 or CD-ROM driver 3800 of the computer system 3000, and installs the keyboard drive program.

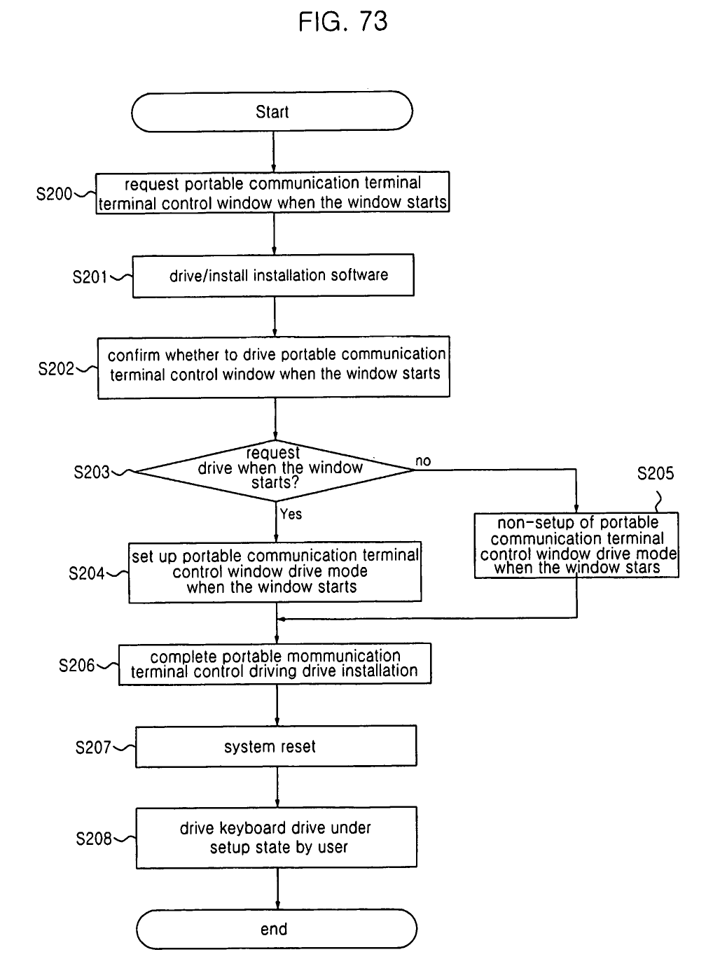

One example of the installation process will now be explained with reference to FIG. 73.

When the portable recording medium (CD or FD) storing the portable communication terminal control driving drive program is inserted into the FD driver 3700 or CD-ROM driver 3800 of the computer system 3000, the CPU 3100 controls the graphic card 3400 so that an initial screen for installation of the portable communication terminal control driving drive program shown in FIG. 49(a) can be automatically displayed on the screen 4200 of the display device 4000 by the window program mounted on the computer system 3000.

Thereafter, when the user selects an installation menu of the initial screen of FIG. 49(a) by using the keyboard device 40 or mouse device 80 (S200), the CPU 3100 recognizes input of the keyboard device or mouse device, controls the driver device 3700 or 3800 which the recording medium FD or CD storing the portable communication terminal control driving drive program is inserted into to drive a corresponding installation software, and simultaneously controls a hard disk driver 3500 to store the drive program recorded on the recording medium FD or CD in an empty storage region of a hard disk 3500A (S201).

As shown in FIG. 49(b), the CPU 3100 controls the graphic card 3400 to display a screen for enabling the user to select whether to drive a portable communication terminal control window when the window starts on the screen 4200 of the display device 4000 by the corresponding installation software.

When the user inputs ‘Yes’ or ‘No’ to the screen of FIG. 49(b) by using the keyboard device or mouse device, the CPU 3100 confirms the input (S202-S203).

When the CPU 3100 confirms that the user selects ‘Yes’, the CPU 3100 renews information of a start program (for example, autoexec.bat and config.sys files) of the corresponding computer system by the corresponding installation software, and sets up to drive the portable communication terminal control window when the computer system starts to be driven (S204). Conversely, when the user selects ‘No’, the CPU 3100 recognizes the input and goes to the next step without changing the information of the start program (S205).

When installation of the portable communication terminal control driving drive program is finished, the CPU 3100 controls the graphic card 3400 to display a message screen for displaying completion of the installation and re-driving the system on the screen 4100 of the display device 4000 by the installation software (S206).

Thereafter, when the user demands to newly start the computer system, the CPU 3100 finishes the computer system, resets the computer system and drives the window (S207).

The portable communication terminal control driving drive program is driven under the conditions set up by the user in the steps of S204 or S205 (S208).

That is, if information of the start program of the computer system is renewed in the step of S204, when the computer system starts according to the information of the start program (for example, autoexec.bat and config.sys files), the portable communication terminal window is driven to be displayed in an icon shape 4220 at a predetermined region of an operation display line 4210 on the screen 4200 of the display device 4000 having a plurality of background screen icons and the operation display line 4210, as shown in FIG. 49(c).

The operation when the user connects the keyboard device 40 of the invention to the portable communication terminal 30 and the computer system 3000 and operates the portable communication terminal control mode key 48′ in a state where the portable communication terminal control driving drive program is installed by the operation of FIG. 73 will now be explained with reference to FIGS. 68, 69, 72 and 74.

When the user operates the portable communication terminal control mode key 48′ of the keyboard device 40, the control circuit 36 recognizes the operation, and drives the mode setup display drive circuit 33 so that the mode setup display device 48A′ can emit light (S220).

The control circuit 36 sets up the communication mode for the portable communication terminal, transmits a communication mode setup request to the portable communication terminal 30 through the data conversion processing circuit 38, sets up a communication mode for the computer system 3000, and transmits a communication mode setup request to the computer system 3000 through the key scan data transmission circuit 39 at the same time (S221).

The portable communication terminal 30 receiving the communication mode setup request sets up a communication mode for the keyboard device 40 (S222).

The CPU 3100 of the computer system 3000 which receives the communication mode setup request through for example, the keyboard driver 3200 sets up the communication mode for the keyboard device 40 (S223), and drives the portable communication terminal control window.

Here, when the portable communication terminal control driving drive program is not driven at the time of starting the computer system 3000, the CPU 3100 controls the hard disk driver 3500 to drive the portable communication terminal control driving drive program previously installed and stored in a predetermined region of the hard disk 3500A, and also controls the graphic card 3400 to display the portable communication terminal control window 4400 on a predetermined region of the screen 4200 of the display device 4000.

Conversely, when the portable communication terminal control driving drive program is driven at the time of starting the computer system 3000 and when the portable communication terminal control window is displayed in an icon shape 4220 at a predetermined region of the operation display line 4210 of the screen 4200 of the display device 4000 as shown in FIG. 49(c), the CPU 3100 drives the portable communication terminal control window display program of the memory 3600, and controls the graphic card 3400 to display the portable communication terminal control window 4400 on a predetermined region of the screen 4200 of the display device 4000 (S224-S225).

When the portable communication terminal control window 4400 is displayed, if the portable communication terminal 30 receives caller information (Caller ID; i.e., caller phone number), the portable communication terminal 30 transmits the caller information to the keyboard device 40 (S226).

That is, the caller information is transmitted to the data conversion processing circuit 38 through the data line 35D, the power/data I/O jack 35, the portable communication terminal connection device 1000A and the connection jack 40A. The data conversion processing circuit 38 transmits the caller information data converted to have a data format suitable for the computer system 3000 to the control circuit 36.

The control circuit 36 searches the data memory 37. When a phone number identical to the caller phone number of the caller information exists in the memory 37, the control circuit 36 reads detailed information data of the caller (for example, name, firm name, fax number, etc.) corresponding to the phone number, and transmits the data to the computer system 3000 through the key scan data transmission circuit 39 (S227).

The CPU 3100 of the computer system 3000 drives the graphic card 3400 to display the detailed information data of the caller received from the keyboard device 40 through for example, the keyboard driver 3200 on the portable communication terminal control window (S228).

Accordingly, the caller information and the detailed information thereof are displayed on the portable communication terminal control window 4400 of the display device screen 4200 (S229).

In the case that the control circuit 36 of the keyboard device 40 fails to find the detailed caller information corresponding to the caller information in the step of S227, the control circuit 36 outputs the caller information from the portable communication terminal 30 to the computer system 3000. The computer system 3000 displays the caller information on the portable communication terminal control window of the display device 4000.

On the other hand, when the portable communication terminal 30 receives a short message, it transmits the short message to the keyboard device 40 (S230).

That is, the short message is transmitted to the data conversion processing circuit 38 through the data line 35D, the power/data I/O jack 35, the portable communication terminal connection device 100A and the connection jack 40A. The data conversion processing circuit 38 transmits the short message converted to have a data format suitable for the computer system 3000 to the control circuit 36.

The control circuit 36 transmits the short message to the computer system 3000 through the key scan data transmission circuit 39 (S231).

Thereafter, the CPU 3100 of the computer system 3000 drives the graphic card 3400 to display the short message received from the keyboard device 40 through for example, the keyboard driver 3200 on the portable communication terminal control window (S232).

Therefore, the short message is displayed on the portable communication terminal control window 4400 of the display device screen 4200 (S233).

The operation of transmitting the short message by using the computer system 3000 when the user connects the keyboard device 40 to the portable communication terminal 30 and the computer system 3000 in a state where the portable communication terminal control driving drive program is installed by the operation of FIG. 73 will now be described with reference to FIGS. 68, 69, 72 and 75.

When the user sets up the short message input mode by selecting a short message menu M1 of the portable communication terminal control window 4400 of FIG. 52(a) by using the keyboard or mouse as the input device (S240), the CPU 3100 of the computer system 3000 recognizes the input and controls the graphic card 3400 to display the short message window (S241).

Accordingly, the short message window 4450 is displayed on the display device screen 4200 as shown in FIG. 52(b) (S242).

Thereafter, when the user inputs a receiver phone number to a receiver phone number input window 4450A by using the short message input unit such as the keyboard and also inputs a short message to a short message input window 4450B, the CPU 3100 controls the graphic card 3400 to display the receiver phone number and the short message on the short message window 4450 (S243-S244).

Here, the inputted receiver phone number and short message are temporarily stored in the memory 3600.

The short message may be inputted through the operation panel 42 of the keyboard device 40 or the keyboard of the notebook computer.

When the user sets up a short message transmission mode by selecting a short message transmission menu 4450C by using the keyboard or mouse as the input device, the CPU 3100 recognizes the operation, reads the receiver phone number and short message temporarily stored in the memory 3600, and transmits them to the keyboard device 40 through for example, the keyboard driver 3200 (S245).

Here, the transmitted data contains a header for displaying that the data is the short message transmission data.

The control circuit 36 of the keyboard device 40 receiving the short message transmission data through the data transmission/reception circuit 230G recognizes the short message transmission data by analyzing the header of the data, and temporarily stores the data in the memory 37 (S246).

When the user operates the short message transmission key 46, the control circuit 36 recognizes the operation, and transmits the short message transmission data to the portable communication terminal 30 through the data conversion processing circuit 38 (S247).

Here, the inputted short message transmission data can be transmitted directly to the portable communication terminal 30, without operating the short message transmission key 46 in the steps of S246 and S247.

The portable communication terminal 30 receives the short message transmission data, recognizes the short message by analyzing the header of the data, separates the receiver phone number and the short message, and transmits the short message to the receiver phone number (S248).

Then, the portable communication terminal 30 notifies completion of the short message transmission to the keyboard device 40 (S249).

The control circuit 36 of the keyboard device 40 which is informed of completion of the short message transmission by the data conversion processing circuit 38 notifies completion of the short message transmission to the computer system 3000 through the key scan data transmission circuit 39 (S250).

The CPU 3100 of the computer system 3000 informed of completion of the short message transmission by for example, the keyboard driver 3200 controls the graphic card 3400 to display completion of the short message transmission on the short message window 4450 of the display device 4000 of FIG. 52(b) (S251-S252).

The operation of renewing a telephone directory of the keyboard device 40 by using the computer system 3000 when the user connects the keyboard device 40 to the portable communication terminal 30 and the computer system 3000 in a state where the portable communication terminal control driving drive program is installed by the operation of FIG. 73 will now be explained with reference to FIGS. 68, 69, 76 and 54.

In order to renew telephone directory information stored in the keyboard device 40, when the user sets up a telephone directory renewal mode by selecting a telephone directory sorting menu M2 of the portable communication terminal control window 4400 of FIG. 52(a) by using the keyboard or mouse as the input device (S260), the CPU 3100 of the computer system 3000 recognizes the operation, and outputs a message of requesting previously-stored phone number information to the keyboard device 40 through for example, the keyboard driver 3200 (S261).

The control circuit 36 of the keyboard device 40 receiving the phone number information transmission request message through the key scan data transmission circuit 39 reads the phone number information from the memory 37 and transmits the information to the computer system 3000 through the key scan data transmission circuit 39 (S262).

The CPU 3100 of the computer system 3000 receiving the phone number information from the keyboard device 40 through for example, the keyboard driver 3200 controls the graphic card 3400 to display the phone number information on the telephone directory sorting window 4460 as shown in FIG. 54 (S263-S264).

Thereafter, when the user corrects or deletes a phone number list displayed on the telephone directory sorting window 4460, or inputs a new phone number list by using the input unit such as the keyboard, the CPU 3100 controls the graphic card 3400 to display the corrected, deleted or newly-inputted phone number list on the telephone directory sorting window 4460 (S265-S266).

Here, the corrected, deleted or newly-inputted phone number information is temporarily stored in the memory 3600. In addition, the correction, deletion and addition of the phone number list may be performed by the operation panel 42 of the keyboard device 40 or the keyboard of the notebook computer.

When the user renews the phone number information and sets up a renewed phone number information storage mode by selecting a telephone directory storage menu 4460A by using the keyboard or mouse as the input device (S267), the CPU 3100 recognizes the operation, reads the phone number information temporarily stored in the memory 3600, and transmits the information to the keyboard device 40 through for example, the keyboard driver 3200 (S268).

Here, the transmitted data contains a header for displaying that the data is the phone number information renewal data.

The control circuit 36 of the keyboard device 40 receiving the phone number information renewal data through the key scan data transmission circuit 39 recognizes the phone number information renewal data by analyzing the header of the data, and renews the phone number information stored in the data memory 37 (S269).

The control circuit 36 of the keyboard device 40 transmits a message of displaying completion of the phone number information renewal to the computer system 3000 through the key scan data transmission circuit 39 (S270).

The CPU 3100 of the computer system 3000 receiving the phone number information renewal completion message through for example, the keyboard driver 3200 controls the graphic card 3400 to display the phone number information renewal completion message on the telephone directory sorting window 4460 of the display device (S271-S272).

The operation of renewing setup control information of the portable communication terminal 30 by using the computer system 3000 when the user connects the keyboard device 40 to the portable communication terminal 30 and the computer system 3000 in a state where the portable communication terminal control driving drive program is installed by the operation of FIG. 73 will now be explained with reference to FIGS. 68, 69, 72, 77 and 56.

In order to renew the setup control information of the portable communication terminal 30, when the user sets up a portable communication terminal setup information renewal mode by selecting a portable communication terminal control menu M3 of the portable communication terminal control window 4400 of FIG. 52(a) by using the keyboard or mouse as the input device (S280), the CPU 3100 of the computer system 3000 recognizes the operation, and outputs a portable communication terminal setup information request message to the keyboard device 40 through for example, the keyboard driver 3200 (S281).

Here, a header of the message contains information displaying that the message is the portable communication terminal setup information request message.

The control circuit 36 of the keyboard device 40 receiving the portable communication terminal setup information request message through the key scan data transmission circuit 39 recognizes the message and transmits it to the portable communication terminal 30 through the data conversion processing circuit 38.

The portable communication terminal 30 receiving the portable communication terminal setup information request message recognizes the message, reads previously-determined setup information from the memory, and transmits the portable communication terminal setup information message having the setup information and header to the keyboard device 40 (S283).

Here, the header contains information displaying that the message is the portable communication terminal setup information message.

The control circuit 36 of the keyboard device 40 receiving the portable communication terminal setup information message through the data conversion processing circuit 38 recognizes the portable communication terminal setup information message and transmits the message to the computer system 3000 through the key scan data transmission circuit 39 (S284).

The CPU 3100 of the computer system 3000 receiving the portable communication terminal setup information message from the keyboard device 40 through for example, the keyboard driver 3200 temporarily stores the message in the memory 3600, and controls the graphic card 3400 to display a portable communication terminal control sub menu SM as shown in FIG. 56(a).

Then, when the user selects for example, a bell sound/vibration/loudness menu, the CPU 3100 reads the portable communication terminal setup information relating to the menu from the memory 3600, and controls the graphic card 3400 to display a bell sound/vibration/loudness setup window BW corresponding to the menu as shown in FIG. 56(b) (S284A, S285).

Here, when the user selects a different sub menu of FIG. 56(a), a setup window corresponding to the sub menu is displayed in the same manner.

When the user intends to change bell sound N of a bell sound setup window BW_1 to a different bell sound in the bell sound/vibration/loudness setup window BW, the user searches a wanted bell sound by moving a scroll bar at the right side of a bell sound selection window BW_2 by using the input unit such as the mouse and clicks the bell sound, to set up the bell sound in the bell sound setup window BW1. In addition, when the user wants to change bell of a bell selection window BW3 to vibration, the user clicks a vibration selection window BW4 to select vibration. In the case that the user intends to change level N of a bell loudness setup window BW_5 into a different level, the user searches a wanted level by moving the scroll bar at the right side of a level selection window BW_6 by using the input unit such as the mouse and clicks the level, to set up the bell sound level in the bell loudness setup window BW5.

When the user sets up the bell sound, vibration and loudness on the bell sound/vibration/loudness setup window BW and clicks a confirmation menu BW7 through the mouse, the CPU 3100 recognizes the operation and stores the setup contents in the memory 3600 (S286-S288). In the same manner, the user can select a different sub menu of FIG. 56(a) and renews the setup contents. For brief explanations, drawings and explanations thereof are omitted.

When the user renews the setup contents of the portable communication terminal, and selects a storage menu SM-n which is the last item of the sub menu of FIG. 56(a) by using for example, the mouse (S289), the CPU 3100 recognizes the operation, reads the setup information of the portable communication terminal renewed and stored in the memory 3600, generates a portable communication terminal setup renewal information message by adding the header to the information, and transmits the message to the keyboard device 40 through for example, the keyboard driver 3200 (S289).

Here, the header of the message includes information displaying that the message is the portable communication terminal setup renewal information.

The control circuit 36 of the keyboard device 40 which receives the portable communication terminal setup renewal information message through the key scan data transmission circuit 39 recognizes the portable communication terminal setup renewal information by analyzing the header of the message, and transmits the message to the portable communication terminal 30 through the data conversion processing circuit 38 (S290).

The portable communication terminal 30 receiving the portable communication terminal setup renewal information message recognizes the setup renewal information by analyzing the header of the message, and stores the renewal information in the memory as new setup information (S291).

Thereafter, the portable communication terminal 30 notifies completion of the setup information renewal to the keyboard device 40 (S292).

The control circuit 36 of the keyboard device 40 informed of completion of the renewal through the data conversion processing circuit 38 notifies it to the computer system 3000 through the key scan data transmission circuit 39 (S293).

The CPU 3100 of the computer system 3000 informed of completion of the renewal by for example, the keyboard driver 3200 controls the graphic card 3400 to display completion of the renewal of the portable communication terminal setup information on a window 4440 of the display device 4000 as shown in FIG. 56(a) (S294-S295).

On the other hand, the above-described embodiments of the invention are not intended for limiting. For example, at least one or more receiver phone numbers can be inputted from the keyboard device 40 in the short message mode (namely, simultaneous transmission). When the transmission mode is set up, the phone numbers are transmitted to the portable communication terminal 30 to connect a call path to the receivers and transmit the short message thereto.

The control circuit stores the caller phone number information transmitted to the portable communication terminal in the data memory, and displays the whole caller phone number information on the window of the monitor when the CPU of the computer main body is activated. In the case that the user selects specific caller phone number information on the window, the control circuit controls the call corresponding to the caller phone number to be made through the portable communication terminal.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

As discussed earlier, in accordance with the present invention, the power supply device supplies the power outputted from the keyboard/mouse connection jack or USB jack of the notebook or desktop computer system as the operation power or the battery charging power of the power load terminal including the portable communication terminal, the MP3 player and the speaker, and thus a special charger or power adapter is not required.

Moreover, the power supply and data repeater device for the portable communication terminal supplies the power to the portable communication terminal by using the power of the I/O device of the computer system, confirms the caller information and the short message from the portable communication terminal on the display device of the computer system by building the interface between the computer system and the portable communication terminal, inputs the short message by using the input device of the computer system, transmits the inputted short message through the portable communication terminal, and sets up various modes of the portable communication terminal in the computer system.

In the keyboard device having the portable communication terminal connection structure, the portable communication terminal is connected to the keyboard device to execute the short message function, which simplifies the short message input process by the portable communication terminal. In addition, the function of charging the portable communication terminal is provided to prevent call interruption due to battery discharge of the portable communication terminal.

Furthermore, the keyboard device having the portable communication terminal control function charges the portable communication terminal by the key scan power, manages the mode setup items of the portable communication terminal, and registers, corrects or deletes the data, which makes it easier to process the data in the portable communication terminal.

In addition, the caller phone number and short message transmitted to the portable communication terminal are displayed on the monitor device in the on state of the computer main body. Therefore, the user can confirm the caller phone number, the detailed information of the caller corresponding to the caller phone number, and the short message without confirming the display panel of the portable communication terminal.

What is claimed is:

1. A power supply device for a power load terminal using a computer input port comprising:
a first connector means connected to a keyboard connection port and a mouse connection port of a computer system, for receiving key scan power; and
at least one second connector means for supplying power from the first connector means to the power load terminal.

2. The power supply device according to claim 1, wherein the power load terminal is selected from a portable communication terminal, portable audio reproducing device and speaker.

3. The power supply device according to claim 1, wherein the portable communication terminal is selected from CDMA and GSM cellular phones, PCS phone and PDA (Personal Digital Assistant), and the portable audio reproducing device is selected from an MP3 player, portable cassette tape player and portable compact disk player.

4. The power supply device according to any one among claims 1 to 3, wherein the device further comprises a cable for transmitting power between the first and second connector means.

5. The power supply device according to any one among claims 1 to 3, wherein the power supply device further comprises a power stabilizing means for stabilizing the key scan power as supply power of the power load terminal between the first and second connector means.

6. The power supply device according to claim 5, wherein the power supply device further comprises: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

7. The power supply device according to claims 5, wherein the second connector means comprises: a power cable device having a first power connection plug, a power cable and a second power connection plug connected to a power supply jack of the power load terminal; and a power jack for supplying the power from the power stabilizing means to the power load terminal through the medium of the power cable, the first power connection plug being connected to the power jack.

8. A power supply and data repeater device for a power load terminal using a peripheral device connection port of a computer comprising:
a first connector means connected to the peripheral device connection port of the computer system;
at least one second connector means for receiving operation power of a peripheral device from the computer system through the first connector means, and supplying the power to the power load terminal; and
a data repeater means for repeating data between the computer system and the peripheral device through the first connector means.

9. A power supply and data repeater device according to claim 8, wherein the data repeater means comprises: a wiring connected to pins of the peripheral device connection port of the computer system through the first connector means; and a peripheral device connection port being identical to the peripheral device connection port of the computer system connected to the wiring.

10. The power supply and data repeater device according to claim 8, wherein the data repeater means comprises: a wiring connected to pins of the peripheral device connection port of the computer system through the first connector means; and a wireless communication means connected to the wiring, for performing wireless communication with a wireless communication type computer peripheral device.

11. The power supply and data repeater device according to claim 8, wherein the power load terminal is selected from a portable communication terminal, portable audio reproducing device and speaker.

12. The power supply and data repeater device according to claim 8, wherein the portable communication terminal is selected from CDMA and GSM cellular phones, PCS phone and PDA, and the portable audio reproducing device is selected from an MP3 player, portable cassette tape player and portable compact disk player.

13. The power supply and data repeater device according to any one among claims 8 to 12, wherein the peripheral device connection port is selected from a keyboard connection port, mouse connection port and USB (Universal Serial Bus) port.

14. The power supply and data repeater device according to any one among claims 8 to 12, wherein the device further comprises a cable for transmitting power between the first and second connector means.

15. The power supply and data repeater device according to any one among claims 8 to 12, wherein the power supply and data repeater device further comprises a power stabilizing means for stabilizing the key scan power as supply power of the power load terminal between the first and second connector means.

16. The power supply and data repeater device according to any one among claims 8 to 12, wherein the power supply and data repeater device further comprises: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

17. The power supply and data repeater device according to any one among claims 8 to 12, wherein the second connector means comprises: a power cable device having a first power connection plug, a power cable and a second power connection plug connected to a power supply jack of the power load terminal; and a power jack connected to the first connector means, for supplying the power to the power load terminal through the medium of the power cable, the first power connection plug being connected to the power jack.

18. The power supply and data repeater device according to claim 15, wherein the second connector means comprises: a power cable device having a first power connection plug, a power cable and a second power connection plug connected to a power supply jack of the power load terminal; and a power jack for supplying the power from the power stabilizing means to the power load terminal through the medium of the power cable, the first power connection plug being connected to the power jack.

19. A power supply and data repeater device for a portable communication terminal using a computer input port comprising:
a first connector means connected to a peripheral device connection port of a computer system; and a power supply/data repeater means for stabilizing power transmitted from the peripheral device connection port of the computer system through the first connector means, supplying the power to the portable communication terminal, and repeating data communication between the computer system and the portable communication terminal through the first connector means.

20. The power supply and data repeater device according to claim 19, wherein the power supply and data repeater means comprises: a power stabilizing means for stabilizing the key scan power as supply power of the portable communication terminal; a charging state detecting means for detecting a charging state of a battery of the portable communication terminal; a charging state display means for displaying the state according to a detection result of the charging state detecting means; a power supply control means for controlling supply of the power stabilized by the power stabilizing means to the power load terminal according to the detection result of the charging state detecting means; a data communication means for performing data communication between the computer system and the portable communication terminal; and a second connector means for transmitting the power from the power supply control means and the data from the data communication means to the portable communication terminal.

21. The power supply and data repeater device according to claim 20, wherein the power supply/data repeater means comprises a data communication setup means for setting up data communication between the computer system and the portable communication terminal.

22. The power supply and data repeater device according to claim 21, wherein an exclusive use communication drive program for communicating with the portable communication terminal through the peripheral device connection port is installed in the computer system and when the data communication setup means sets up a communication mode, the communication drive program is driven upon the request of the data communication means, for displaying a portable communication terminal control window on a display device of the computer system.

23. The power supply and data repeater device according to claims 22, wherein the power supply/data repeater means further comprises a memory means for storing detailed phone number information corresponding to phone numbers, which is inputted, corrected or deleted through the portable communication terminal control window by the communication drive program installed in the computer system.

24. The power supply and data repeater device according to claim 23, wherein the portable communication terminal receives caller phone number information and transmits the information to the power supply/data repeater means, the data communication means searches detailed information corresponding to the caller phone number information from the memory means, and transmits the caller phone number information and the searched detailed information to the computer system, and
the computer system displays the caller phone number information and the detailed information on the portable communication terminal control window by the communication drive program.

25. The power supply and data repeater device according to claim 22, wherein in the case that the portable communication terminal receives a short message and transmits it to the power supply/data repeater means, the data communication means transmits the short message to the computer system, and the computer system displays the short message on the portable communication terminal control window by the communication drive program.

26. The power supply and data repeater device according to claim 22, wherein the computer system inputs a receiver phone number and a short message through the portable communication terminal control window, and transmits short message information including the receiver phone number and the short message to the portable communication terminal through the medium of the power supply/data repeater means by the communication drive program, and the portable communication terminal separates the phone number and the short message from the short message information, and transmits the short message to the phone number.

27. The power supply and data repeater device according to claim 22, wherein the computer system demands setup information of the portable communication terminal to the portable communication terminal through the power supply/data repeater means by the communication drive program, the portable communication terminal transmits the predetermined setup information to the computer system through the power supply/data repeater means upon the setup information request, the computer system receiving the setup information displays the setup information on the portable communication terminal control window by the communication drive program, and
when the computer system receives a renewal request for correcting the setup information through the portable communication terminal control window, the computer system transmits the corrected setup information to the portable communication terminal through the power supply/data repeater means by the communication drive program, and the portable communication terminal sets up the corrected setup information as new setup information.

29. The power supply and data repeater device according to any one among claims 19 to 27, wherein the portable communication terminal is selected from CDMA and GSM cellular phones, PCS phone and PDA, and the portable audio reproducing device is selected from an MP3 player, portable cassette tape player and portable compact disk player.

30. The power supply and data repeater device according to any one among claims 19 to 27, wherein the data repeater means comprises: a wiring connected to pins of the peripheral device connection port of the computer system through the first connector means; and a peripheral device connection port being identical to the peripheral device connection port of the computer system connected to the wiring.

31. The power supply and data repeater device according to any one among claims 19 to 27, wherein the data repeater means comprises: a wiring connected to pins of the peripheral device connection port of the computer system through the first connector means; and a wireless communication means connected to the wiring, for performing wireless communication with a wireless communication type computer peripheral device.

32. The power supply and data repeater device according to any one among claims 19 to 27, wherein the peripheral device connection port is selected from a keyboard connection port, mouse connection port and USB port.

33. The power supply and data repeater device according to any one among claims 19 to 27, wherein the power supply and data repeater device further comprises a power supply means for stabilizing the power transmitted from the peripheral device connection port of the computer system through the first connector means, and supplying the power as operation power of the power load terminal, and
the power supply means comprises: a charging state detecting means for detecting a charging state of a battery of the power load terminal; a charging state display means for displaying the state of the battery according to a detection result of the charging state detecting means; a power supply control means for controlling supply of the stabilized power to the power load terminal according to the detection result of the charging state detecting means; and a power cable connection jack for supplying the power from the power supply control means to the power load terminal through a power cable.

34. The power supply and data repeater device according to claims 33, wherein the power load terminals is selected from an MP3 player, portable cassette tape player and portable compact disk player and speaker.

35. The power supply and data repeater device according to any one among claims 20 to 27, wherein the second connector means comprises: a power cable device having a first power connection plug, a power cable and a second power connection plug connected to the power supply jack of the power load terminal; and a power jack connected to the first connector means, for supplying the power to the power load terminal through the medium of the power cable, the first power connection plug being connected to the power jack.

36. A keyboard device comprising:
at least one connector means for supplying key scan power transmitted from a keyboard connection port of a computer system to a power load terminal.

37. The keyboard device according to claim 36, wherein the power load terminal is selected from a portable communication terminal, portable audio reproducing device and speaker.

38. The keyboard device according to claim 37, wherein the portable communication terminal is selected from CDMA and GSM cellular phones, PCS phone and PDA, and the portable audio reproducing device is selected from an MP3 player, portable cassette tape player and portable compact disk player.

39. The keyboard device according to any one among claims 36 to 38, wherein the keyboard device further comprises a power stabilizing means for stabilizing the key scan power as supply power of the power load terminal.

40. The keyboard device according to claims 39, wherein the keyboard device further comprises: a charging state detecting means for detecting a charging state of a charging battery of the power load terminal; a charging state display means for displaying the state according to a detection result of the charging state detecting means; and a power supply control means for controlling supply of the power stabilized by the power stabilizing means to the power load terminal according to the detection result of the charging state detecting means.

41. The keyboard device according to claim 40, wherein the connector means supplies the power from the power stabilizing means to the power load terminal through the medium of a power cable device including a first power connection plug, a power cable and a second power connection plug connected to a power supply jack of the power load terminal, and includes a power jack to which the first power connection plug is connected.

42. The keyboard device according to any one among claims 36 to 38, wherein the keyboard device comprises: a charging means for charging power by using the key scan power; and a charging power supply means for supplying the charging power from the charging means to the connector means when the key scan power is not supplied from the computer system.

43. The keyboard device according to claim 42, wherein the keyboard device further comprises a photoelectric transducer; and a photoelectric transducing means for stabilizing the power of the photoelectric transducer, and supplying the power to the charging means.

44. The keyboard device according to any one among claims 36 to 38, wherein the keyboard device further comprises: a power jack for receiving DC power from a power adapter means for converting the AC power to DC power; and a power supply means for supplying the DC power from the power jack to the connector means when the key scan power is not supplied from the computer system.

45. A keyboard device comprising:
a power stabilizing means for stabilizing key scan power transmitted from a keyboard connection port of a computer system; a data communication means for processing data communication with a portable communication terminal; a data converting means for converting data being exchanged between the portable communication terminal and the keyboard to recognize reciprocally; and a connector means for transmitting the power from the power stabilizing means and the data from the data converting means to the portable communication terminal.

46. The keyboard device according to claim 45, wherein the connector means supplies the power and data to the portable communication terminal through the medium of a cable device including a first connection plug, a cable and a second connection plug connected to a power/data I/O jack of the portable communication terminal, and includes a power/data connection jack to which the first connection plug is connected.

47. The keyboard device according to claim 46, wherein the power stabilizing means comprises: a charging state detecting means for detecting a charging state of a battery of the portable communication terminal; a charging state display means for displaying the state according to a detection result of the charging state detecting means; and a power supply means for supplying the power stabilized by the power stabilizing means to the connector means according to the detection result of the charging state detecting means.

48. The keyboard device according to claim 46, wherein the keyboard device further comprises: a short message mode setup means for setting up a short message mode for inputting a short message to the portable communication terminal; a memory means for storing short message data inputted through an operation panel in the short message mode; and a short message transmitting means for transmitting the short message data stored in the memory means to the portable communication terminal through the data communication means.

49. The keyboard device according to claim 46, wherein the keyboard device further comprises a short message mode setup means for transmitting short message data inputted through an operation panel to the portable communication terminal through the data communication means.

50. The keyboard device according to claim 48 or 49, wherein an exclusive use keyboard drive program for displaying the short message inputted to the portable communication terminal on a monitor device is installed in the computer system, and the short message mode setup means transmits a control signal for displaying a short message window on the monitor device of the computer system by the keyboard drive program in the short message mode to the computer system.

51. A keyboard device comprising:
a power stabilizing means for stabilizing key scan power transmitted from a keyboard connection port of a computer system; a data communication means for processing data communication with a portable communication terminal; and a connector means for transmitting the power from the power stabilizing means to the portable communication terminal, and exchanging data between the data communication means and the portable communication terminal, and
the connector means connects the power stabilizing means and the data communication means to the portable communication terminal through the medium of a cable device including a first connection plug, a data converting means for converting the data between the data communication means and the portable communication terminal, and a second connection plug connected to a power/data I/O jack of the portable communication terminal, and includes a power/data connection jack to which the first connection plug is connected.

52. The keyboard device according to claim 51, wherein the power stabilizing means comprises: a charging state detecting means for detecting a charging state of a battery of the portable communication terminal; a charging state display means for displaying the state according to a detection result of the charging state detecting means; and a power supply means for transmitting the power stabilized by the power stabilizing means to the connector means according to the detection result of the charging state detecting means.

53. A keyboard device comprising:
a power stabilizing means for stabilizing key scan power transmitted from a keyboard connection port of a computer system; a data communication means for processing data communication with a portable communication terminal; a data converting means for converting data between the data communication means and the portable communication terminal; a connector means for supplying the power from the power stabilizing means to the portable communication terminal, and exchanging the data between the data communication means and the portable communication terminal; and a portable communication terminal control mode setup means for setting up a portable communication terminal control mode,
an exclusive use portable communication terminal control drive program for displaying a short message inputted to the portable communication terminal on a monitor device is installed in the computer system, and
the portable communication terminal control mode setup means transmits a control signal for displaying a portable communication terminal control window on the monitor device of the computer system by the portable communication terminal control drive program in the portable communication terminal control mode to the computer system.

54. The keyboard device according to claim 53, wherein the power stabilizing means comprises: a charging state detecting means for detecting a charging state of a battery of the portable communication terminal; a charging state display means for displaying the state according to a detection result of the charging state detecting means; and a power supply means for transmitting the power stabilized by the power stabilizing means to the connector means according to the detection result of the charging state detecting means.

55. The keyboard device according to claim 53, wherein the keyboard device further comprises a memory means for storing detailed information corresponding to phone numbers, and
the detailed phone number information is inputted, corrected or deleted through the portable communication terminal control window by the communication drive program installed in the computer system.

56. The keyboard device according to claim 55, wherein when the portable communication terminal receives caller phone number information and transmits the information to the data communication means through the medium of the connector means, the data communication means searches detailed information corresponding to the caller phone number information from the memory means, and transmits the caller phone number information and the searched detailed information to the computer system, and
the computer system displays the caller phone number information and the detailed information on the portable communication terminal control window by the portable communication terminal control drive program.

57. The keyboard device according to any one among claims 53 to 56, wherein in the case that the portable communication terminal receives a short message and transmits it to the data communication means through the medium of the connector means, the data communication means transmits the short message to the computer system, and the computer system displays the short message on the portable communication terminal control window by the portable communication terminal control drive program.

58. The keyboard device according to any one among claims 53 to 56, wherein the keyboard device of the invention inputs a receiver phone number and a short message through the portable communication terminal control window, and transmits short message information including the receiver phone number and the short message to the portable communication terminal through the medium of the data communication means and the connector means by the portable communication terminal control drive program, and the portable communication terminal separates the phone number and the short message from the short message information, and transmits the short message to the phone number.

59. The keyboard device according to any one among claims 53 to 56, wherein the keyboard device demands setup information of the portable communication terminal to the portable communication terminal through the medium of the data communication means and the connector means by the portable communication terminal control drive program, the portable communication terminal transmits the predetermined setup information to the computer system through the connector means and the data communication means upon the setup information request, and the computer system receiving the setup information displays the setup information on the portable communication terminal control window by the communication drive program.
